(19) United States
(12) Patent Application Publication
(10) Pub. No.: US 2021/0366132 A1
(43) Pub. Date: Nov. 25, 2021

(54) IMAGE PROCESSING DEVICE, IMAGE PROCESSING METHOD, AND STORAGE MEDIUM STORING IMAGE PROCESSING PROGRAM

(71) Applicant: Mitsubishi Electric Corporation, Tokyo (JP)

(72) Inventors: Jun MINAGAWA, Tokyo (JP); Kohei OKAHARA, Tokyo (JP); Kento YAMAZAKI, Tokyo (JP); Tsukasa FUKASAWA, Tokyo (JP)

(73) Assignee: Mitsubishi Electric Corporation, Tokyo (JP)

(21) Appl. No.: 17/393,633

(22) Filed: Aug. 4, 2021

Related U.S. Application Data
(63) Continuation of application No. PCT/JP2019/036030, filed on Sep. 13, 2019.

(30) Foreign Application Priority Data
Feb. 18, 2019 (JP) PCT/JP2019/005751

(51) Int. Cl. G06T 7/246; G06T 7/292; G06T 5/50; G06N 20/00

(52) U.S. Cl. CPC G06T 7/248; G06T 7/292; G06T 2207/20224; G06N 20/00; G06T 2207/20221; G06T 5/50

(57) ABSTRACT

An image processing device includes processing circuitry to record each of the captured images in a storage device while associating the captured image with identification information on the image capturing device that captured the captured image and time information indicating an image capture time; to calculate an estimated movement amount of each of the image capturing devices; and repeatedly to execute a deviation correction process, wherein in regard to each of the image capturing devices, the processing circuitry acquires the captured images in a designated period from the storage device, obtains movement amounts in adjacent image periods based on captured images arranged in chronological order, and obtains the estimated movement amount by calculation using the movement amounts in the adjacent image periods.

### CROSS-REFERENCE TO RELATED APPLICATION

This application is a continuation application of International Application No. PCT/JP2019/036030 having an international filing date of Sep. 13, 2019, which claims priority to International Application No. PCT/JP2019/005751 having an international filing date of Feb. 18, 2019.

### BACKGROUND OF THE INVENTION

### 1. Field of the Invention

The present invention relates to an image processing device, an image processing method and an image processing program.

### 2. Description of the Related Art

There has been proposed a device that generates a synthetic image by combining a plurality of captured images captured by a plurality of cameras (see Patent Reference 1, for example). This device corrects deviation in boundary parts of the plurality of captured images by calibrating a camera parameter of each of the plurality of cameras by using feature points in a captured image captured before a change in the posture of a vehicle and the feature points in a captured image captured after the change in the posture of the vehicle.

Patent Reference 1: WO 2017/069191 (see paragraph 0041 and FIG. 5, for example)

However, the aforementioned conventional device estimates a position posture change of an image capturing device occurring in a short time by performing the matching between the feature points in a captured image before the position posture change and the feature points in a captured image after the position posture change. Therefore, when estimating the position posture change of a camera in a long period (some days to some years), there is a possibility that the matching between the feature points fails due to great changes between the features in the captured image before the position posture change and the features in the captured image after the position posture change. Further, after the correction of the deviation, no evaluation is made of whether the deviation in the boundary parts of the plurality of captured images has been corrected accurately or not. Accordingly, there is a problem in that the deviation remains in the boundary parts in the synthetic image.

### SUMMARY OF THE INVENTION

An object of the present invention, which has been made to resolve the above-described problems with the conventional technology, is to provide an image processing device, an image processing method and an image processing program capable of accurately correcting the deviation occurring in overlap regions of a plurality of captured images constituting the synthetic image due to the position posture change of a plurality of image capturing devices.

An image processing device according to an aspect of the present invention is a device for executing a process of combining a plurality of captured images captured by a plurality of image capturing devices, including: processing circuitry to record each of the plurality of captured images in a storage device while associating the captured image with identification information on the image capturing device that captured the captured image and time information indicating an image capture time; to calculate an estimated movement amount of each of the plurality of image capturing devices based on the plurality of captured images recorded in the storage device; and repeatedly to execute a deviation correction process including a process of obtaining an evaluation value of a deviation amount in each overlap region of the plurality of captured images constituting a synthetic image generated by combining the plurality of captured images whose image capture times are the same, a process of updating an external parameter of each of the plurality of image capturing devices based on the estimated movement amount and the evaluation value of the deviation amount, and a process of combining the plurality of captured images whose image capture times are the same by using the updated external parameters, wherein in regard to each of the plurality of image capturing devices, the processing circuitry acquires the captured images in a designated period from the storage device, obtains movement amounts in adjacent image periods based on a plurality of captured images arranged in chronological order, and obtains the estimated movement amount by calculation using the movement amounts in the adjacent image periods.

An image processing method according to another aspect of the present invention is a method of executing a process of combining a plurality of captured images captured by a plurality of image capturing devices, including: recording each of the plurality of captured images in a storage device while associating the captured image with identification information on the image capturing device that captured the captured image and time information indicating an image capture time; when calculating an estimated movement amount of each of the plurality of image capturing devices based on the plurality of captured images recorded in the storage device, in regard to each of the plurality of image capturing devices, acquiring the captured images in a designated period from the storage device, obtaining movement amounts in adjacent image periods based on a plurality of captured images arranged in chronological order, and obtaining the estimated movement amount by calculation using the movement amounts in the adjacent image periods; and repeatedly executing a deviation correction process including a process of obtaining an evaluation value of a deviation amount in each overlap region of the plurality of captured images constituting a synthetic image generated by combining the plurality of captured images whose image capture times are the same, a process of updating an external parameter of each of the plurality of image capturing devices based on the estimated movement amount and the evaluation value of the deviation amount, and a process of combining the plurality of captured images whose image capture times are the same by using the updated external parameters.

An image processing device according to another aspect of the present invention is a device for executing a process of generating a synthetic image by combining a plurality of camera images captured by a plurality of cameras, including: processing circuitry to provide a plurality of external parameters as camera parameters of the plurality of cameras; to generate synthesis tables, as mapping tables used at a time of combining projection images, based on the plurality of external parameters and to generate a plurality of projection images corresponding to the plurality of camera images by projecting the plurality of camera images onto the same projection surface by using the synthesis tables; to generate the synthetic image from the plurality of projection images; to calculate a plurality of external parameters after correction as camera parameters of the plurality of cameras by estimating movement amounts of the plurality of cameras based on reference data, including a plurality of reference images as camera images used as reference corresponding to the plurality of cameras and a plurality of external parameters corresponding to the plurality of reference images, and the plurality of camera images captured by the plurality of cameras; and to update the plurality of external parameters to the plurality of external parameters after the correction by using a result of the calculating of the plurality of external parameters after the correction.

According to the present invention, the deviation occurring in the overlap regions of the plurality of captured images constituting the synthetic image due to the position posture change of a plurality of image capturing devices can be corrected with high accuracy.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing an example of a hardware configuration of an image processing device according to a first embodiment of the present invention;

FIG. 2 is a functional block diagram schematically showing a configuration of the image processing device according to the first embodiment;

FIG. 3A and FIG. 3B are explanatory diagrams showing an example of a process executed by a synthesis table generation unit and a synthesis processing unit of the image processing device according to the first embodiment;

FIG. 4A and FIG. 4B are explanatory diagrams showing another example of the process executed by the synthesis table generation unit and the synthesis processing unit of the image processing device according to the first embodiment;

FIG. 5 is a flowchart showing an outline of a process executed by the image processing device according to the first embodiment;

FIG. 6 is a flowchart showing a process executed by an image recording unit of the image processing device according to the first embodiment;

FIG. 7 is a flowchart showing a process executed by a movement amount estimation unit of the image processing device according to the first embodiment;

FIG. 8 is a diagram showing the relationship between recorded captured images and movement amounts;

FIG. 9 is a flowchart showing a process executed by an outlier exclusion unit of the image processing device according to the first embodiment;

FIG. 10 is an explanatory diagram showing a process executed by the outlier exclusion unit for exclusion of outliers;

FIG. 11 is a flowchart showing a process executed by a correction timing determination unit of the image processing device according to the first embodiment;

FIG. 12 is a flowchart showing a parameter optimization process (i.e., deviation correction process) executed by the image processing device according to the first embodiment;

FIG. 13 is an explanatory diagram showing calculation formulas used for update of an external parameter performed by a parameter optimization unit of the image processing device according to the first embodiment;

FIG. 14 is an explanatory diagram showing an example of the deviation correction process executed by the parameter optimization unit of the image processing device according to the first embodiment;

FIGS. 15A to 15D are explanatory diagrams showing another example of the deviation correction process executed by the parameter optimization unit of the image processing device according to the first embodiment;

FIGS. 16A to 16C are explanatory diagrams showing another example of the deviation correction process executed by the parameter optimization unit of the image processing device according to the first embodiment;

FIG. 17 is a flowchart showing a process executed by the synthesis table generation unit of the image processing device according to the first embodiment;

FIG. 18 is a flowchart showing a process executed by the synthesis processing unit of the image processing device according to the first embodiment;

FIGS. 19A to 19C are explanatory diagrams showing a process executed by a deviation amount evaluation unit of the image processing device according to the first embodiment for obtaining a deviation amount evaluation value;

FIG. 20 is a flowchart showing a process executed by the deviation amount evaluation unit of the image processing device according to the first embodiment;

FIG. 21 is a flowchart showing a process executed by an overlap region extraction unit of the image processing device according to the first embodiment;

FIG. 22 is a flowchart showing a process executed by a display image output unit of the image processing device according to the first embodiment;

FIG. 23 is a flowchart showing the parameter optimization process (i.e., the deviation correction process) executed by an image processing device according to a second embodiment of the present invention;

FIG. 24 is an explanatory diagram showing an example of the deviation correction process executed by the parameter optimization unit of the image processing device according to the second embodiment;

FIGS. 25A to 25D are explanatory diagrams showing another example of the deviation correction process executed by the parameter optimization unit of the image processing device according to the second embodiment;

FIG. 26 is a diagram showing an example of a hardware configuration of an image processing device according to a third embodiment of the present invention;

FIG. 27 is a functional block diagram schematically showing a configuration of the image processing device according to the third embodiment;

FIG. 28 is a functional block diagram schematically showing a configuration of a projection processing unit shown in FIG. 27;

FIG. 29 is a functional block diagram schematically showing a configuration of a synthesis processing unit shown in FIG. 27;

FIG. 30 is a functional block diagram schematically showing a configuration of a deviation detection unit shown in FIG. 27;

FIG. 31 is a functional block diagram schematically showing a configuration of a deviation correction unit shown in FIG. 27;

FIG. 32 is a flowchart showing a process executed by the synthesis processing unit shown in FIG. 27 and FIG. 29;

FIG. 33 is a flowchart showing a process executed by the projection processing unit shown in FIG. 27 and FIG. 28;

FIG. 34 is an explanatory diagram showing an example of a process executed by the projection processing unit shown in FIG. 27 and FIG. 28;

FIG. 35 is a flowchart showing a process executed by the deviation detection unit shown in FIG. 27 and FIG. 28;

FIG. 36 is an explanatory diagram showing a process executed by a superimposition region extraction unit shown in FIG. 31;

FIGS. 37A and 37B are explanatory diagrams showing an example of a process executed by a projection region deviation amount evaluation unit shown in FIG. 30;

FIG. 38 is a flowchart showing a process executed by a movement amount estimation-parameter calculation unit shown in FIG. 27;

FIG. 39 is a flowchart showing a process executed by the deviation correction unit shown in FIG. 27 and FIG. 31;

FIG. 40 is a functional block diagram schematically showing a configuration of an image processing device according to a fourth embodiment of the present invention;

FIG. 41 is a flowchart showing a process executed by a camera image recording unit shown in FIG. 40;

FIGS. 42A to 42C are explanatory diagrams showing a process executed by an input data selection unit shown in FIG. 40;

FIG. 43 is a flowchart showing the process executed by the input data selection unit shown in FIG. 40;

FIGS. 44A to 44C are explanatory diagrams showing a process executed by the input data selection unit shown in FIG. 40;

FIG. 45 is a functional block diagram schematically showing a configuration of an image processing device according to a fifth embodiment of the present invention;

FIG. 46 is a flowchart showing a process executed by a camera image recording unit shown in FIG. 45;

FIG. 47 is a functional block diagram schematically showing a configuration of a mask image generation unit shown in FIG. 45;

FIG. 48 is a flowchart showing a process executed by the mask image generation unit shown in FIG. 45;

FIGS. 49A to 49E are explanatory diagrams showing the process executed by the mask image generation unit shown in FIG. 45;

FIGS. 50A to 50E are explanatory diagrams showing the process executed by the mask image generation unit shown in FIG. 45;

FIGS. 51A to 51D are explanatory diagrams showing the process executed by the mask image generation unit shown in FIG. 45;

FIGS. 52A to 52C are explanatory diagrams showing the process executed by the mask image generation unit shown in FIG. 45;

FIGS. 53A to 53C are explanatory diagrams showing the process executed by the mask image generation unit shown in FIG. 45;

FIG. 54 is a flowchart showing a process executed by the movement amount estimation-parameter calculation unit shown in FIG. 45;

FIGS. 55A to 55C are explanatory diagrams showing the process executed by the movement amount estimation-parameter calculation unit shown in FIG. 45;

FIG. 56 is a functional block diagram schematically showing a configuration of a deviation correction unit shown in FIG. 45;

FIG. 57 is a flowchart showing a process for deviation correction;

FIG. 58 is a functional block diagram schematically showing a configuration of an image processing device according to a sixth embodiment of the present invention;

FIG. 59 is a functional block diagram schematically showing a configuration of an input image transformation unit shown in FIG. 58;

FIG. 60 is a flowchart showing a process executed by the input image transformation unit shown in FIG. 58 and FIG. 59;

FIG. 61 is an explanatory diagram showing the process executed by the input image transformation unit shown in FIG. 58 and FIG. 59;

FIG. 62 is an explanatory diagram showing a process executed by the input image transformation unit shown in FIG. 58 and FIG. 59; and

FIG. 63 is a flowchart showing a process executed by an image transformation destination determination unit of an image processing device according to a modification of the sixth embodiment.

### DETAILED DESCRIPTION OF THE INVENTION

Image processing devices, image processing methods and image processing programs according to embodiments of the present invention will be described below with reference to the drawings. The following embodiments are just examples and a variety of modifications are possible within the scope of the present invention.

### (1) First Embodiment

### (1-1) Configuration

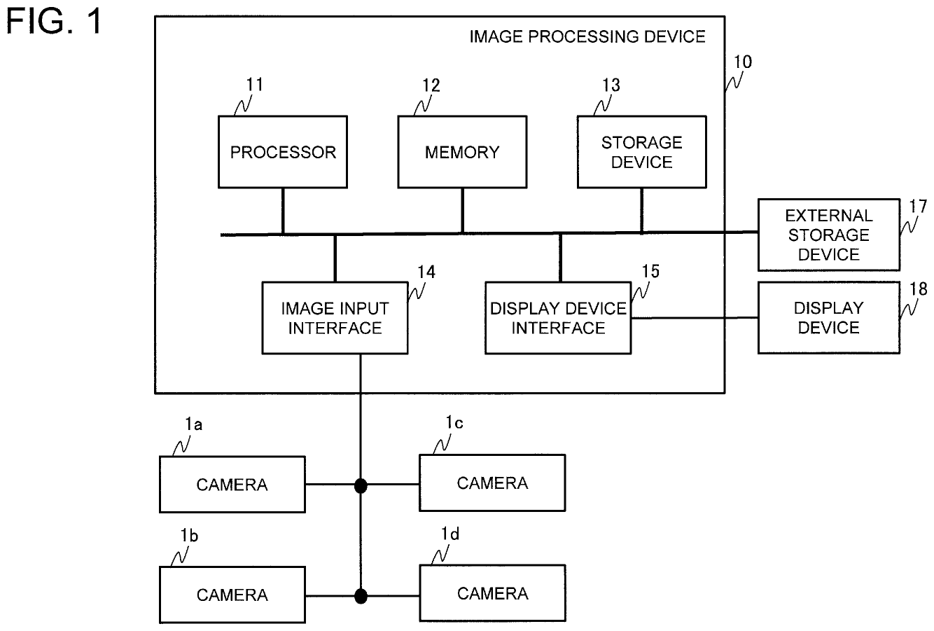

FIG. 1 is a diagram showing an example of the hardware configuration of an image processing device 10 according to a first embodiment of the present invention. As shown in FIG. 1, the image processing device 10 may be implemented by processing circuitry. The processing circuitry includes a processor 11, a memory 12 as a main storage device, a storage device 13 as an auxiliary storage device, an image input interface 14, and a display device interface 15, for example. The processor 11 performs various calculation processes and various hardware control processes by executing programs stored in the memory 12. The programs stored in the memory 12 include an image processing program according to the first embodiment. The image processing program is acquired via the Internet, for example. The image processing program may also be acquired from a record medium (i.e., a non-transitory computer-readable storage medium) storing the image processing program such as a magnetic disk, an optical disc, a semiconductor memory or the like. The storage device 13 is, for example, a hard disk drive, an SSD (Solid State Drive) or the like. The image input interface 14 takes in captured images provided from cameras 1a, 1b, 1c and 1d as image capturing devices, namely, camera images, while converting the captured images into captured image data. The display device interface 15 outputs the captured image data or synthetic image data which will be described later to a display device 18 that is a display. While four cameras 1a to 1d are shown in FIG. 1, the number of the cameras is not limited to four.

The cameras 1a to 1d have a function of capturing images. Each of the cameras 1a to 1d includes an image pickup device such as a CCD (Charged-Coupled Device) image sensor or a CMOS (Complementary Metal-Oxide-Semiconductor) image sensor and a lens unit including one or more lenses. The cameras 1a to 1d do not need to be devices of the same type having the same configuration as each other. Each camera 1a-1d can be, for example, a fixed camera including a fixed lens unit and having no zoom function, a zoom camera including a movable lens unit and having the zoom function, a pan tilt zoom (PTL) camera, or the like. In the first embodiment, a case where the cameras 1a to 1d are fixed cameras will be described.

The cameras 1a to 1d are connected to the image input interface 14 of the image processing device 10. This connection may be either wired connection or wireless connection. The connection between the cameras 1a to 1d and the image input interface 14 is, for example, connection by an IP (Internet Protocol) network. The connection between the cameras 1a to 1d and the image input interface 14 may also be a different type of connection.

The image input interface 14 receives captured images (i.e., image data) from the cameras 1a to 1d. The received captured images are stored in the memory 12 or the storage device 13. The processor 11 generates a synthetic image (i.e., synthetic image data) by performing a synthesis process on a plurality of captured images received from the cameras 1a to 1d by executing a program stored in the memory 12 or the storage device 13. The synthetic image is sent to the display device 18 as the display via the display device interface 15. The display device 18 displays an image based on the received synthetic image.

### (Image Processing Device 10)

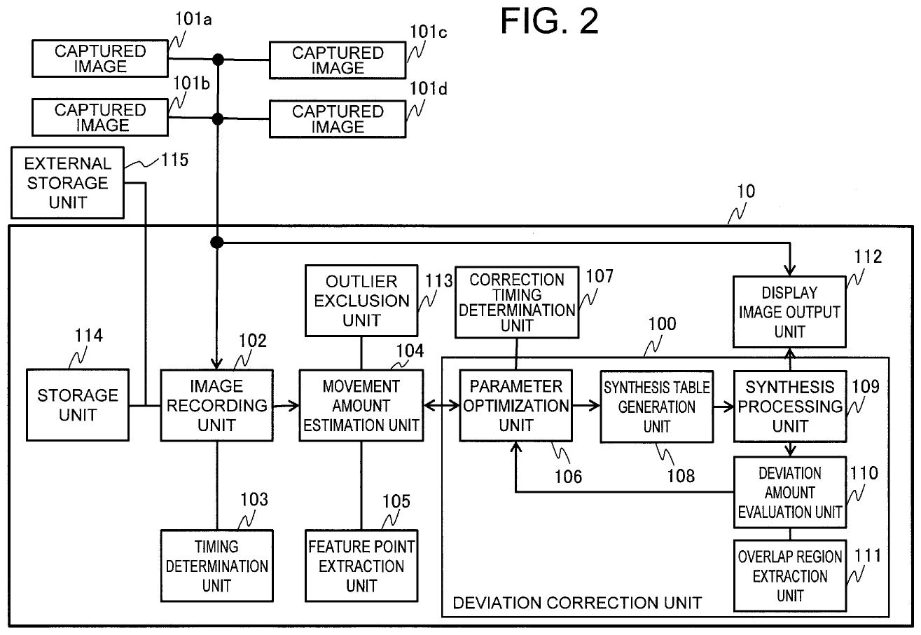

FIG. 2 is a functional block diagram schematically showing a configuration of the image processing device 10 according to the first embodiment. The image processing device 10 is a device capable of executing an image processing method according to the first embodiment. As shown in FIG. 2, the image processing device 10 includes an image recording unit 102, a storage unit 114, a timing determination unit 103, a movement amount estimation unit 104, a feature point extraction unit 105, a parameter optimization unit 106, a correction timing determination unit 107, a synthesis table generation unit 108, a synthesis processing unit 109, a deviation amount evaluation unit 110, an overlap region extraction unit 111 and a display image output unit 112. The parameter optimization unit 106, the synthesis table generation unit 108, the synthesis processing unit 109, the deviation amount evaluation unit 110 and the overlap region extraction unit 111 constitute a deviation correction unit 100 that corrects deviation in overlap regions (superimposition regions) of the captured images in the synthetic image. Further, the image processing device 10 may include an outlier exclusion unit 113. The image recording unit 102 is connected to an external storage unit 115 that stores captured images 101a to 101d. The storage unit 114 is, for example, the memory 12 or the storage device 13 shown in FIG. 1 or a part of the memory 12 or the storage device 13. The external storage unit 115 is, for example, an external storage device 17 shown in FIG. 1 or a part of the external storage device 17.

The image processing device 10 receives the captured images 101a to 101d from the cameras 1a to 1d and generates one synthetic image by combining the captured images 101a to 101d together. The image recording unit 102 records the captured images 101a to 101d captured by the cameras 1a to 1d in the storage unit 114, the external storage unit 115 or both of the storage unit 114 and the external storage unit 115.

The timing determination unit 103 commands timing for the image recording unit 102 to record the captured images 101a to 101d.

The movement amount estimation unit 104 calculates an estimated movement amount (i.e., position posture deviation amount) of each of the cameras 1a to 1d. The movement amount is represented by, for example, translational movement components and rotational movement components of each camera 1a-1d. The translational movement components include three components in X-axis, Y-axis and Z-axis directions in an XYZ orthogonal coordinate system. The rotational movement components include three components of roll, pitch and yaw. Incidentally, the format of the parameters is not limited here as long as the movement amount of each camera can be uniquely determined. Further, the movement amount may also be formed with part of the plurality of components. The movement (i.e., position posture deviation) of each camera 1a-1d can be represented by, for example, a movement vector having three translational movement components and three rotational movement components as elements. An example of the movement vector will be shown as a movement vector Pt in FIG. 13 which will be explained later.

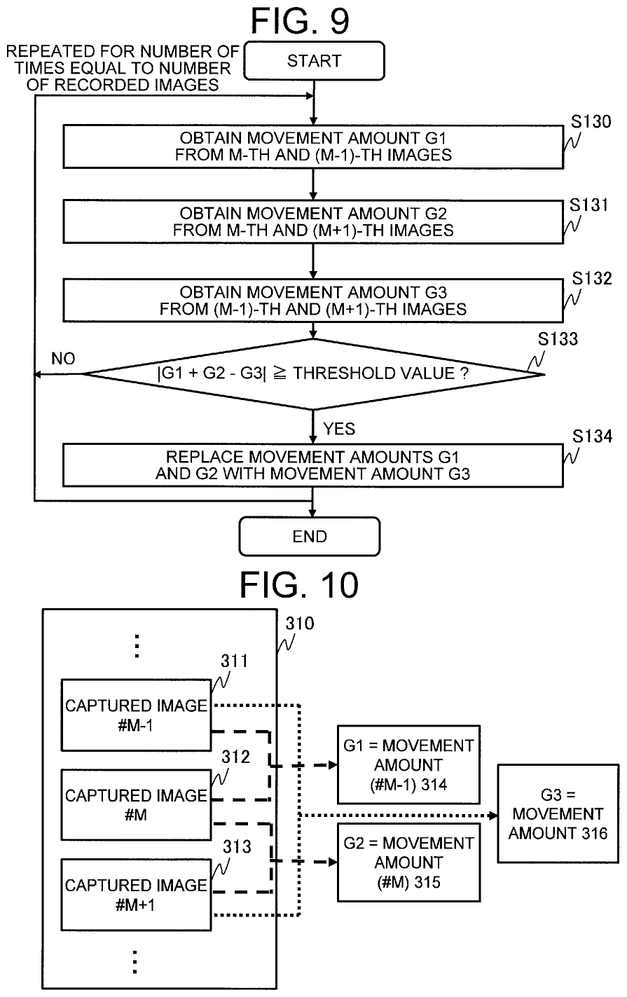

The outlier exclusion unit 113 judges whether each of movement amounts #1 to #N−1 in periods between adjacent images (hereinafter referred to also as “movement amounts in adjacent image periods”) corresponds to an outlier or not in a process of determining the movement amount of each camera 1a-1d in a designated period estimated by the movement amount estimation unit 104 (hereinafter referred to also as an “estimated movement amount”), and determines not to use the movement amounts in adjacent image periods corresponding to outliers for the calculation for determining the estimated movement amount generated by the movement amount estimation unit 104. Here, N is a positive integer. The judgment on whether one of the movement amounts in the adjacent image periods corresponds to an outlier or not can be made based on whether or not the movement amount in the adjacent image period is a value that cannot occur. For example, the outlier exclusion unit 113 judges that the movement amount in the adjacent image period is an outlier when the movement amount in the adjacent image period exceeds a predetermined threshold value. A concrete example of the judgment on whether the movement amount in the adjacent image period is an outlier or not will be described later with reference to FIG. 9 and FIG. 10.

The feature point extraction unit 105 extracts feature points, to be used for calculating the estimated movement amounts of the cameras 1a to 1d, from the captured images 101a to 101d.

The parameter optimization unit 106 obtains optimum external parameters, for correcting the deviation in the overlap regions between the captured images constituting the synthetic image, based on the estimated movement amounts calculated by the movement amount estimation unit 104 and evaluation values of deviation amounts provided from the deviation amount evaluation unit 110 which will be described later, and updates the external parameters by using the obtained external parameters. The deviation in the overlap region between captured images will be referred to also as “deviation in the synthetic image”. This amount is shown in FIG. 13 which will be explained later.

The correction timing determination unit 107 determines timing for correcting the deviation in the synthetic image.

The synthesis table generation unit 108 generates a synthesis table as a mapping table of each of the captured images corresponding to the external parameter provided from the parameter optimization unit 106. The synthesis processing unit 109 generates the synthetic image by combining the captured images 101a to 101d into one image by using the synthesis tables provided from the synthesis table generation unit 108.

The deviation amount evaluation unit 110 calculates the amount of the deviation in the synthetic image, that is, the deviation amount, and outputs the calculated value of the deviation amount as the evaluation value of the deviation amount. The deviation amount evaluation value is provided to the parameter optimization unit 106. The overlap region extraction unit 111 extracts the overlap regions between the captured images 101a to 101d constituting the synthetic image when the synthesis processing unit 109 combines the captured images 101a to 101d together. The display image output unit 112 outputs the synthetic image in which the deviation has been corrected, that is, the synthetic image after a deviation correction process.

### (Image Recording Unit 102)

The image recording unit 102 records the captured images 101a to 101d in the storage unit 114, the external storage unit 115 or both of the storage unit 114 and the external storage unit 115 with timing designated by the timing determination unit 103. When recording each captured image 101a-101d, the image recording unit 102 also records a device ID as identification information for identifying the camera that generated the captured image 101a-101d and an image capture time while associating the device ID and the image capture time with each captured image 101a-101d. The device ID and the image capture time are referred to also as “accompanying information”. Namely, the image recording unit 102 stores the captured images 101a to 101d associated with the accompanying information in the storage unit 114, the external storage unit 115 or both of the storage unit 114 and the external storage unit 115.

As the method of recording each captured image 101a-101d and the accompanying information while associating them with each other, there are, for example, a method of including the accompanying information in the data of each captured image 101a-101d, a method of making the association by using a relational database such as RDBMS (Relational DataBase Management System), and so forth. The method of recording each captured image 101a-101d and the accompanying information while associating them with each other can be a method other than the aforementioned methods.

### (Timing Determination Unit 103)

The timing determination unit 103 determines the timing for recording the captured images provided from the cameras 1a to 1d based on a condition designated by the user, for example, and notifies the image recording unit 102 of the determined timing. The designated condition can be at predetermined constant time intervals, at each time point when a predetermined situation occurs, or the like. The predetermined time interval is a constant time interval designated by using a unit such as second, minute, hour, day, month or the like. The time point when a predetermined situation occurs can be, for example, a time point when feature points are detected in the captured image from the camera 1a-1d (e.g., a certain time point in the daytime), a time point when no moving object is detected in the captured image from the camera 1a-1d, or the like. Further, the timing for recording the captured image may also be determined individually for each camera 1a-1d based on characteristics and installation position condition of the camera 1a-1d.

### (Feature Point Extraction Unit 105)

The feature point extraction unit 105 extracts feature points in each captured image 101a-101d and detects the coordinates of the feature points in order to calculate the estimated movement amount of each camera 1a-1d based on the captured images 101a to 101d. There is AKAZE as a typical example of feature point detection algorithm. However, the feature point detection algorithm is not limited to this example.

### (Movement Amount Estimation Unit 104)

The movement amount estimation unit 104 calculates the estimated movement amount of each camera 1a-1d, i.e., calculates the estimated movement amount, based on the feature points of the captured images 101a to 101d recorded by the image recording unit 102. The estimated movement amount of each camera 1a-1d is, for example, a movement amount from a position at a reference time defined as the time point when the camera 1a-1d was installed. The estimated movement amount of each camera 1a-1d is, for example, a movement amount in a period between designated starting day and ending day. The estimated movement amount of each camera 1a-1d can also be the estimated movement amount of each camera 1a-1d in a period between a starting time and an ending time defined by designating the starting time and the ending time. The movement amount estimation unit 104 calculates the estimated movement amount of each camera 1a-1d based on the coordinates of the feature points of each captured image 101a-101d at two time points.

Further, the movement amount estimation unit 104 receives feedback information from the parameter optimization unit 106 when a parameter optimization process (i.e., the deviation correction process) has been executed by the deviation correction unit 100. Specifically, the movement amount estimation unit 104 sets (i.e., resets) the estimated movement amount calculated for each camera 1a-1d to zero at a time when the parameter optimization unit 106 has optimized and updated the external parameter of the camera 1a-1d. Alternatively, the movement amount estimation unit 104 may perform the calculation of the estimated movement amount on the basis of machine learning based on the feedback information received from the parameter optimization unit 106. Thereafter, the movement amount estimation unit 104 performs the calculation of the estimated movement amount by defining the reference time as the time point when the feedback information was received.

The estimated movement amount provided by the movement amount estimation unit. 104 is represented by the translational movement components and the rotational movement components of the camera 1a-1d. The translational movement components include the three components in the X-axis, Y-axis and Z-axis directions, and the rotational movement components include the three components of roll, pitch and yaw. Incidentally, the format of the parameters is not limited here as long as the movement amount of each camera can be uniquely determined. The translational movement components and the rotational movement components may be outputted in the format of a vector or a matrix. Incidentally, the process for calculating the estimated movement amount of each camera 1a-1d is not limited to the above-described process. For example, there is a method using a homography matrix as an example of the method of representing the movement amount between camera images. When an internal parameter of the camera is known, the external parameter can be calculated from the homography matrix. The rotational movement components of the estimated movement amount of each camera 1a-1d may also be acquired based on output from a rotary encoder or the like of a camera to which a sensor is attached or a camera including a built-in sensor (e.g., PTZ camera).

### (Parameter Optimization Unit 106)

In regard to each camera judged by the correction timing determination unit 107 to be a target of the parameter optimization process (i.e., the deviation correction process), the parameter optimization unit 106 obtains the external parameter, to be used for correcting the deviation in the synthetic image, based on the estimated movement amount of each camera 1a-1d provided from the movement amount estimation unit 104 and the deviation amount evaluation value (referred to also as a “deviation amount calculation value”) in the synthetic image calculated by the deviation amount evaluation unit 110. The external parameter is made up of, for example, three components in the X-axis, Y-axis and Z-axis directions as translational movement components and three components of roll, pitch and yaw as rotational movement components. Incidentally, the format of the external parameter is not limited as long as the position posture of the camera can be uniquely determined.

The parameter optimization unit 106 calculates the external parameter, to be used for correcting the deviation in the synthetic image, so as to reduce the deviation amount in the synthetic image based on the estimated movement amount of each camera 1a-1d obtained by the movement amount estimation unit 104 and the deviation amount evaluation value in the synthetic image obtained by the deviation amount evaluation unit 110. The optimization process of the external parameter of each camera is executed by, for example, repeating the following processes (H2) to (H5) in this order after executing the following processes (H1) to (H5):

(H1) process in which the parameter optimization unit 106 updates the external parameter of each camera 1a-1d
(H2) process in which the synthesis table generation unit 108 generates the synthesis table corresponding to parameters (i.e., the internal parameter, a distortion correction parameter and the external parameter) of each camera 1a-1d
(H3) process in which the synthesis processing unit 109 generates the synthetic image by combining the captured images 101a to 101d by using the synthesis table of each camera 1a-1d
(H4) process in which the deviation amount evaluation unit 110 obtains the deviation amount evaluation value in the synthetic image and feeds back the deviation amount evaluation value
(H5) process in which the parameter optimization unit 106 updates the external parameter by using the deviation amount evaluation value as feedback information.

Further, when the position posture deviation has occurred to two or more cameras among the cameras 1a to 1d, the parameter optimization unit 106 executes a process of determining a captured image as the reference among the captured images 101a to 101d and a process of determining the order of the cameras as the targets of the deviation correction process. Furthermore, at a time when the deviation correction process has been executed, the parameter optimization unit 106 provides the movement amount estimation unit 104 with the feedback information for resetting the estimated movement amount of each camera. This feedback information includes the device ID indicating the camera as the target of the resetting of the movement amount and the external parameter after the correction.

### (Correction Timing Determination Unit 107)

The correction timing determination unit 107 provides the parameter optimization unit 106 with the timing satisfying the designated condition as the timing for executing the deviation correction process for correcting the deviation in the synthetic image. Here, the designated condition is a condition that the estimated movement amount of each camera 1a-1d acquired from the movement amount estimation unit 104 via the parameter optimization unit 106 has exceeded a threshold value, a condition that the deviation amount evaluation value in the synthetic image acquired from the deviation amount evaluation unit 110 has exceeded a predetermined threshold value, or the like. The condition that the estimated movement amount of each camera 1a-1d has exceeded a threshold value is, for example, a condition that the “estimated movement amount in a designated period” has exceeded a threshold value, or the like. The correction timing determination unit 107 outputs a command for making the parameter optimization unit 106 execute the deviation correction process for correcting the deviation in the synthetic image. Incidentally, the timing of the deviation correction process may also be designated by the user by using an input interface such as a mouse or a keyboard.

### (Synthesis Table Generation Unit 108)

The synthesis table generation unit 108 generates the synthesis tables for generating the synthetic image based on the internal parameter and the distortion correction parameter of each camera 1a-1d and the external parameter of each camera 1a-1d provided from the parameter optimization unit 106.

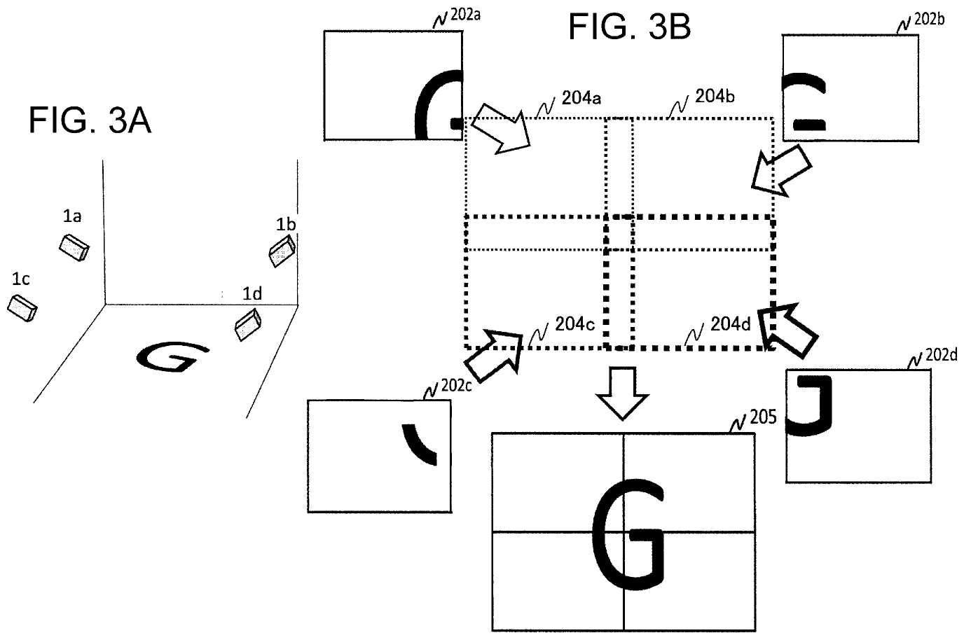

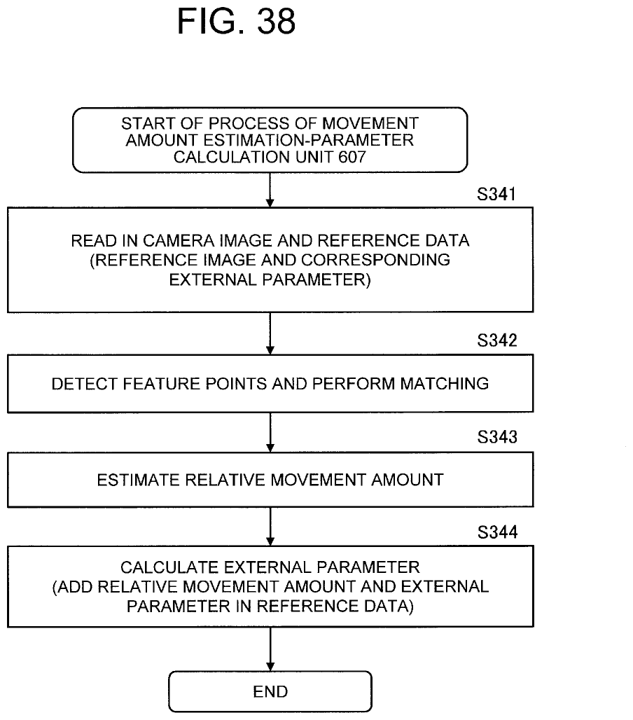

FIG. 3A and FIG. 38 are explanatory diagrams showing a process executed by the synthesis table generation unit 108 and the synthesis processing unit 109. FIG. 3A shows the positions and postures of the cameras 1a to 1d. FIG. 3B shows captured images 202a, 202b, 202c and 202d captured by the cameras 1a to 1d, a synthetic image 205, and synthesis tables 204a, 204b, 204c and 204d used for generating the synthetic image 205.

The synthesis table generation unit 108 provides the synthesis processing unit 109 with the synthesis tables 204a to 204d based on the internal parameter and the distortion correction parameter of each camera 1a-1d and the external parameter of each camera 1a-1d provided from the parameter optimization unit 106. The synthesis processing unit 109 generates the synthetic image 205 based on the captured images 202a to 202d.

Incidentally, a bird's eye synthetic image, a panoramic synthetic image, an around view image or the like can be generated as the synthetic image by changing the positional relationship and image capture ranges of the cameras 1a to 1d. The synthesis table generation unit 108 outputs data indicating the correspondence between pixels of the captured images 202a to 202d and pixels of the synthetic image 205 as the synthesis tables. The synthesis table generation unit 108 arranges the captured images 202a to 202d in two rows and two columns in a case where the synthesis tables 204a to 204d are tables used for combining captured images of two rows and two columns, for example.

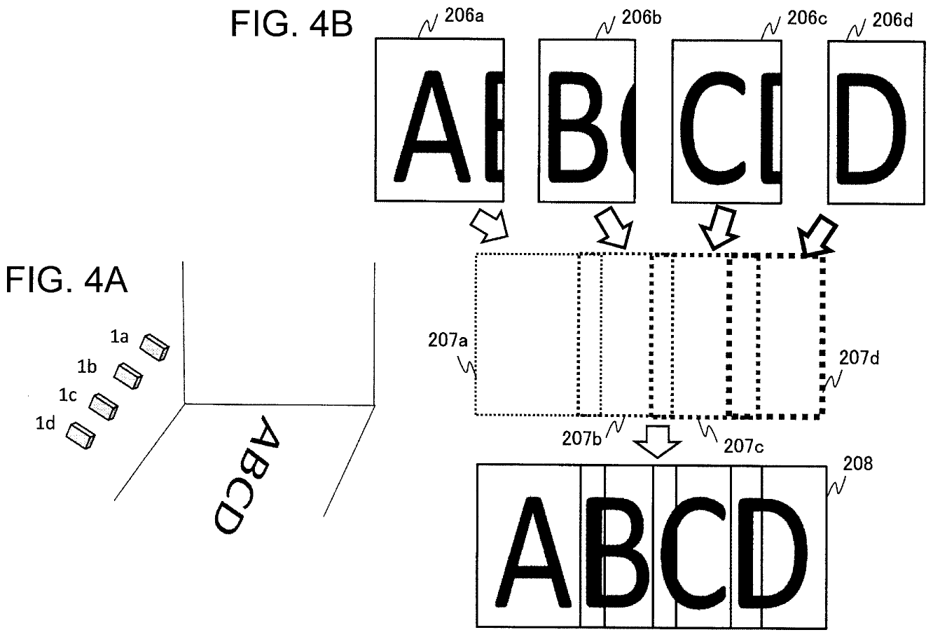

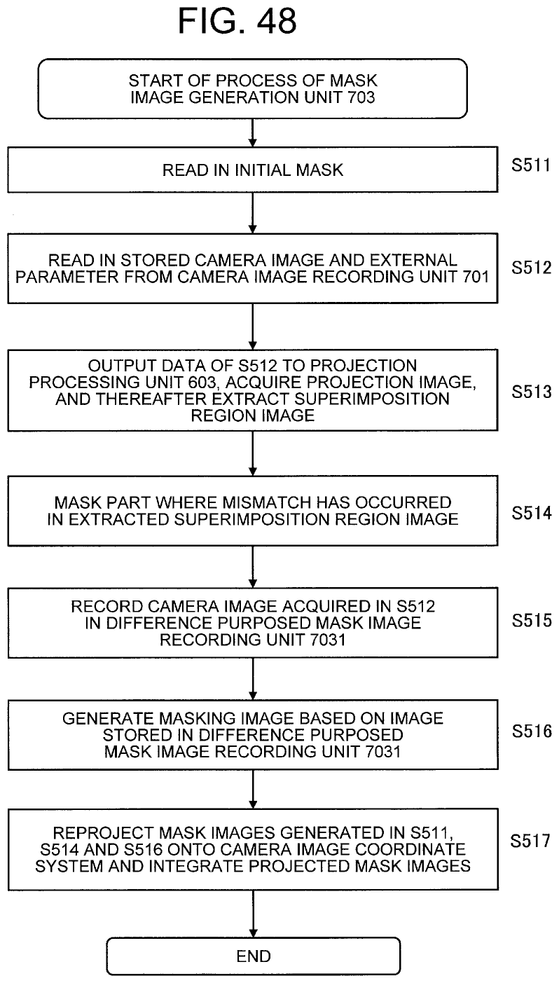

FIG. 4A and FIG. 4B are explanatory diagrams showing another process executed by the synthesis table generation unit 108 and the synthesis processing unit 109. FIG. 4A shows the positions and postures of the cameras 1a to 1d. FIG. 48 shows captured images 206a, 206b, 206c and 206d captured by the cameras 1a to 1d, a synthetic image 208, and synthesis tables 207a, 207b, 207c and 207d used for generating the synthetic image 208.

The synthesis table generation unit 108 provides the synthesis processing unit 109 with the synthesis tables 207a to 207d based on the internal parameter and the distortion correction parameter of each camera 1a-1d and the external parameter of each camera 1a-1d provided from the parameter optimization unit 106. The synthesis processing unit 109 generates the synthetic image 208 based on the captured images 206a to 206d.

Incidentally, a bird's eye synthetic image, a panoramic synthetic image, an around view image or the like can be generated as the synthetic image by changing the positional relationship and the image capture ranges of the cameras 1a to 1d. The synthesis table generation unit 108 outputs data indicating the correspondence between pixels of the captured images 206a to 206d and pixels of the synthetic image 208 as the synthesis tables. The synthesis table generation unit 108 arranges the captured images 206a to 206d in one row and four columns in a case where the synthesis tables 207a to 207d are tables used for combining captured images of one row and four columns, for example.

### (Synthesis Processing Unit 109)

The synthesis processing unit 109 receives the synthesis table of each camera 1a-1d generated by the synthesis table generation unit 108 and the captured images captured by the cameras 1a to 1d and generates one synthetic image by combining the captured images together. The synthesis processing unit 109 performs a blending process on parts where captured images overlap with each other.

### (Deviation Amount Evaluation Unit 110)

The deviation amount evaluation unit 110 calculates the deviation amount evaluation value indicating the magnitude of the deviation in the synthetic image based on the synthetic image generated by the synthesis processing unit 109 and the synthesis tables used at the time of the synthesis, and provides the deviation amount evaluation value to the parameter optimization unit 106 and thereby feeds hack the result of the deviation correction process for correcting the deviation in the synthetic image to the parameter optimization unit 106. The deviation in the synthetic image occurs in boundary parts where captured images transformed by using the synthesis tables (i.e., images after the transformation) are joined together. The boundary parts are referred to also as overlap regions or overlap parts. For the calculation of the deviation amount evaluation value in the synthetic image, numerical values such as luminance value difference, distance between corresponding feature points, an image similarity level or the like in the overlap regions of the captured images after the transformation to be joined together are used. The deviation amount evaluation value is calculated for each combination of captured images after the transformation. For example, when there exist the cameras 1a to 1d, the deviation amount evaluation value of the camera 1a is calculated in regard to the cameras 1a and 1b, the cameras 1a and 1c, and the cameras 1a and 1d. While a range used for the calculation of the deviation amount evaluation value is detected automatically, the range may also be designated by an operation by the user.

### (Overlap Region Extraction Unit 111)

The overlap region extraction unit 111 extracts the overlap regions of the captured images after the transformation in the synthetic image generated by the synthesis processing unit 109. Information indicating the extracted overlap regions is provided to the deviation amount evaluation unit 110.

### (Display Image Output Unit 112)

The display image output unit 112 outputs the synthetic image provided from the synthesis processing unit 109 to the display device (shown in FIG. 1, for example) or the like.

### (1-2) Operation

### (1-2-1) Outline

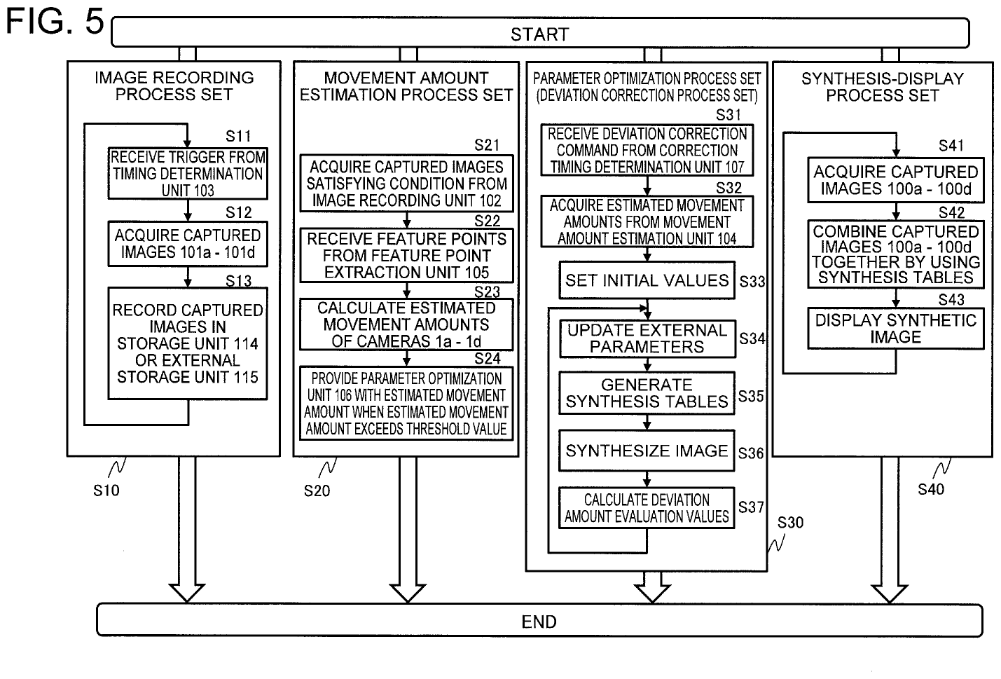

FIG. 5 is a flowchart showing an outline of a process executed by the image processing device 10. As shown in FIG. 5, the image processing device 10 executes an image recording process set S10, a movement amount estimation process set S20, a parameter optimization process set (i.e., deviation correction process set) S30 and a synthesis-display process set S40 in parallel.

In the image recording process set S10, upon receiving a trigger from the timing determination unit 103 (step S11), the image recording unit 102 acquires the captured images 101a to 101d (step S12) and records the captured images 101a to 101d in the storage unit 114, the external storage unit 115 or both of the storage unit 114 and the external storage unit 115 (step S13).

In the movement amount estimation process set S20, the movement amount estimation unit 104 receives the captured images 101a to 101d from the image recording unit 102 and selects captured images not excluded by the outlier exclusion unit 113, i.e., captured images satisfying a predetermined condition (step S21). Subsequently, the movement amount estimation unit 104 receives the feature points in the selected captured images from the feature point extraction unit 105 (step S22). Subsequently, the movement amount estimation unit 104 calculates the estimated movement amount of each camera 1a-1d (step S23). The movement amount estimation unit 104 provides the parameter optimization unit 106 with the estimated movement amount when the estimated movement amount exceeds a threshold value (step S24).

In the parameter optimization process set S30, upon receiving a correction command from the correction timing determination unit 107 (step S31), the parameter optimization unit 106 acquires the estimated movement amount of each camera 1a-1d from the movement amount estimation unit 104 (step S32). The parameter optimization unit 106 sets initial values of the external parameters of the cameras 1a to 1d (step S33) and updates the external parameters (step S34). Subsequently, the synthesis table generation unit 108 generates the synthesis tables as the mapping tables (step S35) and the synthesis processing unit 109 synthesizes an image by using the synthesis tables (step S36). Subsequently, the deviation amount evaluation unit 110 calculates the deviation amount evaluation values in the synthetic image (step S37). The processing of the steps S34 to S37 is executed repeatedly until an optimum solution is obtained.

In the synthesis-display process set S40, the synthesis processing unit 109 acquires the captured images after the transformation (step S41) and combines together the captured images after the transformation by using the synthesis tables (step S42). The display image output unit 112 outputs the synthetic image to the display device. The display device displays a picture based on the synthetic image (step S43).

### (1-2-2) Details of Image Recording Process Set S10

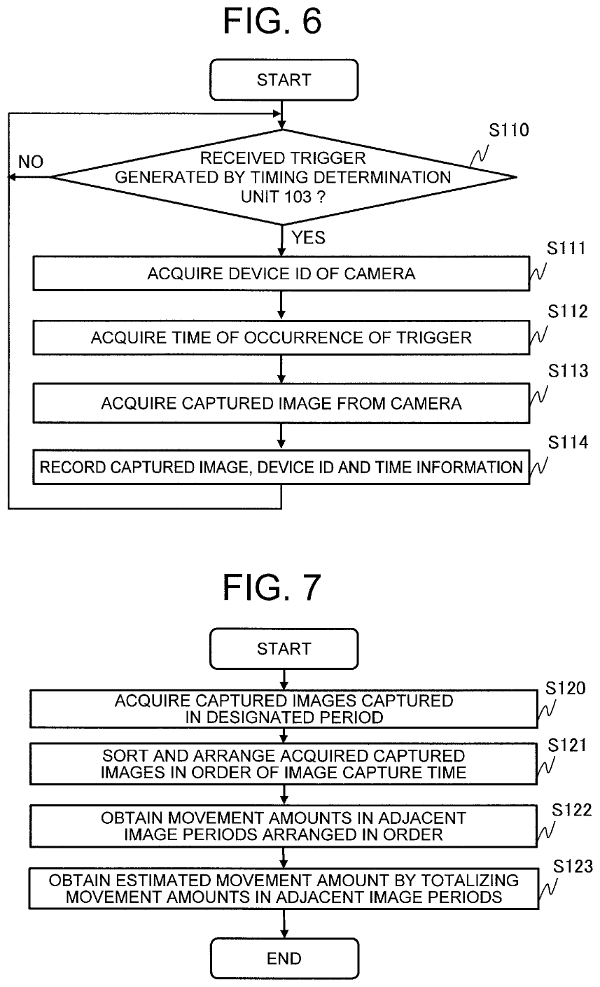

FIG. 6 is a flowchart showing a process executed by the image recording unit 102. First, the image recording unit 102 judges whether or not the trigger has been received from the timing determination unit 103 (step S110). The trigger provides the timing for recording each captured image 100a-100d in the storage unit 114, the external storage unit 115 or both of the storage unit 114 and the external storage unit 115. The trigger includes the device ID for identifying the camera that captured the captured image to be stored.

Upon receiving the trigger, the image recording unit 102 acquires the device ID of the camera (step S111). Subsequently, the image recording unit 102 acquires time information indicating the time of the occurrence of the trigger (step S112). For example, the image recording unit 102 acquires the time of the occurrence of the trigger from a clock installed in a computer forming the image processing device 10. Incidentally, the time information may also be information like an ordinal number clarifying ordinal relationship of captured images to be recorded.

Subsequently, the image recording unit 102 acquires a present captured image from the camera (step S113). Finally, the image recording unit 102 records the captured image in the storage unit 114, the external storage unit 115 or both of the storage unit 114 and the external storage unit 115 while associating the device ID of the camera and time information indicating the image capture time with the captured image (step S114). Incidentally, at the time of receiving the trigger, the image recording unit 102 may also record captured images from a plurality of cameras installed. Alternatively, at the time of receiving the trigger, the image recording unit 102 may exclusively record captured images from cameras satisfying a predetermined condition. Further, when a request for a recorded captured image is received from the movement amount estimation unit 104, the image recording unit 102 provides the movement amount estimation unit 104 with the requested captured image. In the request for a captured image, the movement amount estimation unit 104 designates the requested captured image by designating the device ID of the camera and an image capture time or an image capture period.

### (1-2-3) Details of Movement Amount Estimation Process Set S20

In the movement amount estimation process set S20, the feature points are extracted from the captured image from each camera 1a-1d recorded in the image recording process set S10 and the estimated movement amount of each camera 1a-1d is calculated. The estimated movement amount includes, for example, the three components in the X-axis, Y-axis and Z-axis directions as the translational movement components and the three components of roll, pitch and yaw as the rotational movement components. The calculation of the estimated movement amount is performed in parallel with a correction timing determination process performed by the correction timing determination unit 107. The timing for calculating the estimated movement amount can be each time a constant time interval elapses, or when the captured image is updated in the image recording process set S10.

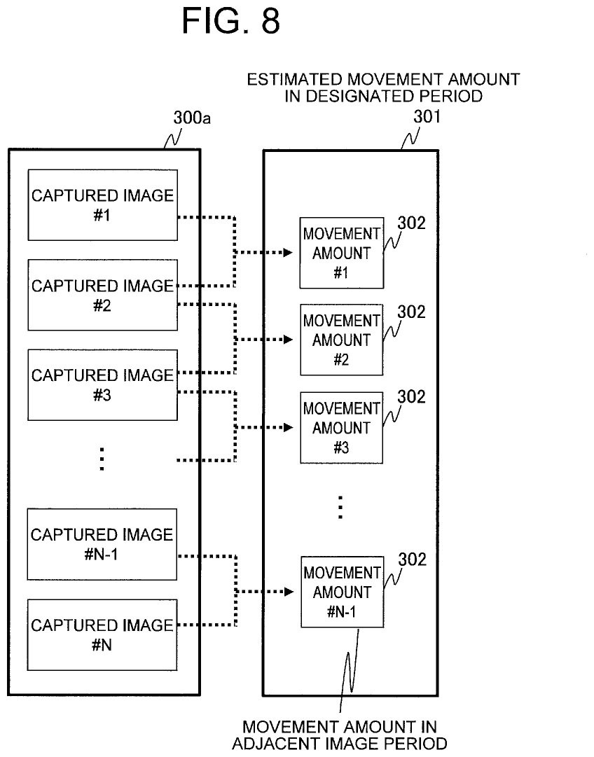

FIG. 7 is a flowchart showing a process executed by the movement amount estimation unit 104. FIG. 8 is a diagram showing the relationship between the captured images recorded by the image recording unit 102 and the movement amounts (#1 to #N−1) 302 in the adjacent image periods.

First, the movement amount estimation unit 104 receives captured images 300a recorded in a designated period for performing the calculation of the estimated movement amount among the captured images from each camera recorded by the image recording unit 102 (step S120).

Subsequently, the movement amount estimation unit 104 sorts and arranges the received captured images 300a in the order of the recording by the image recording unit 102 (step S121). The captured images 300a are arranged in the order of captured images #1 to #N. Here, N is a positive integer indicating the order of the image capture time of a captured image.

Subsequently, the movement amount estimation unit 104 obtains the movement amounts 302 in the adjacent image periods by means of image analysis (step S122). As shown in FIG. 8, each adjacent image period is a period from a captured image #K to a captured image #K+1, where K is an integer larger than or equal to 1 and smaller than or equal to N−1 indicating the order of the image capture time of a captured image. Each of the movement amounts #1 to #N−1 in the adjacent image periods includes the components in the X-axis, Y-axis and Z-axis directions as the translational movement components and the components of roll, pitch and yaw as the rotational movement components. In the example of FIG. 8, N−1 movement amounts (#1 to #N−1) 302 are obtained. For the image analysis, a five-point algorithm is used, for example. However, the image analysis may be executed by a different method as long as the position posture of the camera can be obtained from features in the captured images. Incidentally, the “position posture” means the position, the posture, or both of the position and the posture.

In the image analysis in this case, the coordinates of feature points detected by the feature point extraction unit 105 by image matching between captured images are used. When no feature point is detected by the image matching by the feature point extraction unit 105, the movement amount estimation unit 104 does not calculate the movement amount in the adjacent image period.

Finally, the movement amount estimation unit 104 totalizes the movement amounts 302 satisfying a predetermined condition among the movement amounts 302 in the adjacent image periods and outputs the sum total as the movement amount of each camera in the designated period, that is, the estimated movement amount 301. Here, the predetermined condition is the fact that the movement amount 302 does not correspond to a movement amount judged as an outlier among the movement amounts #1 to #N in the adjacent image periods. Namely, the sum total of the movement amounts obtained by excluding movement amounts judged as outliers among the movement amounts #1 to #N in the adjacent image periods obtained by the image analysis is calculated as the estimated movement amount 301. The process of previously excluding the movement amounts not satisfying the condition is executed by the outlier exclusion unit 113.

The outlier exclusion unit 113 has the function of preventing movement amounts judged as outliers among the movement amounts 302 in the adjacent image periods from being used by the movement amount estimation unit 104 for the calculation of the estimated movement amount 301 in the designated period. Specifically, the outlier exclusion unit 113 prevents a movement amount from being used for the calculation of the estimated movement amount 301 in the designated period when the movement amount is a value that cannot normally occur, such as when a translational movement component of each camera 1a-1d is a great value exceeding a threshold value or when a rotational movement component is a great value exceeding a threshold value.

As shown in FIG. 9 and FIG. 10, it is also possible for the outlier exclusion unit 113 to perform the exclusion of the outliers by taking into account the temporal chronological relationship among the movement amounts 302 in the adjacent image periods. FIG. 9 is a flowchart showing a process executed by the outlier exclusion unit 113. FIG. 10 is an explanatory diagram showing a process executed by the outlier exclusion unit 113 for the exclusion of the outliers. Incidentally, M is a positive integer.

A plurality of captured images 310 shown in FIG. 10 indicate the state in which the captured images from each camera recorded by the image recording unit 102 have been sorted and arranged in the order of the recording. When judging whether a movement amount corresponding to an outlier exists or not by using a captured image (#M) 312 that was captured the M-th, the outlier exclusion unit 113 calculates G1=“movement amount 314”, as a movement amount in an adjacent image period, from the captured image (#M) 312 recorded the M-th and a captured image (#M−1) 311 recorded immediately before the captured image (#M) 312, and obtains G2=“movement amount 315”, as a movement amount in an adjacent image period, from the captured image (#M) 312 recorded the M-th and a captured image (#M+1) 313 recorded immediately after the captured image (#M) 312 (steps S130 and S131).

Subsequently, the outlier exclusion unit 113 obtains G3=“movement amount 316” from the captured image (#M−1) 311 and the captured image (#M+1) 313 recorded immediately before and after the captured image (#M) 312 recorded the M-th (step S132). In this case, G1+G2=G3 holds if the movement amounts have been obtained ideally.

By using this property, the outlier exclusion unit 113 judges that G1=“movement amount 314” or G2=“movement amount 315” includes an outlier if G1+G2 differs greatly from G3 (step S133). In other words, the outlier exclusion unit 113 judges that G1 or G2 as a movement amount is an outlier when|G1+G2−G3| is greater than or equal to a predetermined threshold value.

In the case where |G1+G2−G3| is greater than or equal to the predetermined threshold value, for the exclusion of outliers, the outlier exclusion unit 113 excludes G1=“movement amount 314” and G2=“movement amount 315” and includes G3=“movement amount 316” in the calculation of the estimated movement amount. As above, the outlier exclusion unit 113 handles the movement amounts regarding the M-th captured image (#M) 312 as outliers and excludes G1=“movement amount 314” and G2=“movement amount 315”, as the movement amounts obtained by using the M-th captured image (#M) 312, from the calculation of the estimated movement amount (step S134).

### (1-2-4) Details of Parameter Optimization Process Set S30

In the parameter optimization process set S30, the correction timing determination unit 107 determines the device ID of the camera as the target of the parameter optimization process, i.e., the deviation correction process, based on the estimated movement amount of each camera 1a-1d provided from the movement amount estimation unit 104 and the deviation amount evaluation value of each camera 1a-1d in the synthetic image provided from the deviation amount evaluation unit 110. Thereafter, the parameter optimization unit 106 obtains the external parameter of the camera as the target of the parameter optimization process. The external parameter includes, for example, the three components in the X-axis, Y-axis and Z-axis directions as the translational movement components and the three components of roll, pitch and yaw as the rotational movement components.

After receiving the device ID of the camera as the target of the parameter optimization process from the correction timing determination unit 107, the parameter optimization unit 106 sets the values of the external parameter of the camera as the target of the parameter optimization process as the values of the external parameter of a moved camera.

Subsequently, the parameter optimization unit 106 changes the external parameter of the camera as the target of the parameter optimization process. The way of changing the external parameter varies depending on the method of the parameter optimization process. Then, the parameter optimization unit 106 provides the synthesis table generation unit 108 with the present external parameters of the plurality of cameras.

The synthesis table generation unit 108 generates the synthesis table for generating the synthetic image in regard to each camera based on the external parameter of each camera 1a-1d provided from the parameter optimization unit 106 and the internal, parameter and the distortion correction parameter of each camera 1a-1d.

The synthesis processing unit 109 generates one synthetic image by combining the captured images after the transformation corresponding to the captured images from the cameras 1a to 1d by using the synthesis tables generated by the synthesis table generation unit 108.

The deviation amount evaluation unit 110 obtains the deviation amount evaluation value in the generated synthetic image based on the generated synthetic image and the synthesis tables used at the time of generating the synthetic image, and feeds back the deviation amount evaluation value to the parameter optimization unit 106. The parameter optimization unit 106 executes the parameter optimization process so as to reduce the deviation amount evaluation value by changing the external parameter of the camera as the target of the parameter optimization process based on the deviation amount evaluation value obtained as the feedback.

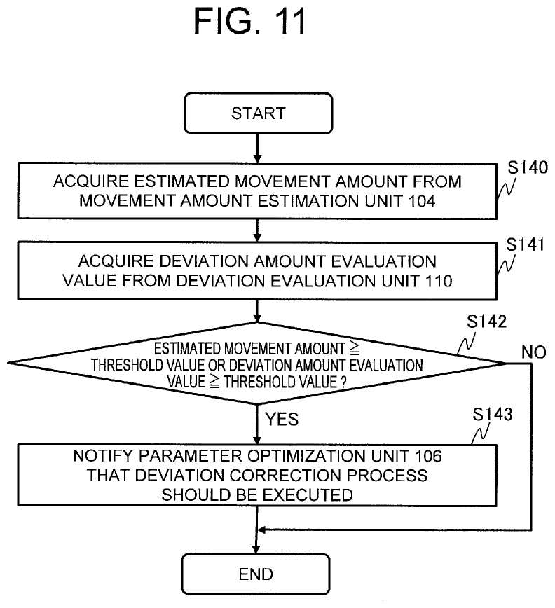

FIG. 11 is a flowchart showing a process executed by the correction timing determination unit 107. At a time when the optimization process of the external parameter of a camera has become necessary, the correction timing determination unit 107 notifies the parameter optimization unit 106 of the device ID of the camera as the target of the parameter optimization process. When the position posture deviation (i.e., movement) has occurred to a plurality of cameras, the correction timing determination unit 107 notifies the parameter optimization unit 106 of the device IDs of the plurality of cameras. The timing of the parameter optimization process (i.e., the deviation correction process) is determined automatically based on the estimated movement amount of each camera and the deviation amount evaluation value in the synthetic image. However, this timing may also be determined by a manual operation performed by the user.

A method of automatically determining the timing for the correction will be described below. First, the correction timing determination unit 107 acquires the estimated movement amount of each camera, the deviation amount evaluation value in the synthetic image, or both of them from the movement amount estimation unit 104 or the deviation amount evaluation unit 110 as an index for judging whether the parameter optimization process is necessary or not (steps S140 and S141).

Subsequently, the correction timing determination unit 107 compares the acquired estimated movement amount of each camera with a threshold value, or compares the acquired deviation amount evaluation value in the synthetic image with a threshold value (step S142). For example, when the estimated movement amount exceeds its threshold value or the deviation amount evaluation value exceeds its threshold value, the correction timing determination unit 107 notifies the parameter optimization unit 106 that the parameter optimization process should be executed (step S143). The condition using a threshold value for executing the deviation correction process can be set as various conditions, such as when the estimated movement amount of each camera exceeds its threshold value, when the deviation amount evaluation value in the synthetic image exceeds its threshold value, when both of these conditions are satisfied, and so forth.

Further, the correction timing determination unit 107 may include a configuration for detecting the occurrence of a situation where the deviation correction process cannot be executed based on the result of comparison between the deviation amount evaluation value in the synthetic image and a predetermined threshold value and notifying the user of the occurrence of the situation. The case where the deviation correction process cannot be executed is, for example, a case where position posture deviation that is so great as to disable the formation of an overlap region between captured images has occurred to a camera. The method of notifying the user can be, for example, displaying the notification in superimposition on the displayed synthetic image.

The parameter optimization unit 106 receives the estimated movement amount of each camera from the movement amount estimation unit 104, receives the deviation amount evaluation value in the synthetic image from the deviation amount evaluation unit 110, and outputs the external parameter for the deviation correction process. Incidentally, the parameter optimization process for the process of correcting the deviation, in the synthetic image is executed by the movement amount estimation unit 104 and the deviation correction unit 100.

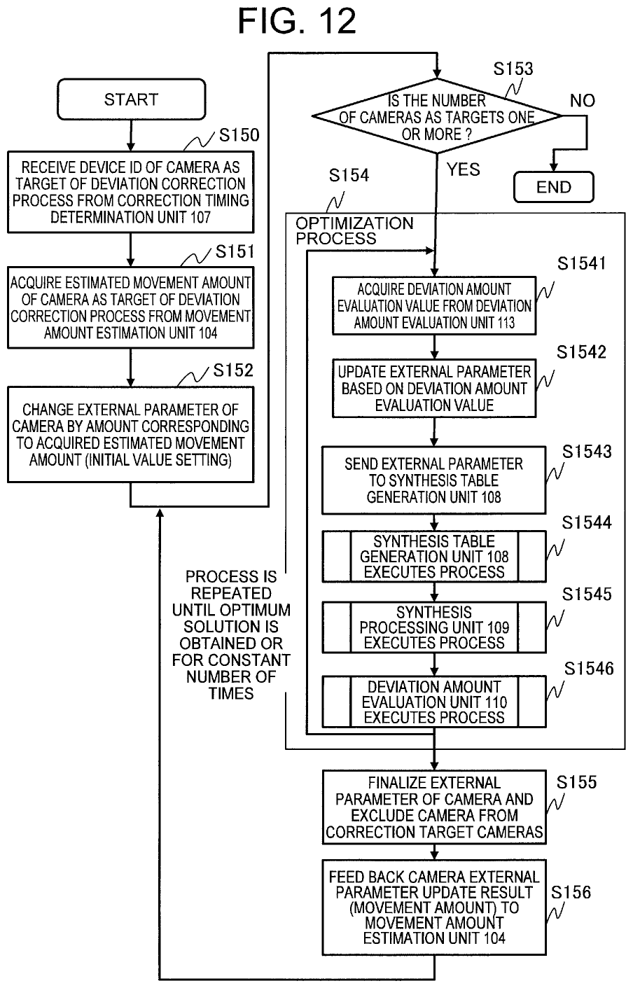

FIG. 12 is a flowchart showing the parameter optimization process (i.e., the deviation correction process) executed by the image processing device 10 according to the first embodiment. First, the parameter optimization unit 106 receives the device ID of the camera as the target of the deviation correction process from the correction timing determination unit 107 (step S150).

Subsequently, the parameter optimization unit 106 receives the estimated movement amount of each camera as the target of the parameter optimization process from the movement amount estimation unit 104 (step S151). The estimated movement amount includes, for example, the three components in the X-axis, Y-axis and Z-axis directions as the translational movement components and the three components of roll, pitch and yaw as the rotational movement components.

Subsequently, the parameter optimization unit 106 changes the external parameter of the camera as the target of the parameter optimization process based on the estimated movement amount of each camera 1a-1d acquired from the movement amount estimation unit 104 (step S152). Incidentally, the external parameter at the time of the installation of the camera or at the initial startup of the camera is acquired by camera calibration work performed by using a calibration board having a camera calibration pattern.

FIG. 13 is an explanatory diagram showing calculation formulas used for the update of the external parameter performed by the parameter optimization unit 106. As shown in FIG. 13, the external parameter (namely, external parameter vector) P1 after the update (namely, at a time t) is represented as follows:

P1=(X, Y, Z, roll, pitch, yaw)

Here, X, Y and Z represent external parameters in the X-axis, Y-axis and Z-axis directions, and roll, pitch and yaw represent external parameters in roll, pitch and yaw directions.

Further, the external parameter (namely, external parameter vector) P0 before the update (namely, at a time 0) is represented as follows:

P0=(X_0, Y_0, Z_0, roll_0, pitch_0, yaw_0)

Here, X_0, Y_0 and Z_0 represent external parameters in the X-axis, Y-axis and Z-axis directions, and roll_0, pitch_0 and yaw_0 represent external parameters in the roll, pitch and yaw directions.

Furthermore, a movement vector Pt indicating the movement, i.e., the position posture deviation, from the time 0 to the time t is represented as follows:

Pt=(X_t, Y_t, Z_t, roll_t, pitch_t, yaw_t)

Here, X_t, Y_t and Z_t represent movement amounts (i.e., distances) in the X-axis, Y-axis and Z-axis directions, and roll_t, pitch_t and yaw_t represent movement amounts (i.e., angles) in the roll, pitch and yaw directions.

In this case, the following expression (1) holds:

P1−P0+Pt (1)

Incidentally, the external parameter P0 before the update, at the time of the first update, is the external parameter obtained by the camera calibration. Namely, as shown in the expression (1), the external parameter after the update is a parameter obtained by adding the elements of the movement vector Pt obtained by the movement amount estimation unit 104 to the external parameter at the time of the installation.

Subsequently, the parameter optimization unit 106 judges the number of cameras as the targets of the parameter optimization process based on the number the device IDs of cameras received from the correction timing determination unit 107 (step S153). When there is no camera as the target of the parameter optimization process, the parameter optimization process by the parameter optimization unit 106 is ended.

When there is a camera as the target of the parameter optimization process (i.e., when the judgment is YES in the step S153), the parameter optimization process is executed in order to correct the deviation in the synthetic image (step S154). In this case, when the number of cameras as the targets of the parameter optimization process is two or more, the external parameter optimization process of a camera whose estimated movement amount acquired from the movement amount estimation unit 104 is small is executed first. This is because the camera whose estimated movement amount is small can be regarded as a camera with less errors and high reliability.

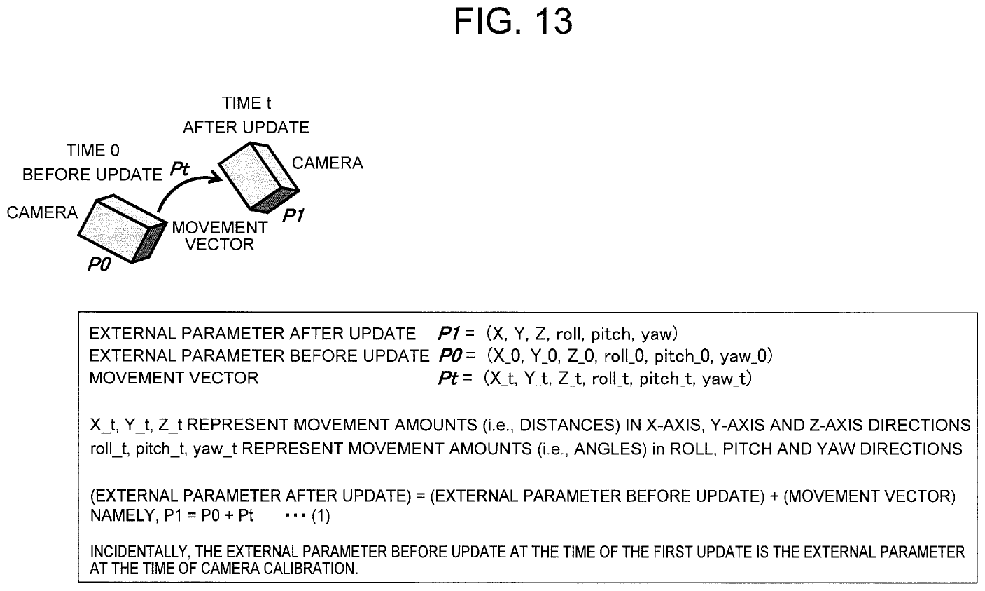

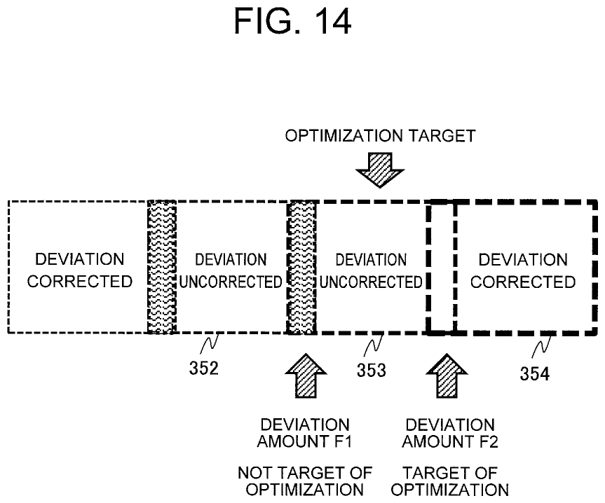

FIG. 14 is an explanatory diagram showing an example of the deviation correction process (i.e., the parameter optimization process) executed by the parameter optimization unit 106 of the image processing device 10 according to the first embodiment. FIG. 14 shows a case where the number of cameras as the targets of the parameter optimization process is two. In this case, for a captured image 353 from a camera as the target of the parameter optimization process, there exist two cameras whose captured images overlap with the captured image 353 and one of the two cameras have not undergone the parameter optimization. Namely, captured images 352 and 354 overlap with the captured image 353 from the camera as the target of the parameter optimization process. In this example, the deviation correction of the camera that captured the captured image 352 has not been made (i.e., uncorrected).

Subsequently, the parameter optimization unit 106 repeats a process of obtaining an external parameter for the deviation correction process and updating the external parameter of the camera by using the obtained external parameter (step S154), and excludes the camera whose deviation correction process is completed from the targets of the parameter optimization process and regards the camera as a deviation-corrected camera (step S155). Further, when the external parameter has been updated, the parameter optimization unit 106 feeds back the device ID of the deviation-corrected camera and the external parameter after the correction to the movement amount estimation unit 104 (step S156).

In the parameter optimization process (step S154), the parameter optimization unit 106 repeats the process so as to change the external parameter of the camera, receive the deviation amount evaluation value in the synthetic image at that time, and reduce the deviation amount evaluation value. Various methods such as a genetic algorithm are usable as the algorithm of the parameter optimization process used in this step.

First, the parameter optimization unit 106 acquires the deviation amount evaluation value of the camera as the target of the optimization from the deviation amount evaluation unit 110 (step S1541). The deviation amount evaluation value is acquired in regard to each captured image from a camera with which the targeted captured image overlaps at the time of the synthesis. The parameter optimization unit 106 receives the deviation amount evaluation value from the deviation amount evaluation unit. 110 in regard to each combination of captured images after the transformation. For example, when there exist the cameras 1a to 1d, the parameter optimization unit 106 receives the deviation amount evaluation value in an overlap region between captured images after the transformation corresponding to the captured images from the cameras 1a and 1b, the deviation amount evaluation value in an overlap region between captured images after the transformation corresponding to the captured images from the cameras 1a and 1c, and the deviation amount evaluation value in an overlap region between captured images after the transformation corresponding to the captured images from the cameras 1a and 1d as the deviation amount evaluation value of the camera 1a.

Thereafter, the parameter optimization unit 106 updates the external parameter of each camera based on the acquired deviation amount evaluation value (step S1542). The external parameter update process varies depending on an optimization algorithm that is used. As a typical optimization algorithm, there are methods such as the Newton's method and the genetic algorithm. However, the method of the external parameter update process of each camera is not limited to these methods.

Subsequently, the parameter optimization unit 106 sends the updated external parameter of the camera to the synthesis table generation unit 108 together with the external parameters of the other cameras (step S1543). The synthesis table generation unit 108 generates the synthesis table, to be used at the time of the synthesis, in regard to each camera based on the external parameter of each camera (step S1544).

The synthesis processing unit 109 generates one synthetic image by combining the captured images acquired from the cameras by using the synthesis tables of the cameras generated by the synthesis table generation unit 108 (step S1545).

The deviation amount evaluation unit 110 obtains the deviation amount evaluation value of each camera based on the synthesis tables of the cameras and the captured images used by the synthesis processing unit 109 at the time of the image synthesis, and outputs the obtained deviation amount evaluation value to the parameter optimization unit 106 (step S1546). The external parameter for correcting the deviation in the synthetic image is calculated by repeating the above process until the deviation amount evaluation value becomes less than or equal to a constant threshold value. Alternatively, it is also possible to calculate the external parameter for the correction by repeating the above process for a previously designated number of times.

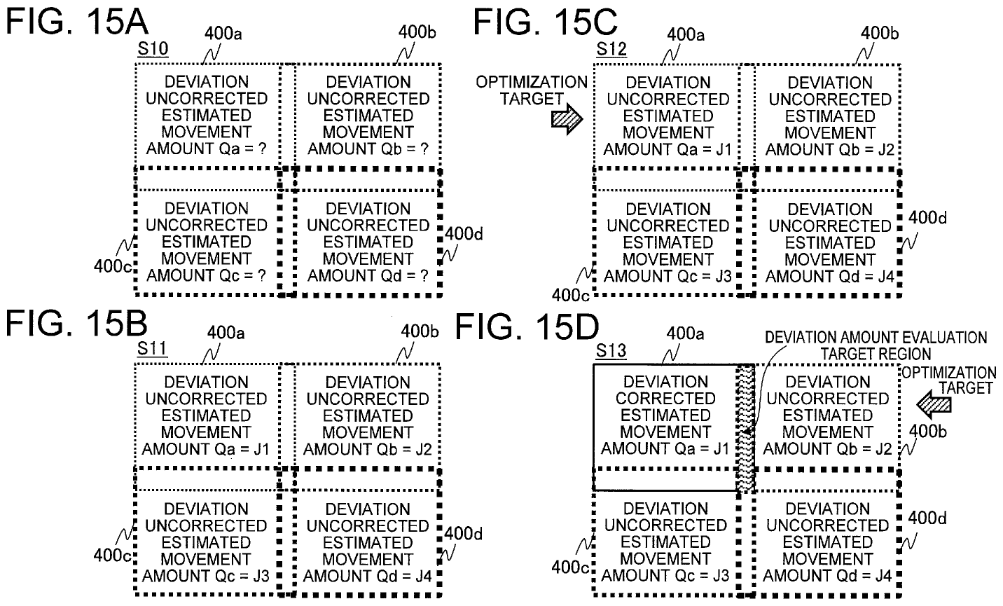

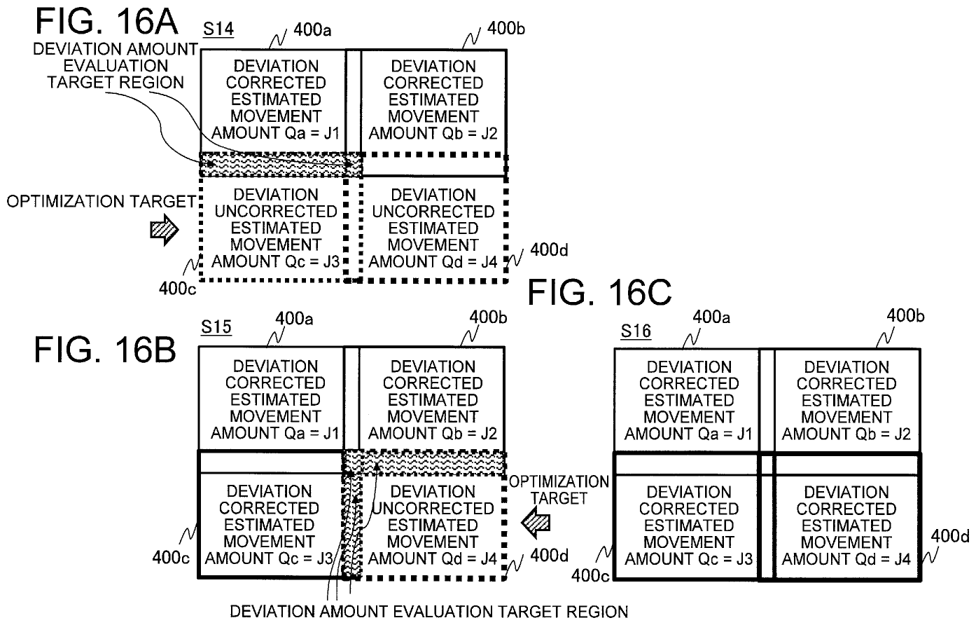

FIGS. 15A to 15D and FIGS. 16A to 16C are explanatory diagrams showing the order of correcting the external parameters of the cameras 1a to 1d. In the figures, the reference characters 400a to 400d respectively represent the captured images captured by the cameras 1a to 1d. As shown as step S10 in FIG. 15A, the cameras 1a to 1d have been designated by the correction timing determination unit 107 as the targets of the parameter optimization process.

As shown as step S11 in FIG. 15B, the parameter optimization unit 106 acquires the values J1 to J4 of the estimated movement amounts Qa to Qd of the cameras as the targets of the parameter optimization process from the movement amount estimation unit 104 and updates the external parameter of each camera 1a-1d based on the acquired values J1 to J4 (steps S150 to S152 in FIG. 12).

Subsequently, as shown as step S12 in FIG. 15C, the parameter optimization unit 106 sets the cameras as the targets of the parameter optimization process in ascending order of the estimated movement amount. The description here will be given of an example in which the values J1 to J4 of the estimated movement amounts Qa to Qd of the cameras 1a to 1d that captured the captured images 400a to 400d satisfy a relationship of J1<J2<J3<J4. Thus, the parameter optimization process is executed first for the camera 1a that captured the captured image 400a in the case where the estimated movement amount Qa equals J1. Here, the parameter optimization unit 106 optimizes the external parameter of the camera by acquiring the deviation amount evaluation values in the overlap regions of the cameras 1a to 1d from the deviation amount evaluation unit 110. In this case, the cameras 1b, 1c and 1d outputting the overlapping captured images 400b, 400c and 400d are in a deviation uncorrected state. Therefore, the correction of the camera 1a is finalized without executing the feedback by use of the deviation amount evaluation value (i.e., the step S154 in FIG. 12).

Subsequently, as shown as step S13 in FIG. 15D, the parameter optimization process is executed for the camera 1b that captured the captured image 400b in the case where the movement amount Qb equals J2 that is the second smallest. The parameter optimization process of the camera 1b is executed based on the deviation amount evaluation value in the overlap region between the captured images 400a and 400b (step S154 in FIG. 12).

Subsequently, as shown as step S14 in FIG. 16A, the parameter optimization process is executed for the camera 1c that captured the captured image 400c in the case where the movement amount Qc equals J3 that is the third smallest. The parameter optimization process of the camera 1c is executed based on the deviation amount evaluation value in the overlap region between the captured images 400a and 400c (step S154 in FIG. 12).

Subsequently, as shown as step S15 in FIG. 16B, the parameter optimization process is executed for the camera 1d that captured the captured image 400d in the case where the movement amount Qd equals J4 that is the fourth smallest. The parameter optimization process of the camera 1d is executed based on the deviation amount evaluation value in the overlap region between the captured images 400b and 400d and based on the deviation amount evaluation value in the overlap region between the captured images 400c and 400d (step S154 in FIG. 12). By executing the above-described processes, the correction of a plurality of cameras to which the deviation has occurred is made (step S16).

The synthesis table generation unit 108 generates the synthesis tables, to be used at the time of the image synthesis, based on the parameters of each camera 1a-1d received from the parameter optimization unit 106. The parameters include the external parameter, the internal parameter and the distortion correction parameter.

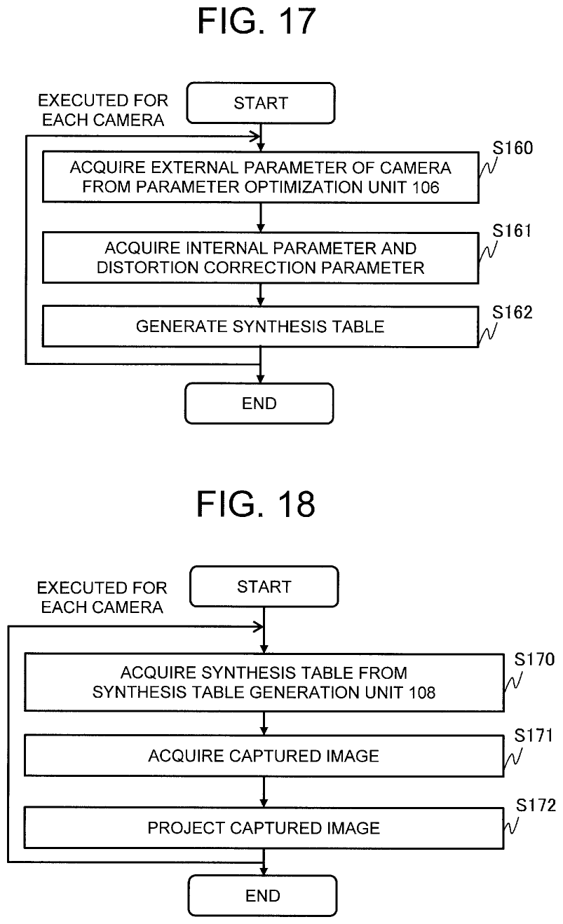

FIG. 17 is a flowchart showing a process executed by the synthesis table generation unit 108. First, the synthesis table generation unit 108 acquires the external parameter of a camera from the parameter optimization unit 106 (step S160).

Subsequently, the synthesis table generation unit 108 acquires the internal parameter and the distortion correction parameter of the camera. Incidentally, the internal parameter and the distortion correction parameter of the camera may also be previously stored in a memory of the synthesis table generation unit 108, for example.

Finally, the synthesis table generation unit 108 generates the synthesis table based on the received external parameter of each camera and the internal parameter and the distortion correction parameter in regard to the camera. The generated synthesis table is provided to the synthesis processing unit 109.

The above-described process is executed for each camera. Incidentally, the method of generating the synthesis table is changed depending on the camera used. For example, a projection method (e.g., central projection method, equidistant projection method, etc.) is used for generating the synthesis table. Further, a distortion model (e.g., radial direction distortion model, circumferential direction distortion model, etc.) is used for correcting lens distortion. However, the method of generating the synthesis table is not limited to the above examples.

FIG. 18 is a flowchart showing a process executed by the synthesis processing unit 109. First, the synthesis processing unit 109 acquires the synthesis table corresponding to a camera from the synthesis table generation unit 108 (step S170). Subsequently, the synthesis processing unit 109 acquires the captured image captured by the camera (step S171). Finally, the synthesis processing unit 109 projects (i.e., displays) the captured image based on the synthesis table (step S172). For example, a part of the image 205 is generated from the captured image 202a in FIG. 3B based on the synthesis table 204a. One synthetic image is generated by combining the captured images after the transformation by executing the same process for each camera. For example, the remaining part of the image 205 is generated from the captured images 202b, 202c and 202d in FIG. 3B based on the synthesis tables 204b, 204c and 204d. Incidentally, it is also possible to perform alpha blend on each overlap region where images overlap with each other. The alpha blend is a method of combining two images by using an a value as a coefficient. The e value is a coefficient that takes on values in a range of [0, 1], and is a value representing the degree of transparency.

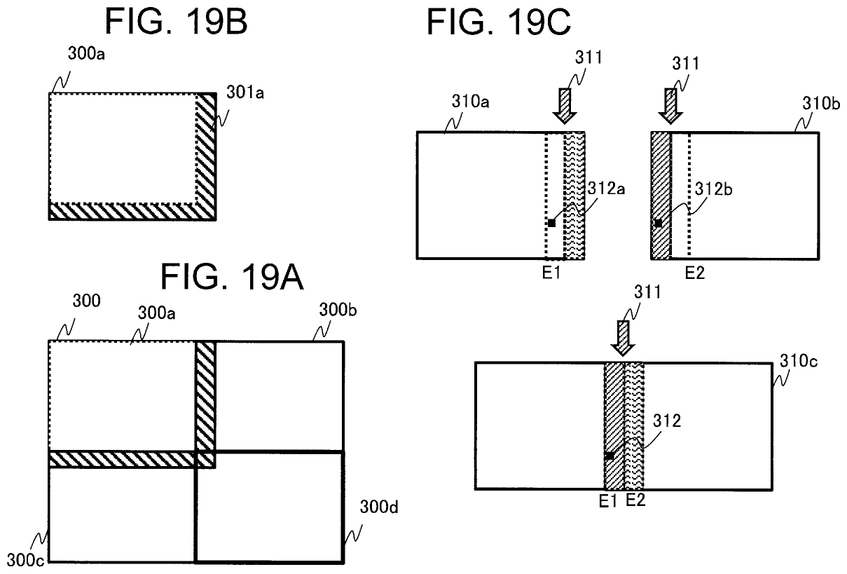

FIGS. 19A to 19C are explanatory diagrams showing a process executed by the deviation amount evaluation unit 110 for obtaining the deviation amount evaluation value. As shown in FIGS. 19A to 19C, the deviation amount evaluation unit 110 outputs the deviation amount evaluation value of each camera 1a-1d based on the captured images 300a from the cameras 1a to 1d combined together by the synthesis processing unit 109 and the synthesis tables as the mapping tables used at the time of the synthesis. As shown in FIG. 19B, the captured image 300a-300d from each camera 1a-1d includes a part overlapping with another captured image. As shown in FIG. 198, the hatched part 301a in the captured image 300a is a part as an overlap region overlapping with another captured image.

As shown in FIG. 19C, the deviation amount evaluation unit 110 obtains the deviation amount evaluation value based on the part as the overlap region. A description will be given below of a process for obtaining the deviation amount evaluation value of a synthetic image 310c when two captured images 310a and 310b after the transformation have been combined together. The synthetic image 310c is generated by combining the captured images 310a and 310b after the transformation together at a position 311 as the boundary. In this case, in the two captured images 310a and 310b after the transformation, a part where pixels overlap with each other is formed in the wavy lined part (i.e., the region on the right-hand side) and the hatched part (i.e., the region on the left-hand side). The deviation amount evaluation unit 110 obtains the deviation amount evaluation value from this overlapping part.

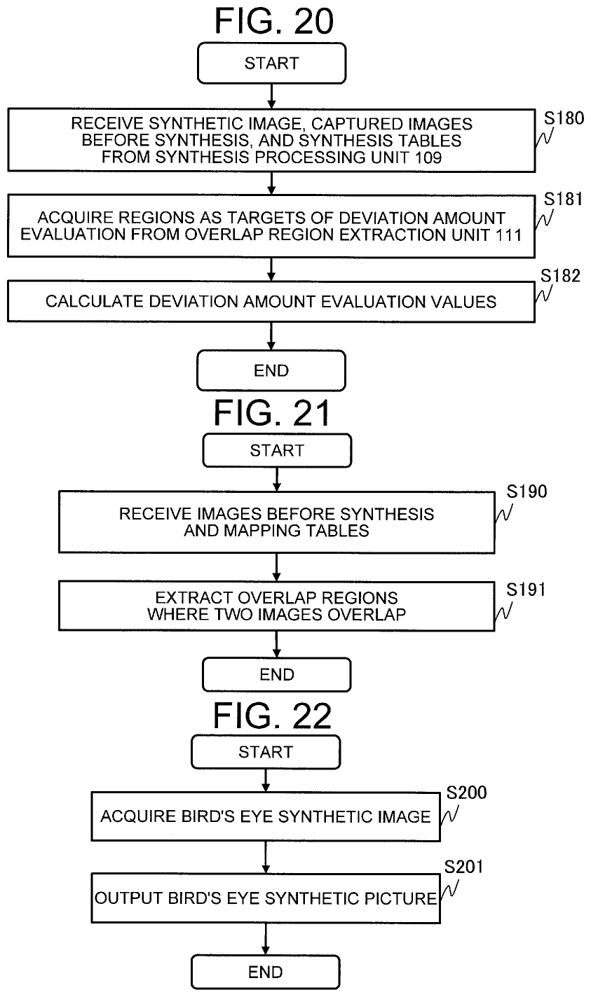

FIG. 20 is a flowchart showing a process executed by the deviation amount evaluation unit 110. First, the deviation amount evaluation unit 110 acquires, from the synthesis processing unit 109, the synthetic image, the captured image from each camera 1a-1d, and the synthesis tables as the mapping tables used at the time of the synthesis (step S180). Subsequently, the deviation amount evaluation unit 110 acquires the parts where images overlap with each other from the overlap region extraction unit 111 (step S181). Thereafter, the deviation amount evaluation unit 110 obtains the deviation amount evaluation values based on the overlapping parts (step S182).

The deviation amount evaluation unit 110 may calculate the deviation amount evaluation value by accumulating luminance differences between pixels in the overlap region. Alternatively, the deviation amount evaluation unit 110 may calculate the deviation amount evaluation value by performing the matching of feature points in the overlap region and accumulating the distances between the matched feature points. Further, the deviation amount evaluation unit 110 may calculate the deviation amount evaluation value by obtaining the image similarity level by using an ECC (Elliptic Curve Cryptography) algorithm. Furthermore, the deviation amount evaluation unit 110 may calculate the deviation amount evaluation value between images by obtaining phase-limited correlation. It is also possible to use not an evaluation value that is optimized so as to minimize the deviation amount evaluation value but an evaluation value that is optimized by maximizing the evaluation value. Further, it is also possible to use an evaluation value that becomes optimum when the evaluation value reaches 0. The deviation amount evaluation value of each camera can be obtained by executing the above-described process for each camera.

FIG. 21 is a flowchart showing a process executed by the overlap region extraction unit 111. When the process of combining the captured images after the transformation is executed, the overlap region extraction unit 111 outputs the overlap regions between the captured images after the transformation adjoining each other. First, the overlap region extraction unit 111 receives the captured images after the transformation and the synthesis tables as the mapping tables from the deviation amount evaluation unit 110 (step S190). Subsequently, the overlap region extraction unit 111 outputs images of the overlap regions where two captured images after the transformation overlap with each other at the time of the synthesis, or data representing the regions as numerical values, based on the synthesis tables (step S191).

### (1-2-5) Details of Synthesis-Display Process Set S40

In the synthesis-display process set S40 shown in FIG. 5, a plurality of captured images after the transformation corresponding to the plurality of captured images captured by the plurality of cameras are combined into one image based on the synthesis tables of the cameras generated by the synthesis table generation unit 108, and the obtained synthetic image is outputted to the display device 18 via the display device interface 15.

FIG. 22 is a flowchart showing a process executed by the display image output unit 112. The display image output unit 112 acquires the synthetic image (e.g., bird's eye synthetic image) generated by the synthesis processing unit 109 (step S200). Subsequently, the display image output unit 112 converts the acquired synthetic image to picture data in a format that can be handled by the display device (e.g., bird's eye synthetic picture) and outputs the picture data (step S201).

### (1-3) Effect

As described above, with the image processing device 10, the image processing method or the image processing program according to the first embodiment, the deviation amount evaluation values in the synthetic image are fed back to the parameter optimization process (i.e., the deviation correction process), and thus the deviation that has occurred to the overlap regions of the plurality of captured images after the transformation constituting the synthetic image due to the position posture change of the cameras 1a to 1d can be corrected with high accuracy.

Further, with the image processing device 10, the image processing method or the image processing program according to the first embodiment, the estimated movement amounts of the cameras 1a to 1d are calculated at time intervals facilitating the matching between feature points in the plurality of captured images after the transformation constituting the synthetic image, and thus the deviation that has occurred to the overlap regions of the plurality of captured images after the transformation constituting the synthetic image due to the position posture change of the cameras 1a to 1d can be corrected with high accuracy.

Furthermore, with the image processing device 10, the image processing method or the image processing program according to the first embodiment, the external parameter of each camera 1a-1d is optimized in order to correct the deviation that has occurred to the overlap regions of the plurality of captured images after the transformation constituting the synthetic image. Accordingly, the deviation occurring to the overlap regions in the synthetic image can be corrected without the need of performing the manual calibration work.

Moreover, with the image processing device 10, the image processing method or the image processing program according to the first embodiment, the maintenance cost in a monitoring system using a plurality of cameras for the purpose of monitoring can be reduced since the deviation can be corrected with high accuracy and without manual operations.

### (2) Second Embodiment

An image processing device according to a second embodiment differs from the image processing device 10 according to the first embodiment in processing performed by the parameter optimization unit 106. In regard to the other features, the second embodiment is the same as the first embodiment. Therefore, FIG. 1 and FIG. 2 will be referred to in the description of the second embodiment.

In the second embodiment, the parameter optimization unit 106 obtains the external parameter, to be used for correcting the deviation in the synthetic image, for each camera 1a-1d based on the estimated movement amount of each camera 1a-1d acquired from the movement amount estimation unit 104 and the deviation amount evaluation value in the synthetic image acquired from the deviation amount evaluation unit 110. The external parameter is made up of the three components in the X-axis, Y-axis and Z-axis directions as the translational movement components and the three components of roll, pitch and yaw as the rotational movement components.

The parameter optimization unit 106 changes the external parameter so as to reduce the deviation amount evaluation value in the synthetic image based on the estimated movement amount of each camera 1a-1d obtained by the movement amount estimation unit 104 and the deviation amount evaluation value in the synthetic image obtained by the deviation amount evaluation unit 110. The optimization process of the external parameter of each camera is executed by, for example, repeating the aforementioned processes (H2) to (H5) in this order after executing the aforementioned processes (H1) to (H5).

Further, when the position posture deviation has occurred to two or more cameras among the cameras 1a to 1d, the parameter optimization unit 106 executes the process of determining a captured image as the reference among the captured images 101a to 101d and the process of determining the order of performing the deviation correction process. Furthermore, at the time when the deviation correction process has been executed, the parameter optimization unit 106 provides the movement amount estimation unit 104 with the feedback information for resetting the estimated movement amount of the camera. This feedback information includes the device ID indicating the camera as the target of the resetting of the estimated movement amount and the external parameter after the correction.

In the second embodiment, when the position posture deviation has occurred to two or more cameras among the cameras 1a to 1d, the parameter optimization unit 106 simultaneously corrects the deviation of all the cameras to which the position posture deviation has occurred. Further, at the time when the deviation correction process has been executed, the parameter optimization unit 106 provides the movement amount estimation unit 104 with the feedback information for resetting the estimated movement amounts of the cameras. This feedback information includes the device IDs indicating the cameras as the targets of the resetting of the estimated movement amounts and the external parameters after the correction.

Thereafter, the parameter optimization unit 106 receives the estimated movement amounts of the cameras from the movement amount estimation unit 104, receives the deviation amount evaluation values in the synthetic image from the deviation amount evaluation unit 110, and outputs the external parameters for the deviation correction process. Incidentally, the deviation correction process for correcting the deviation in the synthetic image is executed by a feedback loop formed of the movement amount estimation unit 104, the parameter optimization unit 106, the synthesis table generation unit 108, the synthesis processing unit 109 and the deviation amount evaluation unit 110.

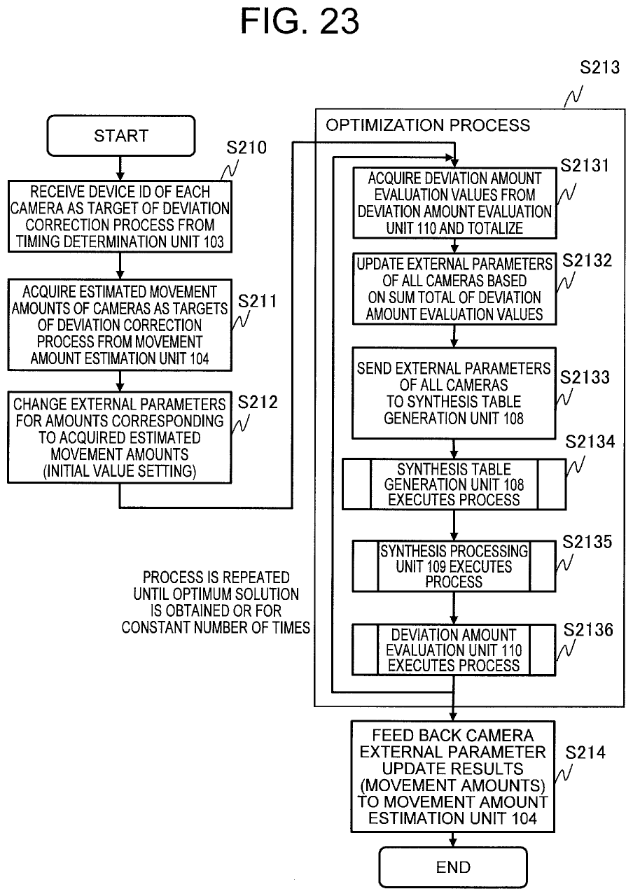

FIG. 23 is a flowchart showing the parameter optimization process (i.e., the deviation correction process) executed by the image processing device according to the second embodiment. First, the parameter optimization unit 106 receives the device IDs of the cameras as the targets of the deviation correction process, that is, the targets of the parameter optimization process, from the correction timing determination unit 107 (step S210).

Thereafter, the parameter optimization unit 106 receives the estimated movement amounts of the cameras as the targets of the parameter optimization process from the movement amount estimation unit 104 (step S211). The estimated movement amount includes, for example, the three components in the X-axis, Y-axis and Z-axis directions as the translational movement components and the three components of roll, pitch and yaw as the rotational movement components.

Subsequently, the parameter optimization unit 106 changes the external parameters of the cameras as the targets of the parameter optimization process based on the estimated movement amount of each camera 1a-1d acquired from the movement amount estimation unit 104 (step S212). Incidentally, the external parameter at the time of the installation of the camera or at the initial startup of the camera is acquired by camera calibration work performed by using a calibration board having a camera calibration pattern. The calculation formulas used for the update of the external parameter performed by the parameter optimization unit 106 are shown in FIG. 13.

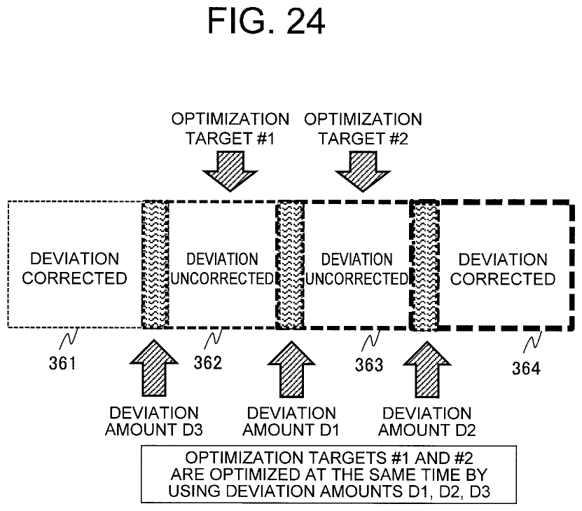

When there is a camera as the target of the parameter optimization process, the external parameter optimization process is executed (step S213). In this case, when the number of cameras as the targets of the parameter optimization process is two or more, the external parameters of the two or more cameras are optimized at the same time. FIG. 24 is an explanatory diagram showing an example of the deviation correction process executed by the parameter optimization unit 106 of the image processing device according to the second embodiment. In FIG. 24, there exist two deviation uncorrected cameras 1b and 1c as the targets of the parameter optimization process. Overlap regions exist in the captured images 362 and 363 captured by these two cameras 1b and 1c and the captured images 361 and 364 captured by the cameras 1a and 1d. Further, there exists a deviation amount D3 between the captured images 361 and 362, there exists a deviation amount D1 between the captured images 362 and 363, and there exists a deviation amount D2 between the captured images 363 and 364.

Subsequently, when the external parameters to be used for correcting the deviation have been obtained, the parameter optimization unit 106 performs the update by using the obtained external parameters as the external parameters of the cameras and ends the parameter optimization process. Further, when the external parameters are updated, the parameter optimization unit 106 feeds back the device IDs of the corrected cameras and the external parameters after the correction to the movement amount estimation unit 104 (step S214).

In the parameter optimization process (step S213), the parameter optimization unit 106 repeats the process so as to change the external parameters of the cameras, receive the deviation amount evaluation values in the synthetic image at that time, and reduce the deviation amount evaluation values. As the algorithm of the parameter optimization process, the genetic algorithm is usable, for example. However, the algorithm of the parameter optimization process can also be a different algorithm.

First, the parameter optimization unit 106 acquires the deviation amount evaluation value(s) of one or more cameras as the optimization target(s) from the deviation amount evaluation unit 110 (step S2131). This deviation amount evaluation value is acquired in regard to each captured image from a camera with which the targeted captured image overlaps at the time of the synthesis. The parameter optimization unit 106 receives the deviation amount evaluation value from the deviation amount evaluation unit 110 in regard to each combination of captured images. For example, when there exist the cameras 1a to 1d, the parameter optimization unit 106 acquires the evaluation values of the deviation amounts D3 and D1 in regard to the camera 1b as an optimization target #1 and the evaluation values of the deviation amounts D2 and D1 in regard to the camera 1c as an optimization target #2 as shown in FIG. 24.

Thereafter, the parameter optimization unit 106 updates the external parameters of the plurality of cameras as the targets by using the sum total of all the acquired deviation amount evaluation values as the deviation amount evaluation value (step S2132). The external parameter update process varies depending on the optimization algorithm that is used. As a typical optimization algorithm, there are methods such as the Newton's method and the genetic algorithm. However, the method of the external parameter update process is not limited to these methods.

Subsequently, the parameter optimization unit 106 sends the updated external parameters of the cameras to the synthesis table generation unit 108 together with the external parameters of the other cameras (step S2133). The synthesis table generation unit 108 generates the synthesis table, to be used at the time of the synthesis, for each camera based on the external parameters of the plurality of cameras (step S2134).

The synthesis processing unit 109 generates one synthetic image by combining the captured images acquired from the cameras by using the synthesis tables of the cameras generated by the synthesis table generation unit 108 (step S2135).

The deviation amount evaluation unit 110 obtains the deviation amount evaluation value of each camera based on the synthesis tables of the cameras and the captured images after the transformation used by the synthesis processing unit 109 at the time of the image synthesis, and outputs the obtained deviation amount evaluation values to the parameter optimization unit 106 (step S2136). The external parameters used for correcting the deviation in the synthetic image are calculated by repeating the above process until the deviation amount evaluation values become less than or equal to a constant threshold value. Alternatively, it is also possible to calculate the external parameters for the correction by repeating the above process for a previously designated number of times.

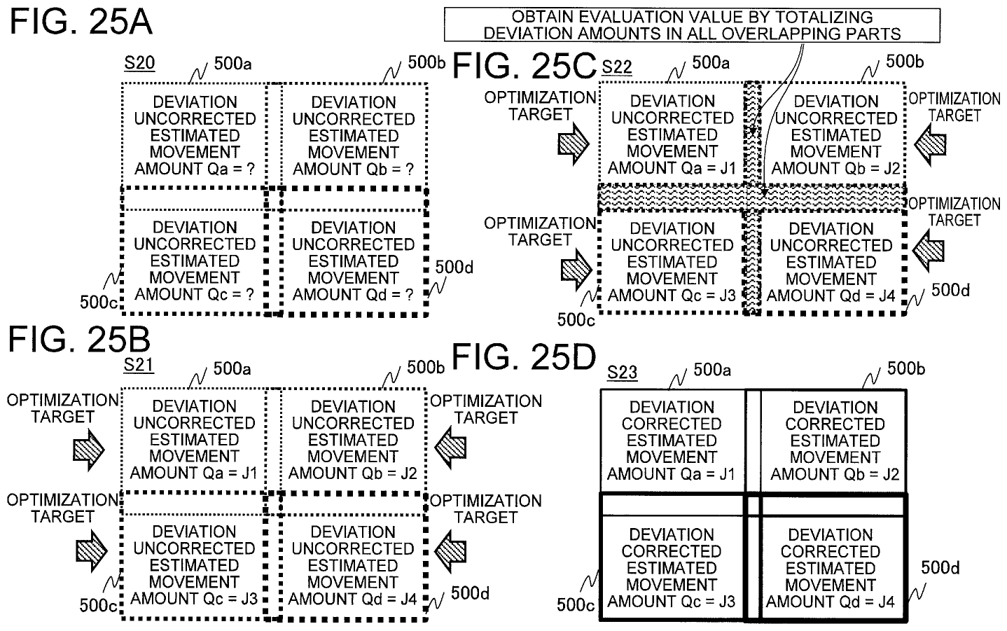

FIGS. 25A to 25D are explanatory diagrams showing the order of correcting a plurality of cameras. In the figures, the reference characters 500a to 500d respectively represent the captured images captured by the cameras 1a to 1d. As shown as step S20 in FIG. 25A, all the cameras 1a to 1d have been designated by the correction timing determination unit 107 as the targets of the parameter optimization process.

As shown as step S21 in FIG. 25B, the parameter optimization unit 106 acquires the values J1 to J4 of the estimated movement amounts Qa to Qd of the cameras as the targets of the parameter optimization process from the movement amount estimation unit 104 and updates the external parameter of each camera 1a-1d based on the acquired values J1 to J4 (steps S210 to S212 in FIG. 23).

Subsequently, as shown as step S22 in FIG. 25C, the parameter optimization unit 106 executes the optimization of the external parameters of the plurality of cameras at the same time (step S213 in FIG. 23).

Subsequently, as shown as step S23 in FIG. 25D, the parameter optimization unit 106 acquires the deviation amount evaluation values in the plurality of captured images from the deviation amount evaluation unit 110, calculates the sum total of the deviation amount evaluation values as an evaluation value, and obtains the external parameters of the plurality of cameras minimizing or maximizing the evaluation value. By executing the above process, the correction of the cameras to which deviation has occurred is made at the same time.

As described above, with the image processing device, the image processing method or the image processing program according to the second embodiment, the deviation amount evaluation values in the synthetic image are fed back to the parameter optimization process (i.e., the deviation correction process), and thus the deviation that has occurred to the overlap regions of the plurality of captured images after the transformation constituting the synthetic image due to the position posture change of the cameras 1a to 1d can be corrected with high accuracy.

Further, with the image processing device, the image processing method or the image processing program according to the second embodiment, the number of calculations can be reduced since the parameter optimization process is executed based on the sum total of a plurality of deviation amount evaluation values.

### (3) Third Embodiment

### (3-1) Image Processing Device 610

An image processing device 610 according to a third embodiment executes the deviation correction process by using superimposition regions of a plurality of captured images (a plurality of camera images) and reference data. The reference data includes a reference image and a camera parameter at the time when the reference image was captured by a camera as an image capturing device. The reference image is a captured image, i.e., a camera image, captured by a camera in a calibrated state. The reference image is referred to also as a “corrected camera image”. The reference image is, for example, a camera image captured by a camera calibrated by using a calibration board when the camera was installed.

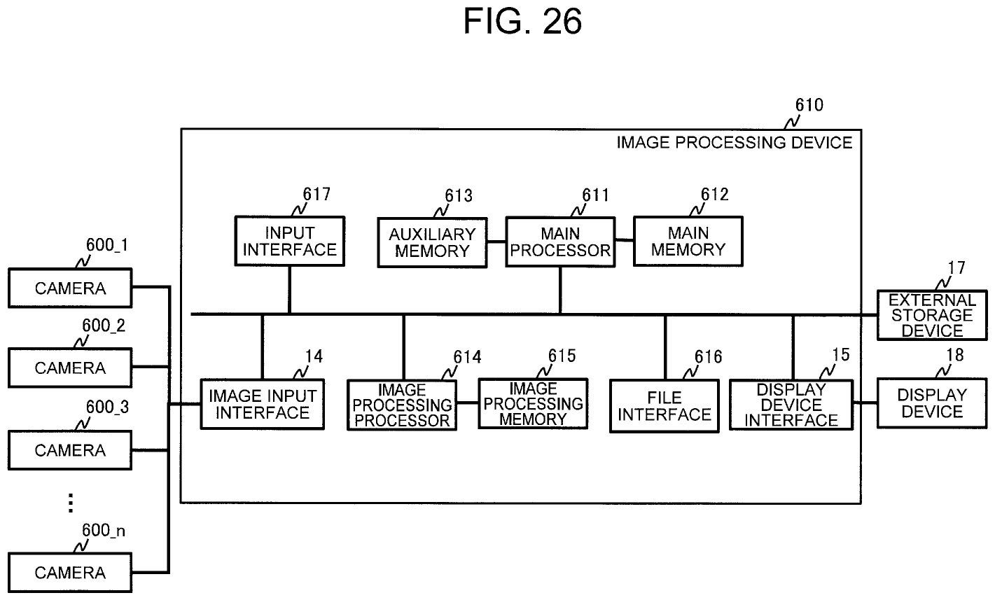

FIG. 26 is a diagram showing an example of the hardware configuration of the image processing device 610 according to the third embodiment. The image processing device 610 is a device capable of executing an image processing method according to the third embodiment. The image processing device 610 may be implemented by processing circuitry. As shown in FIG. 26, the processing circuitry includes a main processor 611, a main memory 612 and an auxiliary memory 613, for example. Further, the image processing device 610 includes a file interface 616, an input interface 617, the display device interface 15 and the image input interface 14. The image processing device 610 may include an image processing processor 614 and an image processing memory 615. Incidentally, the image processing device 610 shown in FIG. 26 is also an example of the hardware configurations of image processing devices 710, 810 and 910 according to fourth, fifth and sixth embodiments which will be described later. Further, the hardware configurations of the image processing devices 610, 710, 810 and 910 according to the third, fourth, fifth and sixth embodiments are not limited to the configuration shown in FIG. 26. For example, the hardware configurations of the image processing devices 610, 710, 810 and 910 according to the third, fourth, fifth and sixth embodiments can be the configuration shown in FIG. 1.

The auxiliary memory 613 stores, for example, a plurality of camera images captured by cameras 600_1 to 600_n. The reference character n represents a positive integer. The cameras 600_1 to 600_n are the same as the cameras 1a to 1d described in the first embodiment. Further, the auxiliary memory 613 stores information on the relationship among the installation positions of the cameras 600_1 to 600_n and the blending process at the time of the image synthesis, camera parameters calculated by previous camera calibration, and a lens distortion correction map. Furthermore, the auxiliary memory 613 may store a plurality of mask images to be used for a mask process performed on each of the plurality of camera images. The mask process and the mask images will be described in the fifth embodiment later.

The main processor 611 performs a process of loading information stored in the auxiliary memory 613 into the main memory 612. The main processor 611 stores a still image file in the auxiliary memory 613 when a process using a still image is executed. Further, the main processor 611 performs various calculation processes and various control processes by executing programs stored in the main memory 612. The programs stored in the main memory 612 may include an image processing program according to the third embodiment. The programs are stored in the main memory 612 from a record medium (i.e., a non-transitory computer-readable storage medium) storing information via a medium reading device (not shown), or via a communication interface (not shown) connectable to the Internet or the like.

The input interface 617 receives input information provided by a device input such as a mouse input, a keyboard input or a touch panel input. The main memory 612 stores input information inputted through the input interface 617.

The image processing memory 615 stores input images transferred from the main memory 612 and the synthetic image (i.e., synthetic image data) and projection images (i.e., projection image data) generated by the image processing processor 614.

The display device interface 15 outputs the synthetic image generated by the image processing device 610. The display device interface 15 is connected to the display device 18 by an HDMI (High-Definition Multimedia Interface) cable or the like. The display device 18 displays a picture based on the synthetic image provided from the display device interface 15.

The image input interface 14 receives image signals provided from the cameras 600_1 to 600_n connected to the image processing device 610. The cameras 600_1 to 600_n are network cameras, analog cameras, USB (Universal Serial Bus) cameras, HD-SDI (High Definition-Serial Digital Interface) cameras or the like, for example. The method of the connection between the image processing device 610 and the cameras 600_1 to 600_n is determined depending on the type of the cameras 600_1 to 600_n. Image information inputted through the image input interface 14 is stored in the main memory 612, for example.

The external storage device 17 and the display device 18 are the same as those described in the first embodiment. The external storage device 17 is a storage device connected to the image processing device 610. The external storage device 17 is a hard disk drive (HDD), an SSD or the like. The external storage device 17 is provided so as to supplement the capacity of the auxiliary memory 613, for example, and operates equivalently to the auxiliary memory 613. However, the image processing device without the external storage device 17 is also possible.

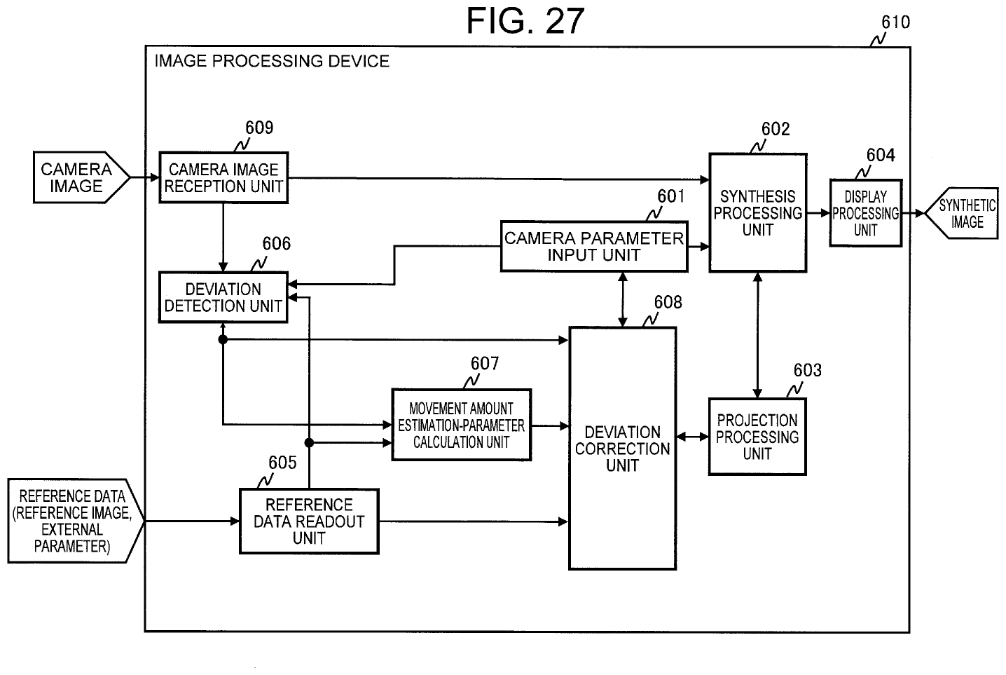

FIG. 27 is a functional block diagram schematically showing the configuration of the image processing device 610 according to the third embodiment. As shown in FIG. 27, the image processing device 610 according to the third embodiment includes a camera image reception unit 609, a camera parameter input unit 601, a synthesis processing unit 602, a projection processing unit 603, a display processing unit 604, a reference data readout unit 605, a deviation detection unit 606, a movement amount estimation-parameter calculation unit 607 and a deviation correction unit 608. The image processing device 610 executes a process of generating a synthetic image by combining a plurality of camera images captured by a plurality of cameras.

In the image processing device 610, the projection processing unit 603 generates synthesis tables, as mapping tables used at the time of combining projection images, based on a plurality of external parameters provided from the camera parameter input unit 601 and generates a plurality of projection images corresponding to the plurality of camera images by projecting the plurality of camera images onto the same projection surface by using the synthesis tables. The synthesis processing unit 602 generates the synthetic image from the plurality of projection images. The reference data readout unit 605 outputs reference data including a plurality of reference images as camera images used as the reference corresponding to the plurality of cameras and a plurality of external parameters corresponding to the plurality of reference images. The movement amount estimation-parameter calculation unit 607 calculates a plurality of external parameters after the correction corresponding to the plurality of cameras by estimating the movement amounts of the plurality of cameras based on the plurality of camera images and the reference data. The deviation detection unit 606 judges whether or not deviation has occurred to any one of the plurality of cameras. When the deviation detection unit 606 judges that deviation has occurred, the deviation correction unit 608 updates the plurality of external parameters provided by the camera parameter input unit 601 by using the plurality of external parameters after the correction calculated by the movement amount estimation-parameter calculation unit 607.

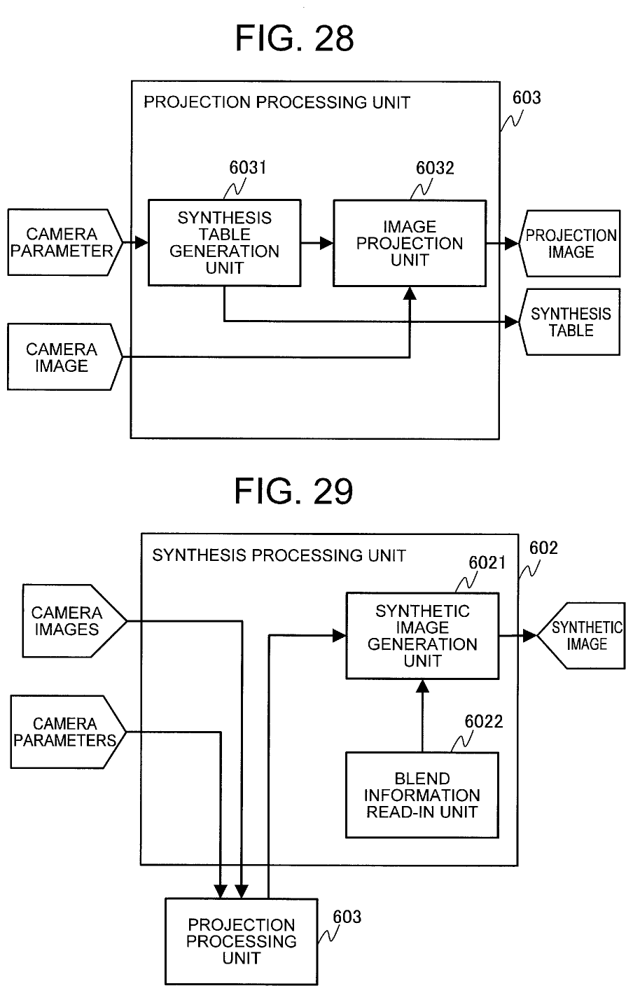

FIG. 28 is a functional block diagram schematically showing the configuration of the projection processing unit 603 shown in FIG. 27. As shown in FIG. 28, the projection processing unit 603 includes a synthesis table generation unit 6031 and an image projection unit 6032.

FIG. 29 is a functional block diagram schematically showing the configuration of the synthesis processing unit 602 shown in FIG. 27. As shown in FIG. 29, the synthesis processing unit 602 includes a synthetic image generation unit 6021 and a blend information read-in unit 6022.

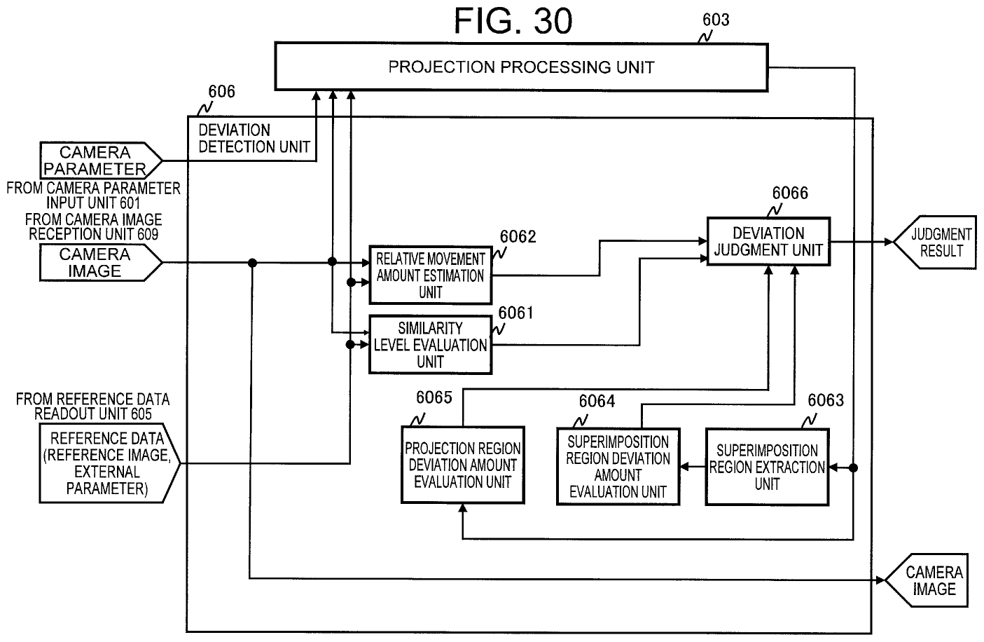

FIG. 30 is a functional block diagram schematically showing the configuration of the deviation detection unit 606 shown in FIG. 27. As shown in FIG. 30, the deviation detection unit 606 includes a similarity level evaluation unit 6061, a relative movement amount estimation unit 6062, a superimposition region extraction unit 6063, a superimposition region deviation amount evaluation unit 6064, a projection region deviation amount evaluation unit 6065 and a deviation judgment unit 6066.

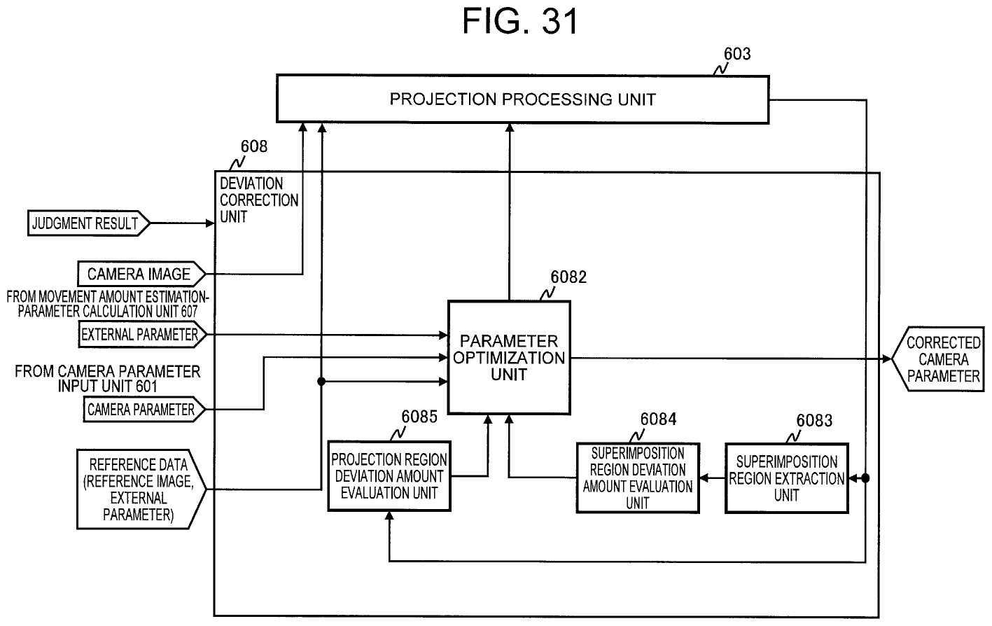

FIG. 31 is a functional block diagram schematically showing the configuration of the deviation correction unit 608 shown in FIG. 27. As shown in FIG. 31, the deviation correction unit 608 includes a parameter optimization unit 6082, a superimposition region extraction unit 6083, a superimposition region deviation amount evaluation unit 6084 and a projection region deviation amount evaluation unit 6085.

### (3-2) Camera Image Reception Unit 609

The camera image reception unit 609 shown in FIG. 27 executes an input process for the camera images provided from the cameras 600_1 to 600_n. The input process is a decoding process, for example. To give an explanation with reference to FIG. 26, the main processor 611 performs the decoding process on the camera images received from the cameras 600_1 to 600_n via the image input interface 14 and stores the decoded camera images in the main memory 612. The decoding process may also be executed by a component other than the camera image reception unit 609. For example, the decoding process may be executed by the image processing processor 614.

### (3-3) Camera Parameter Input Unit 601

The camera parameter input unit 601 shown in FIG. 27 acquires and stores camera parameters calculated by calibration previously performed on the cameras 600_1 to 600_n. The camera parameter includes, for example, an internal parameter, an external parameter, a lens distortion correction map (i.e., distortion parameter), and so forth. Referring to FIG. 26, the main processor 611 loads the camera parameters stored in the auxiliary memory 613 into the main memory 612 via the file interface 616.

Further, the camera parameter input unit 601 executes a process of updating the external parameters in the camera parameters stored in the storage device to external parameters corrected by the deviation correction unit 608 (referred to also as “external parameters after the correction”). The camera parameters including the external parameters after the correction are referred to also as “camera parameters after the correction”. Referring to FIG. 26, the main processor 611 executes a process of writing the external parameters after the correction stored in the main memory 612 to the auxiliary memory 613 via the file interface 616 (e.g., overwriting process).

### (3-4) Synthesis Processing Unit 602

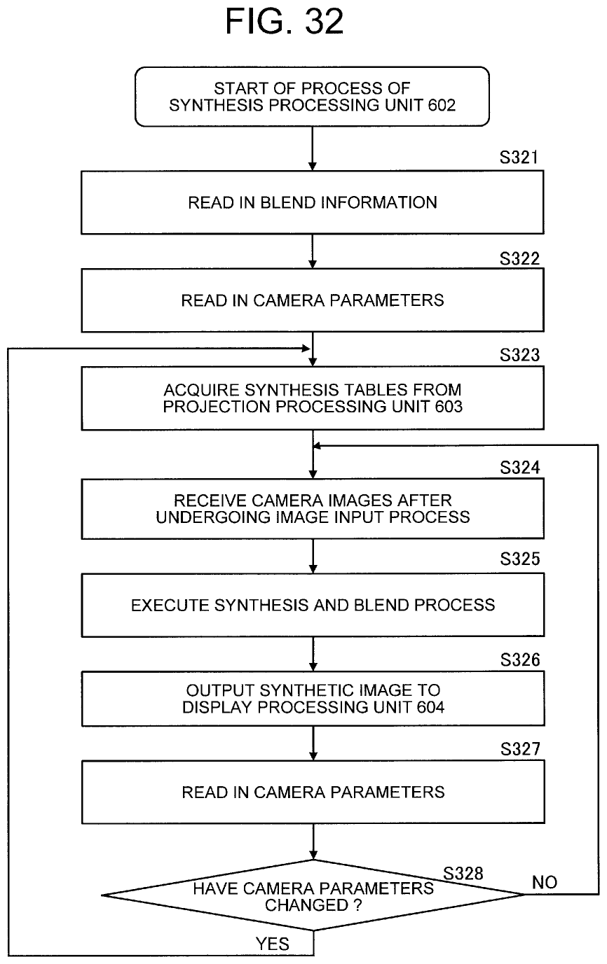

FIG. 32 is a flowchart showing a process executed by the synthesis processing unit 602 shown in FIG. 27 and FIG. 29. The synthesis processing unit 602 generates one synthetic image by combining a plurality of camera images received by the camera image reception unit 609 and undergone the input process. The process shown in FIG. 32 may also be executed by the synthesis processing unit 602 and the projection processing unit 603 in cooperation.

First, the synthesis processing unit 602 reads in blend information and the camera parameters to be used for the blending process from the camera parameter input unit 601 (steps S321 and S322).

Subsequently, the synthesis processing unit 602 acquires synthesis tables generated by the projection processing unit 603 by using the acquired camera parameters (step S323).

Subsequently, the synthesis processing unit 602 receives a plurality of camera images after undergoing the input process (step S324) and generates the synthetic image as one image by combining projection images made up of a plurality of camera images by making the projection processing unit 603 generate images projected on the same projection surface (i.e., projection images) by using the synthesis tables (step S325). Namely, the synthesis processing unit 602 provides the projection processing unit 603 with the camera parameters acquired from the camera parameter input unit 601 and the camera images read in by the camera image reception unit 609, receives the projection images regarding the cameras provided from the projection processing unit 603, and thereafter combines the received projection images regarding the cameras in the synthetic image generation unit 6021 (FIG. 29).

Further, in the step S325, the synthetic image generation unit 6021 of the synthesis processing unit 602 may perform the blending process on joint parts between projection images by using the blend information inputted from the blend information read-in unit 6022. Referring to FIG. 26, the main processor 611 may load the blend information stored in the auxiliary memory 613 into the main memory 612 via the file interface 616.

Subsequently, the synthesis processing unit 602 outputs the synthetic image to the display processing unit 604 (step S346).

The synthesis processing unit 602 reads in the camera parameters from the camera parameter input unit 601 (step S327) and judges whether or not the camera parameters have changed. When the camera parameters have changed, the process advances to the step S323 and the synthesis processing unit 602 makes the projection processing unit 603 generate the synthesis tables to be used for the synthesis process by using the latest camera parameters acquired in the step S327 and further executes the processing of the steps S324 to S328. When the camera parameters have not changed, the process advances to the step S324 and the synthesis processing unit 602 newly receives a plurality of camera images (step S324) and further executes the processing of the steps S325 to S328.

### (3-5) Projection Processing Unit 603

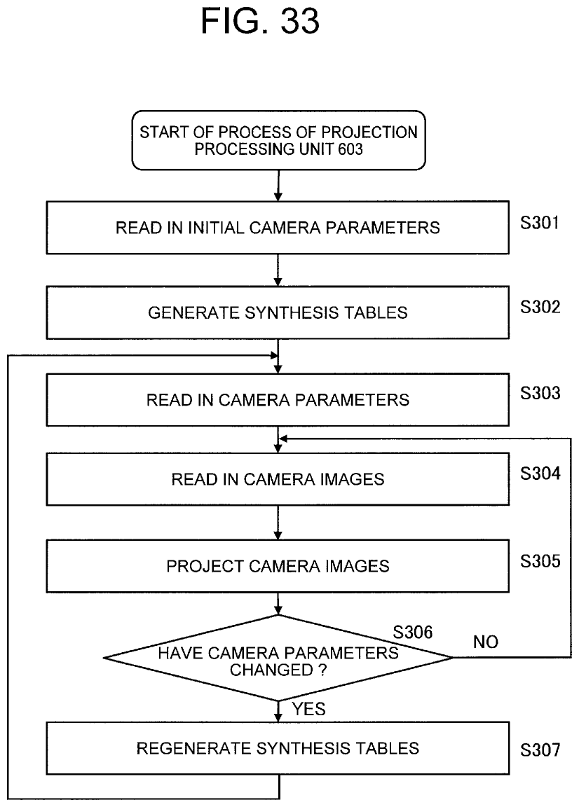

FIG. 33 is a flowchart showing a process executed by the projection processing unit 603 shown in FIG. 27 and FIG. 28. As shown in FIG. 33, the projection processing unit 603 reads in the camera parameters from the synthesis processing unit 602 (step S301). Subsequently, the projection processing unit 603 generates the synthesis tables to be used for the synthesis process by using the acquired camera parameters and transforms the inputted camera images to the projection images by using the generated synthesis tables (step S302).

Subsequently, the projection processing unit 603 reads in the camera parameters (step S303), reads in the camera images (step S304), and generates the projection images from the inputted camera images by using the generated synthesis tables (step S305). Namely, the synthesis table generation unit 6031 (FIG. 28) of the projection processing unit 603 generates the synthesis tables by using the inputted camera parameters, and the image projection unit 6032 (FIG. 28) of the projection processing unit 603 generates the projection images from the synthesis tables and the plurality of camera images.

Subsequently, the projection processing unit 603 judges whether or not the inputted camera parameters have changed (step S306). When the camera parameters have changed, the process advances to step S307 and the projection processing unit 603 regenerates the synthesis tables by using the latest camera parameters acquired in the step S303 and thereafter executes the processing of the steps S303 to S306. When the camera parameters have not changed, the projection processing unit 603 newly receives a plurality of camera images (step S304) and thereafter executes the processing of the steps S305 to S306.

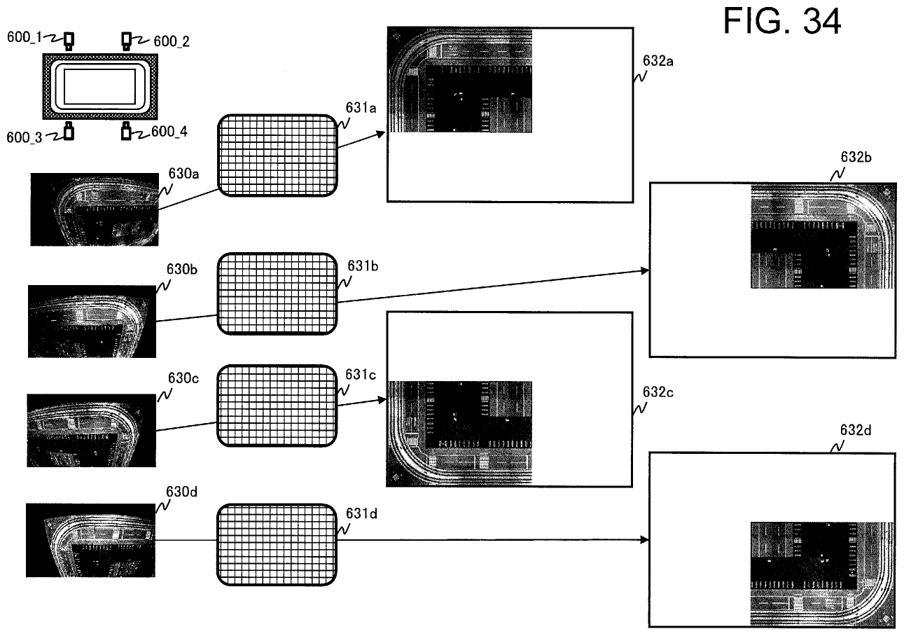

FIG. 34 is an explanatory diagram showing an example of a process executed by the projection processing unit 603 shown in FIG. 27 and FIG. 28. In FIG. 34, the reference characters 630a to 630d represent camera images based on the camera images from the cameras 600_1 to 600_4 after undergoing the input process by the camera image reception unit 609. The reference characters 631a to 631d represent the synthesis tables generated by the projection processing unit 603 by using the camera parameters of the cameras 600_1 to 600_4 inputted to the projection processing unit 603. The projection processing unit 603 generates projection images 632a to 632d of the camera images from the cameras 600_1 to 600_4 based on the synthesis tables 631a to 631d and the camera images 630a to 630d.

Further, the projection processing unit 603 may output the synthesis tables generated by the synthesis table generation unit 6031. When the inputted camera parameters have not changed, the projection processing unit 603 does not need to regenerate the synthesis tables. Therefore, when the inputted camera parameters have not changed, the synthesis table generation unit 6031 executes a process of leaving the synthesis tables as they are without regenerating the synthesis tables.

### (3-6) Display Processing Unit 604

The display processing unit 604 executes a process of converting the synthetic image generated by the synthesis processing unit 602 to picture data that can be displayed by the display device and provides the picture data to the display device. The display device is the display device 18 shown in FIG. 26, for example. The display processing unit 604 displays a picture based on the synthetic image on a display device having one display. The display processing unit 604 may also display a picture based on the synthetic image on a display device having a plurality of displays arranged in horizontal and vertical directions. Further, the display processing unit 604 may also cut out a particular region of the synthetic image (i.e., a part of the synthetic image) and display the region on the display device. Furthermore, the display processing unit 604 may display annotation in superimposition on the picture based on the synthetic image. The annotation means a comment, which can include, for example, a display of something like a frame indicating the result of detecting a person (e.g., a frame surrounding the detected person) and an emphasis display such as a part where the color is changed or the luminance is increased (e.g., a display in which the color of a region surrounding a detected person is changed to a conspicuous color or a brighter color).

### (3-7) Reference Data Readout Unit 605

The reference data readout unit 605 outputs the reference data in the image processing device 610. The reference data is, for example, data including the external parameters as the camera parameters of the cameras in the calibrated state and the reference images as the camera images at that time. The calibrated state is, for example, the state of the cameras 600_1 to 600_n when the calibration by using the calibration board is over at the time of installation of the image processing device 610 and the plurality of cameras 600_1 to 600_n. Referring to FIG. 26, the main processor 611 loads the reference data stored in the auxiliary memory 613 into the main memory 612 via the file interface 616.

### (3-8) Deviation Detection Unit 606

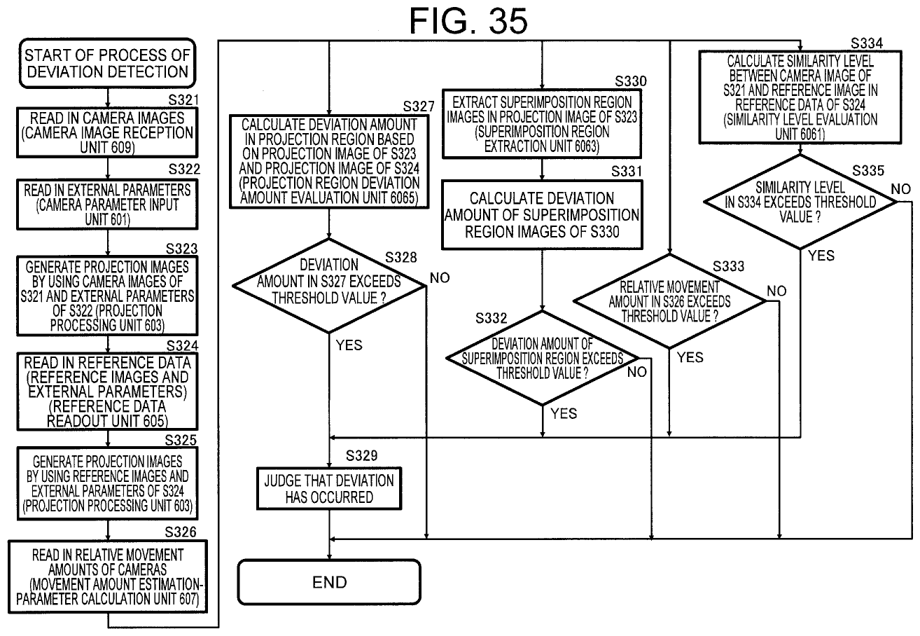

FIG. 35 is a flowchart showing a process executed by the deviation detection unit 606 shown in FIG. 27 and FIG. 28. The deviation detection unit 606 judges whether or not deviation has occurred to each camera 600_1-600_n. Namely, the deviation detection unit 606 judges the presence/absence of deviation and the deviation amount based on the following four processes (R1) to (R4): However, the deviation detection unit 606 can also be configured to judge the presence/absence of deviation and the deviation amount based on a combination of one or more processes among the following four processes (R1) to (R4):

Before the processes (R1) to (R4) by the deviation detection unit 606, processing shown as steps S321 to S326 in FIG. 35 is executed. The read-in of the camera images is performed by the camera image reception unit 609 in step S321, the external parameters are read in by the camera parameter input unit 601 in step S322, and the projection images are generated by the projection processing unit 603 by using the camera images and the external parameters in step S323. Further, the reference data is read out by the reference data readout unit 605 in step S324, and the reference data is read out by the projection processing unit 603 in step S325. Furthermore, relative movement amounts of the cameras are read in by the movement amount estimation-parameter calculation unit 607 in step S326.

(R1) The deviation detection unit 606 compares the reference images as the camera images in the reference data with present camera images acquired from the camera image reception unit 609 and judges positional deviation (displacement) of each camera 600_1-600_n based on the similarity level between the reference image and the present camera image. This process is shown in steps S334 and S335 in FIG. 35. When the similarity level exceeds a threshold value, the deviation detection unit 606 judges that deviation has occurred. Here, the “similarity level” is luminance difference, for example, in which case an increase in that similarity level means a decrease in the degree of similarity.

(R2) The deviation detection unit 606 judges the positional deviation of each camera based on a deviation amount in a projection region. Namely, the deviation detection unit 606 evaluates the deviation amount based on a deviation amount calculated by the projection region deviation amount evaluation unit 6065 which will be described later. This process is shown in steps S327 and S328 in FIG. 35. When the deviation amount exceeds a threshold value, the deviation detection unit 606 judges that deviation has occurred.

(R3) The deviation detection unit 606 judges the positional deviation based on a deviation amount in a superimposition region in the synthetic image. Namely, the deviation detection unit 606 evaluates the deviation amount based on a deviation amount calculated by the superimposition region deviation amount evaluation unit 6064 which will be described later. This process is shown in steps S330 to S332 in FIG. 35. When the deviation amount exceeds a threshold value, the deviation detection unit 606 judges that deviation has occurred.

(R4) The deviation detection unit 606 compares the reference image with the present camera image acquired from the camera image reception unit 609 and judges the presence/absence of deviation based on the relative movement amount between these two images. This process is shown in step S333 in FIG. 35. When the relative movement amount exceeds a threshold value, the deviation detection unit 606 judges that deviation has occurred.

FIG. 35 shows an example in which the deviation detection unit 606 judges that deviation has occurred if the condition is satisfied (i.e., the judgment is YES) in the step S328, S332, S333 or S335 in one of the processes (R1) to (R4). However, the deviation detection unit 606 may also be configured to judge that deviation has occurred if two or more of the conditions of the steps S328, S332, S333 and S335 in the processes (R1) to (R4) are satisfied.

### (Similarity Level Evaluation Unit 6061)

The similarity level evaluation unit 6061 shown in FIG. 30 compares the similarity level between the reference image and the present camera image acquired from the camera image reception unit 609 with a threshold value. The similarity level is, for example, a value based on the luminance difference or structural similarity, or the like. When the similarity level is the luminance difference, an increase in that similarity level means a decrease in the degree of similarity.

### (Relative Movement Amount Estimation Unit 6062)

The relative movement amount estimation unit 6062 shown in FIG. 30 calculates the external parameter of each camera in the camera image provided from the camera image reception unit 609 based on the camera image provided from the camera image reception unit 609 and the reference data of each camera in the calibrated state acquired from the reference data readout unit 605.

The relative movement amount estimation unit 6062 shown in FIG. 30 can use a publicly known method such as the five-point algorithm as the method of calculating the relative movement amount between two images. In the five-point algorithm, the relative movement amount estimation unit 6062 detects feature points in the two images, performs the matching between the feature points in the two images, and applies the result of the matching to the five-point algorithm. Therefore, the relative movement amount estimation unit 6062 estimates the relative movement amount of the present camera image with respect to the reference image by using the reference image in the reference data and the camera image provided from the camera image reception unit 609 for the five-point algorithm.

### (Superimposition Region Extraction Unit 6063)

The superimposition region extraction unit 6063 shown in FIG. 30 extracts superimposition region images, as image parts in the synthetic image in regions where adjoining camera images are superimposed on each other, based on the synthesis tables and the projection images provided from the projection processing unit 603, and outputs the superimposition region images to the superimposition region deviation amount evaluation unit 6064. Specifically, the superimposition region extraction unit 6063 outputs each pair of superimposition region images in adjoining camera images (i.e., two pieces of image data associated with each other).

FIG. 36 is an explanatory diagram showing a process executed by the superimposition region extraction unit 6063 shown in FIG. 30. In FIG. 36, the projection images 633a and 633b represent projection images of camera images outputted by the projection processing unit 603. In FIG. 36, the image 634 shows the positional relationship of the images 633a and 633b when they are combined together. In this case, a superimposition region 635 as a region where the projection images 633a and 633b are superimposed on each other exists in the image 634. The superimposition region extraction unit 6063 obtains the superimposition region 635 based on the synthesis tables and the projection images provided from the projection processing unit 603. After obtaining the superimposition region 635, the superimposition region extraction unit 6063 outputs the superimposition region image in regard to each projection image. A superimposition region image 636a is an image in the superimposition region 635 in the projection image 633a of the camera image from the camera 600_1. A superimposition region image 636b indicates an image in the superimposition region 635 in the projection image 633b of the camera image from the camera 600_2. The superimposition region extraction unit 6063 outputs these two superimposition region images 636a and 636b as a pair of superimposition region images. While only one pair of superimposition region images regarding the cameras 600_1 and 600_2 is shown in FIG. 36, the superimposition region extraction unit 6063 outputs pairs of superimposition region images in the projection images regarding all the cameras. In the case of the camera arrangement shown in FIG. 34, the number of pairs of superimposition region images is 6 at the maximum.

### (Superimposition Region Deviation Amount Evaluation Unit 6064)

The superimposition region deviation amount evaluation unit 6064 shown in FIG. 30 calculates the deviation amount based on each pair of superimposition region images of adjoining camera images provided from the superimposition region extraction unit 6063. The deviation amount is calculated based on the similarity level (e.g., the structural similarity) between images, the difference between feature points, or the like. For example, the superimposition region images 636a and 636b in the projection images regarding the cameras 600_1 and 600_2 are inputted to the superimposition region deviation amount evaluation unit 6064 as a pair, and the superimposition region deviation amount evaluation unit 6064 obtains the similarity level between the images. In this case, the superimposition region deviation amount evaluation unit 6064 uses the camera parameters provided from the parameter optimization unit 6082 as the camera parameters for generating the projection images. Incidentally, when the comparison process is performed, the images compared with each other may be limited to a range where pixels of both images exist.

### (Projection Region Deviation Amount Evaluation Unit 6065)

The projection region deviation amount evaluation unit 6065 shown in FIG. 30 compares the projection image of each camera image acquired from the camera image reception unit 609 corresponding to the camera parameter provided from the parameter optimization unit 6082 (the projection image is obtained by the projection processing unit 603) with a projection image based on the reference data of each camera acquired from the reference data readout unit 605 and thereby calculates a deviation amount with respect to the reference data. Namely, the projection region deviation amount evaluation unit 6065 inputs the reference image as the camera image in the reference data and the corresponding camera parameter to the projection processing unit 603, thereby obtains the projection image, and compares the two projection images. The projection region deviation amount evaluation unit 6065 calculates the deviation amount based on the similarity level (e.g., the structural similarity) between images, the difference between feature points, or the like.

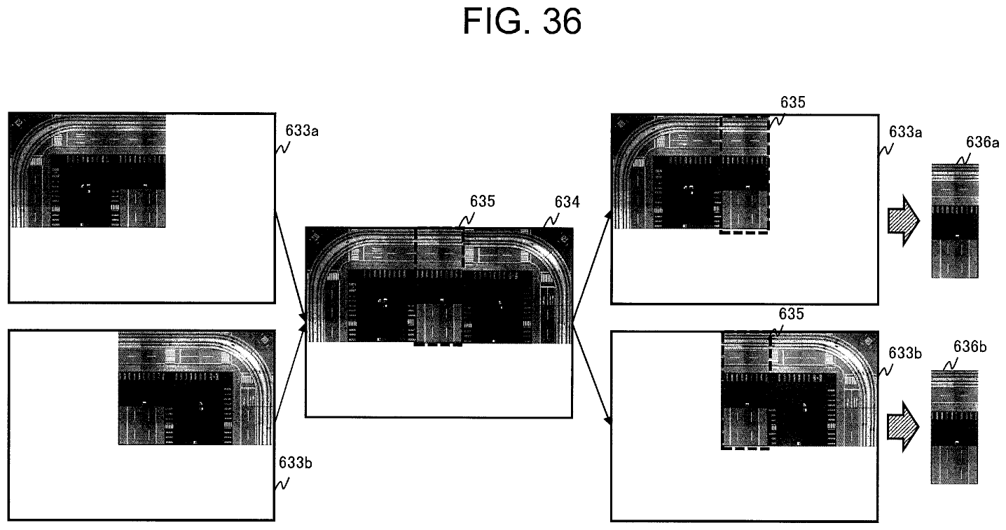

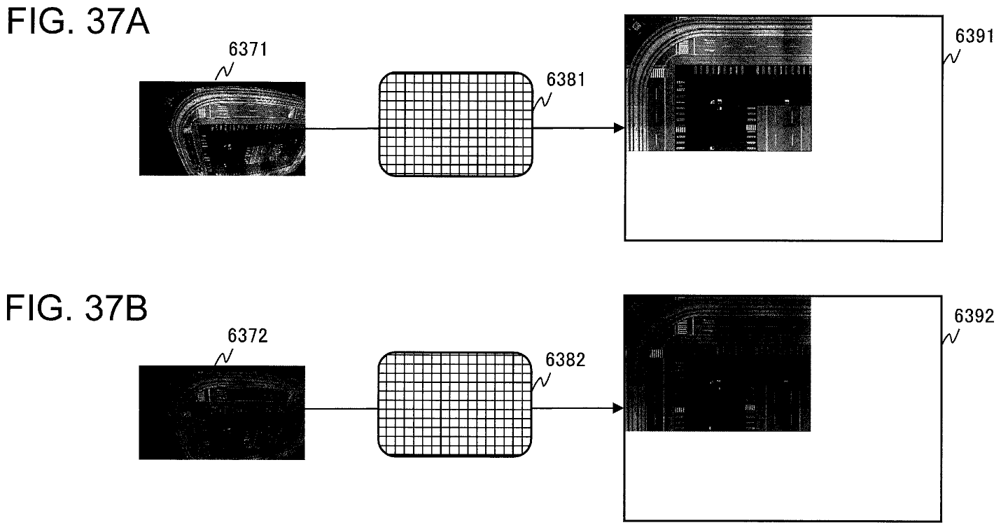

FIGS. 37A and 378 are explanatory diagrams showing an example of a process executed by the projection region deviation amount evaluation unit 6065 shown in FIG. 30. The image 6371 is an input image from the camera 600_1 acquired from the camera image reception unit 609. The image 6372 is an image in the reference data of the camera 600_1 stored in the reference data readout unit 605. The reference character 6381 represents a synthesis table obtained when the camera parameter provided from the parameter optimization unit 6082 is inputted to the projection processing unit 603, and the reference character 6382 represents a synthesis table obtained when the camera parameter in the reference data of the camera 600_1 stored in the reference data readout unit 605 is inputted to the projection processing unit 603. The projection image 6391 is the image obtained when the image 6371 is projected by using the synthesis table 6381. The projection image 6392 is the image obtained when the image 6372 is projected by using the synthesis table 6382. Incidentally, when the comparison process is performed, the images compared with each other may be limited to a range where pixels of both images exist. The projection region deviation amount evaluation unit 6065 calculates the deviation amount with respect to the reference data by comparing the projection images 6391 and 6392. For example, the projection region deviation amount evaluation unit 6065 obtains the similarity level between the images.

### (Deviation Judgment Unit 6066)

The deviation judgment unit 6066 shown in FIG. 30 detects a camera to which deviation has occurred based on the aforementioned four processes (R1) to (R4) and outputs a judgment result. The judgment result includes, for example, information indicating whether deviation has occurred or not, information identifying the camera to which deviation has occurred (e.g., camera number), and so forth. The deviation judgment unit 6066 generates the judgment result based on evaluation values provided from the similarity level evaluation unit 6061, the relative movement amount estimation unit 6062, the superimposition region extraction unit 6063 and the superimposition region deviation amount evaluation unit 6064. The deviation judgment unit 6066 sets a threshold value for each evaluation value and judges that deviation has occurred if the threshold value is exceeded. The deviation judgment unit 6066 may also assign a weight to each evaluation value, obtain the sum total of the weighted evaluation values as a new evaluation value, and make the judgment by setting a threshold value for the new evaluation value.

### (3-9) Movement Amount Estimation-Parameter Calculation Unit 607

FIG. 38 is a flowchart showing a process executed by the movement amount estimation-parameter calculation unit 607 shown in FIG. 27. As shown as steps S341 to S344 in FIG. 38, the movement amount estimation-parameter calculation unit 607 calculates the external parameter of each camera in the camera image provided from the camera image reception unit 609 based on the camera image provided from the deviation detection unit 606 and the reference data of each camera in the calibrated state acquired from the reference data readout unit 605.

The movement amount estimation-parameter calculation unit 607 can use a publicly known method such as the five-point algorithm as the method of calculating the relative camera movement amount between two images. In the five-point algorithm, the movement amount estimation-parameter calculation unit 607 detects feature points in the two images, performs the matching between the feature points in the two images (step S342), and inputs the result of the matching to the five-point algorithm. Therefore, the movement amount estimation-parameter calculation unit 607 is capable of estimating the relative movement amount of each camera with respect to the reference data (relative movement amount at the time point of the input from the camera image reception unit 609) by inputting the camera image provided from the camera image reception unit 609 and the reference image to the aforementioned method (step S343).

The movement amount estimation-parameter calculation unit 607 can also output an external parameter indicating the relative movement amount by adding the external parameter of each camera at the time point of the input from the camera image reception unit 609 to the relative movement amount of each camera estimated above (step S344).

### (3-10) Deviation Correction Unit 608

When the judgment result provided from the deviation detection unit 606 is “deviation has occurred”, the deviation correction unit 608 shown in FIG. 31 calculates a new external parameter to be used when the positional deviation of the pertinent camera is corrected (i.e., the external parameters after the correction). The external parameters after the correction is used when the deviation that has occurred to the synthetic image is corrected.

As the external parameter of each camera to which deviation has occurred, the deviation correction unit 608 uses the external parameter provided from the movement amount estimation-parameter calculation unit 607 or the camera parameter input unit 601. As the external parameter of each camera to which no deviation has occurred, the deviation correction unit 608 uses the external parameter provided from the camera parameter input unit 601.

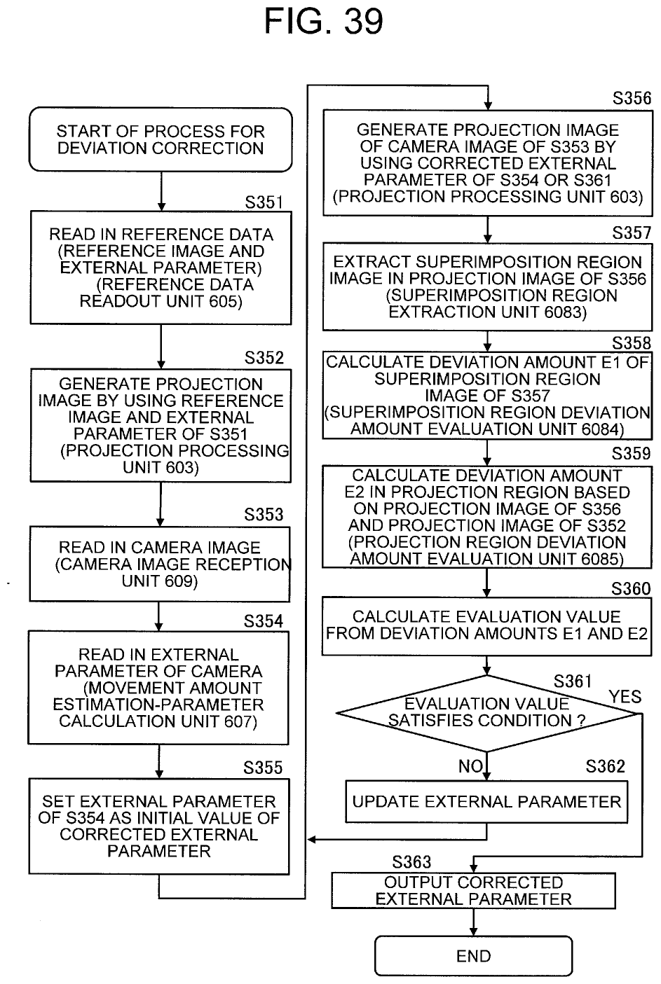

FIG. 39 is a flowchart showing the deviation correction process. The deviation correction unit 608 receives the reference data of each camera in the calibrated state acquired from the reference data readout unit 605, the projection image acquired from the projection processing unit 603, the camera image acquired from the camera image reception unit 609, and the external parameter of each camera acquired from the movement amount estimation-parameter calculation unit 607 as inputs (steps S351 to S354), and outputs the new external parameter to be used when the positional deviation of the camera in which the positional deviation is detected is corrected (i.e., the external parameters after the correction). The deviation correction unit 608 uses the external parameters after the correction when correcting the deviation that has occurred to the synthetic image.

### (Parameter Optimization Unit 6082)

The parameter optimization unit 6082 shown in FIG. 31 calculates the external parameter to be used when the positional deviation of the camera in which the positional deviation is detected (referred to also as a “correction target camera”) acquired from the deviation detection unit 606 is corrected, and outputs the external parameter to the camera parameter input unit 601. Incidentally, when positional deviation is not detected (i.e., when no positional deviation has occurred), the parameter optimization unit 6082 does not change the parameter of the camera and outputs the already set values to the camera parameter input unit 601.

Based on the external parameter currently applied to the correction target camera, the parameter optimization unit 6082 calculates an evaluation value from the deviation amount in the superimposition region of the correction target camera and an adjacent camera acquired from the superimposition region deviation amount evaluation unit 6084 and the deviation amount with respect to the projection image of the reference data (reference data of the correction target camera acquired from the reference data readout unit 605) acquired from the projection region deviation amount evaluation unit 6085, and calculates an external parameter that maximizes or minimizes the evaluation value. The parameter optimization unit 6082 repeats the processing of steps S362 and S356 to S360 in FIG. 39 until the evaluation value satisfies a certain condition (i.e., until the judgment in step S361 in FIG. 39 becomes YES). The number of times of repeating the processing may be limited to a certain number of times or less. Namely, the parameter optimization unit 6082 repeats the processing of updating the external parameter and obtaining the evaluation value at the time of that external parameter until the evaluation value satisfies the certain condition.

The parameter optimization unit 6082 carries out the optimization of the external parameter by newly obtaining an evaluation value based on a deviation amount E1 of superimposition region images as an evaluation value provided from the superimposition region deviation amount evaluation unit 6084 and a deviation amount E2 in a projection region as an evaluation value provided from the projection region deviation amount evaluation unit 6085. The evaluation value obtained in this case is, for example, the sum total of the deviation amount E1 and the deviation amount E2 or a weighted sum of the deviation amount E1 and the deviation amount E2. The weighted sum is calculated as w1χ E1+w2×E2, for example. Here, w1 and w2 are weight parameters of the deviation amount E1 and the deviation amount E2. Incidentally, the weight parameters w1 and w2 are obtained based on the areas of the superimposition region images and the projection images, for example. Further, by changing the weight parameters w1 and w2, it is also possible to execute the deviation correction process by using the evaluation exclusively with the deviation amount E1 as the evaluation value provided from the superimposition region deviation amount evaluation unit 6084 (w2=0) or the evaluation exclusively with the deviation amount E2 as the evaluation value provided from the projection region deviation amount evaluation unit 6085 (w1=0).

In the repetitive processing, the parameter optimization unit 6082 needs to recalculate an evaluation value corresponding to the updated external parameter, for which it is necessary to reacquire the deviation amount E1, as the evaluation value provided from the superimposition region deviation amount evaluation unit 6084, and the deviation amount E2, as the evaluation value provided from the projection region deviation amount evaluation unit 6085, corresponding to the updated external parameter. Thus, when the external parameter has been updated, the parameter optimization unit 6082 outputs the updated external parameter to the projection processing unit 603 and thereby reacquires the projection image regarding each camera corresponding to the external parameter. Here, the projection image is the projection image of each camera image acquired from the camera image reception unit 609. The parameter optimization unit 6082 inputs the reacquired projection image regarding each camera to the superimposition region extraction unit 6083, inputs outputted superimposition region images to the superimposition region deviation amount evaluation unit 6084, and reacquires the deviation amount E1 as an evaluation value. Further, the parameter optimization unit 6082 inputs the reacquired projection image regarding each camera to the projection region deviation amount evaluation unit 6085 and reacquires the deviation amount E2 as an evaluation value.

### (Superimposition Region Extraction Unit 6083)

The superimposition region extraction unit 6083 shown in FIG. 31 extracts the superimposition region images, as images in the superimposition regions of adjoining camera images in the synthetic image, based on the synthesis tables and the projection images provided from the projection processing unit 603, and outputs the superimposition region images to the superimposition region deviation amount evaluation unit 6084. Specifically, the superimposition region extraction unit 6083 outputs superimposition region images in adjoining camera images as a pair. The function of the superimposition region extraction unit 6083 is the same as the function of the superimposition region extraction unit 6063.

### (Superimposition Region Deviation Amount Evaluation Unit 6084)

The superimposition region deviation amount evaluation unit 6084 shown in FIG. 31 calculates the deviation amount based on the pair of superimposition region images of adjoining camera images provided from the superimposition region extraction unit 6083. The superimposition region deviation amount evaluation unit 6084 calculates the deviation amount based on the similarity level (e.g., the structural similarity or the like) between the adjoining camera images, the difference between feature points, or the like. The superimposition region deviation amount evaluation unit 6084 receives the superimposition region images 636a and 636b in the projection images regarding the cameras 600_1 and 600_2 as a pair, for example, and obtains the similarity level between the images. The camera parameters when generating the projection images are those provided from the parameter optimization unit 6082. Incidentally, the comparison process between images is performed only on a range where pixels of both images exist.

### (Projection Region Deviation Amount Evaluation Unit 6085)

The projection region deviation amount evaluation unit 6085 shown in FIG. 31 calculates the deviation amount with respect to the reference data by comparing the projection image of each camera image acquired from the camera image reception unit 609 corresponding to the camera parameter provided from the parameter optimization unit 6082 (the projection image is obtained by the projection processing unit 603) with the projection image based on the reference data of each camera acquired from the reference data readout unit 605. The projection image based on the reference data is acquired from the projection processing unit 603 by inputting the reference image as the camera image in the reference data and the corresponding camera parameter to the projection processing unit 603. The projection region deviation amount evaluation unit 6085 calculates the deviation amount based on the similarity level (e.g., the structural similarity or the like) between images, the difference between feature points, or the like. Incidentally, the comparison process between images is performed only on a range where pixels of both images exist. The projection region deviation amount evaluation unit 6085 calculates the deviation amount with respect to the reference data by comparing the projection images 6391 and 6392. The projection region deviation amount evaluation unit 6085 obtains the similarity level between the images, for example. The processing performed by the projection region deviation amount evaluation unit 6085 is the same as the processing performed by the projection region deviation amount evaluation unit 6065.

### (3-11) Effect

As described above, with the image processing device 610, the image processing method or the image processing program according to the third embodiment, the deviation of camera images in the synthetic image can be corrected while maintaining the positional relationship among the camera images constituting the synthetic image.

Incidentally, it is also possible to employ methods described in the first embodiment as various processing methods in the third embodiment. Further, the deviation detection and deviation correction processes described in the third embodiment can be applied also to other embodiments.

### (4) Fourth Embodiment

### (4-1) Image Processing Device 710

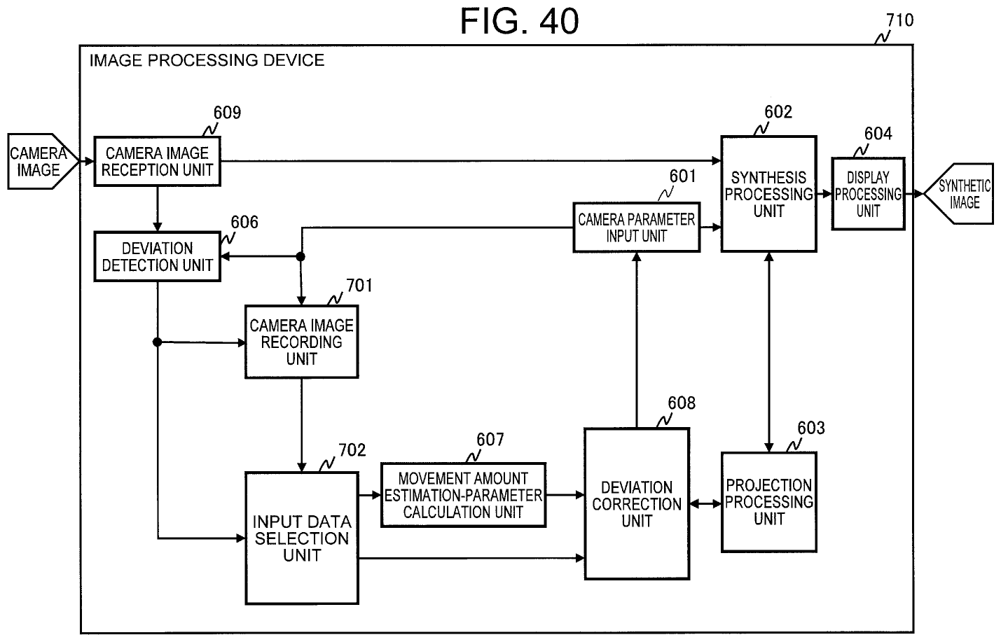

FIG. 40 is a functional block diagram schematically showing the configuration of an image processing device 710 according to a fourth embodiment. In FIG. 40, each component identical or corresponding to a component shown in FIG. 27 is assigned the same reference character as in FIG. 27. The image processing device 710 according to the fourth embodiment differs from the image processing device 610 according to the third embodiment in including a camera image recording unit 701 and an input data selection unit 702. The input data selection unit 702 is a reference data readout unit that selects reference data including a reference image and an external parameter based on the camera image.

As shown in FIG. 40, the image processing device 710 includes the camera image reception unit 609, the camera parameter input unit 601, the synthesis processing unit 602, the projection processing unit 603, the display processing unit 604, the deviation detection unit 606, the movement amount estimation-parameter calculation unit 607, the deviation correction unit 608, the camera image recording unit 701 and the input data selection unit 702. The hardware configuration of the image processing device 710 is the same as that shown in FIG. 26.

The image processing device 710 executes a process of generating a synthetic image by combining a plurality of camera images captured by a plurality of cameras. The camera image recording unit 701 records a plurality of camera images and a plurality of external parameters corresponding to the plurality of camera images in a storage device (e.g., the external storage device 17 in FIG. 26). The storage device does not need to be a part of the image processing device 710. However, the camera image recording unit 701 may include the storage device. The input data selection unit 702 selects an image in a condition close to a camera image received by the camera image reception unit 609 from the plurality of camera images recorded by the camera image recording unit 701 as a reference image, and outputs reference data including the selected reference image and the external parameter corresponding to the reference image. The movement amount estimation-parameter calculation unit 607 estimates the movement amounts of the plurality of cameras based on the plurality of camera images and the reference data and calculates a plurality of external parameters after the correction corresponding to the plurality of cameras.

### (4-2) Camera Image Recording Unit 701

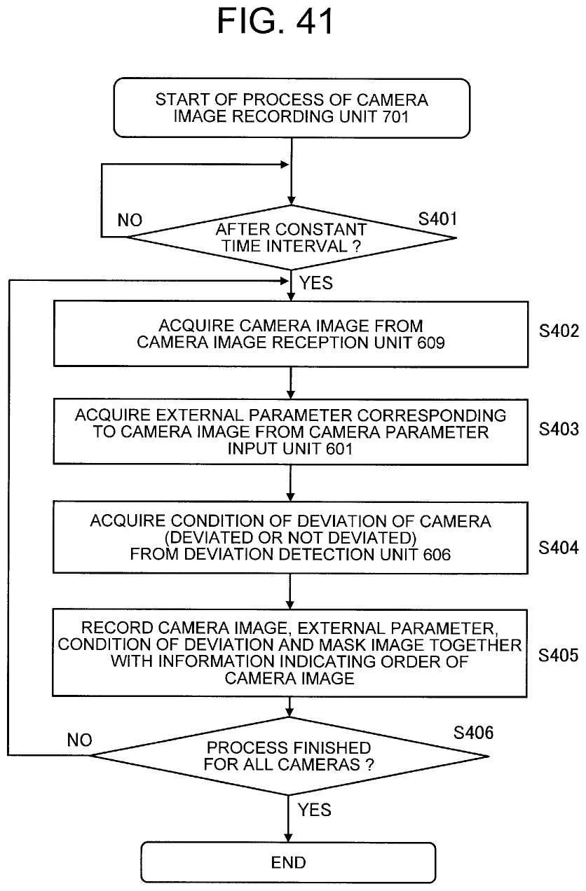

FIG. 41 is a flowchart showing a process executed by the camera image recording unit 701. The camera image recording unit 701 records camera images provided from the camera image reception unit 609 at constant time intervals (step S401). The constant time interval is, for example, a time interval corresponding to some frames, an interval of some seconds, or the like. Incidentally, the constant time interval is a typical example of a predetermined time interval of acquiring camera images, and the time interval can change. Further, when recording a camera image in the storage device, the camera image recording unit 701 also records an ordinal number, a time stamp or the like in addition to the camera image so that the chronological relationship regarding the timing of recording becomes clear (steps S402 and S405). To give an explanation with reference to FIG. 26, the main processor 611 stores the camera image and information indicating the order of the camera image in the main memory 612 and then stores the camera image and the information in the auxiliary memory 613 from the main memory 612 via the file interface 616.

Further, when recording an image, the camera image recording unit 701 also records the already set external parameter of the camera 600_k (k=1, . . . , n) in the camera parameter input unit 601 (steps S403 and S405). Furthermore, the camera image recording unit 701 also records the state of the deviation of the camera 600_k provided from the deviation detection unit 606 (e.g., whether deviation exists or not, the deviation amount, the direction of the deviation, and so forth) at the same time (steps S404 and S405). The camera image recording unit 701 may record a mask image. The mask image will be explained in a fifth embodiment which will be described later. Moreover, the camera image recording unit 701 provides the input data selection unit 702 with the camera image, the external parameter, the information indicating the order of the camera image, and so forth as a set of data. The processing of steps S402 to S406 is executed for all the cameras 600_1 to 600_n.

### (4-3) Input Data Selection Unit 702

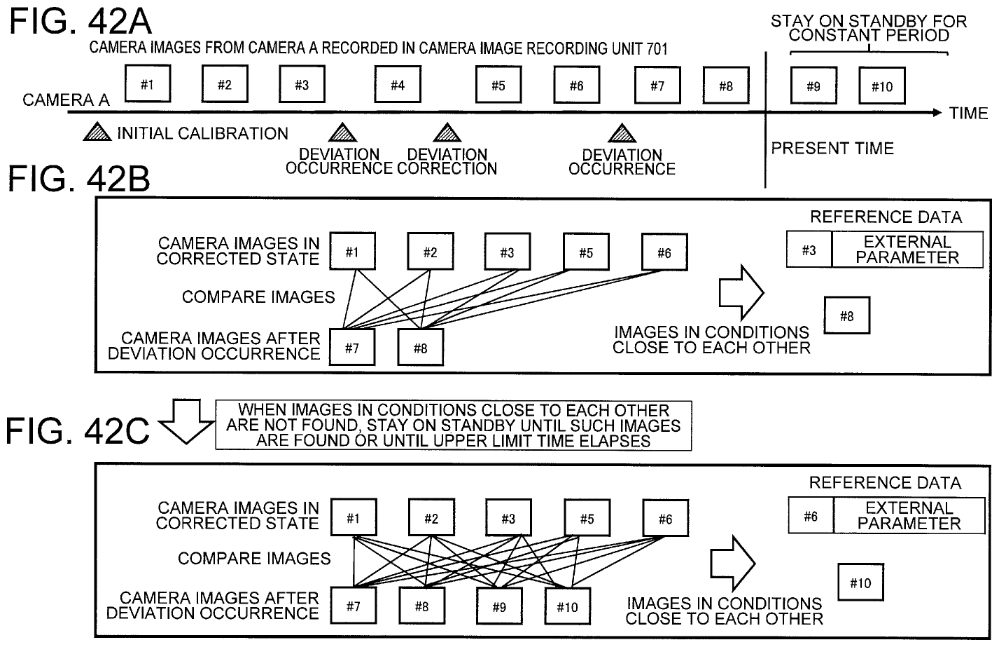

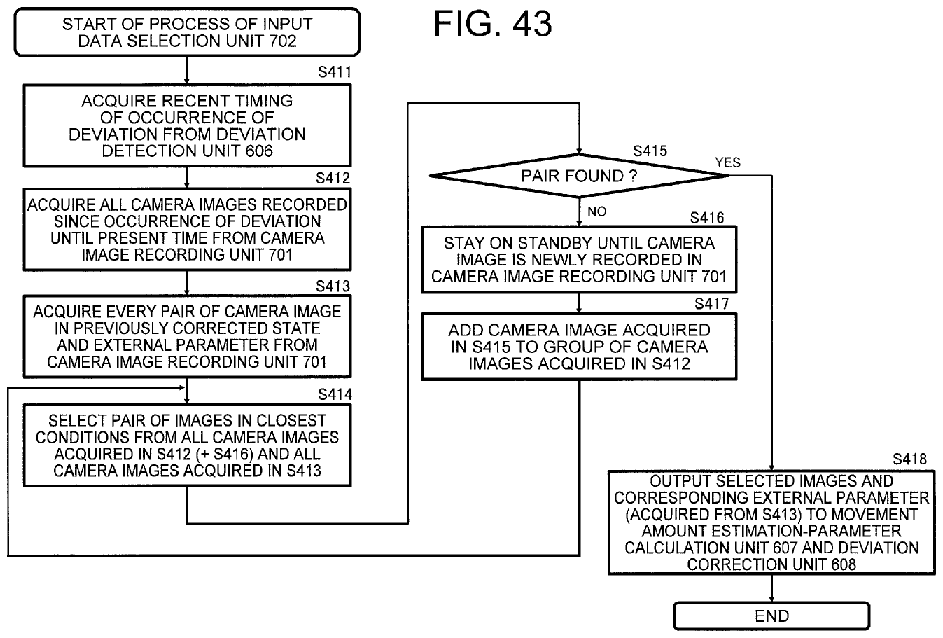

FIGS. 42A to 42C are explanatory diagrams showing a process executed by the input data selection unit 702 shown in FIG. 40. FIG. 43 is a flowchart showing the process executed by the input data selection unit 702 shown in FIG. 40.

In regard to a camera in which deviation has been detected, from all camera images stored in the camera image recording unit 701 since the time point of the detection of the deviation (e.g., #7 and #8 in FIGS. 42A and 42B) and all camera images in the deviation corrected state recorded by the camera image recording unit 701 (e.g., #1 to #6 in FIGS. 42A and 42B), the input data selection unit 702 selects a pair of images in conditions close to each other (e.g., #3 and #8 in FIGS. 42A and 42B) (steps S411 to S415 in FIG. 43). The pair of images in conditions close to each other is, for example, a pair of images whose image capture times are close to each other, a pair of images in which no person exists, a pair of images whose sunshine conditions are close to each other, a pair of images whose luminance values are close to each other, a pair of images close to each other in the similarity level, or the like.

Thereafter, the input data selection unit 702 outputs the camera image selected from all camera images stored in the camera image recording unit 701 since the time point of the detection of the deviation and the image selected from all camera images in the deviation corrected state recorded in the camera image recording unit 701 to the movement amount estimation-parameter calculation unit 607 and the deviation correction unit 608 (step S418 in FIG. 43). In addition, to the movement amount estimation-parameter calculation unit 607 and the deviation correction unit 608, the input data selection unit 702 outputs the external parameter as the camera parameter corresponding to the image selected from all camera images in the deviation corrected state recorded in the camera image recording unit 701.

When there exists no image in a close condition in all the present camera images acquired from the camera image reception unit 609 or camera images recorded in the camera image recording unit 701 (in the past within some frames from the present time point), the input data selection unit 702 stays on standby until a camera image after the occurrence of the deviation is newly recorded in the camera image recording unit 701 and executes the aforementioned comparison process again while including the aforementioned newly recorded camera image (steps SS415 to S417 in FIG. 43, FIG. 42C). Alternatively, the input data selection unit 702 may also stay on standby until an image in a condition close to a present camera image directly acquired from the camera image reception unit 609 is obtained.

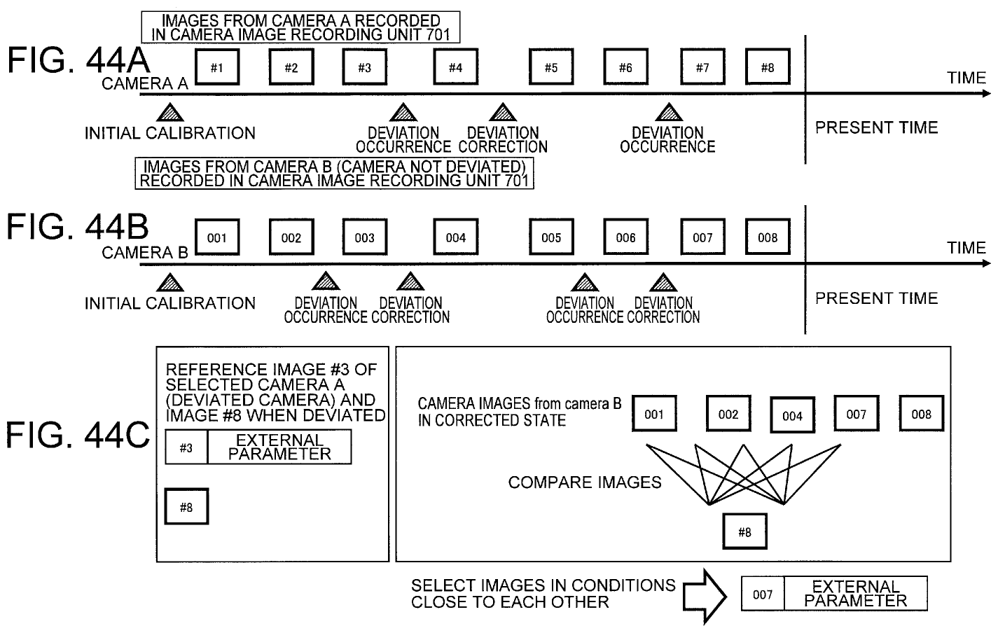

FIGS. 44A to 44C are explanatory diagrams showing a process executed by the input data selection unit 702 shown in FIG. 40. FIG. 44A shows images #1 to #8 from a camera A (e.g., camera 600_1) recorded by the camera image recording unit 701. The camera A is in the state in which deviation has occurred. FIG. 448 shows images 001 to 008 from a camera B (e.g., camera 600_2) recorded by the camera image recording unit 701. The camera B is in the state in which no deviation has occurred (i.e., deviation has been corrected). FIG. 44C shows a method of selecting a camera image in regard to the camera B to which no deviation has occurred.

In regard to the camera to which no deviation has occurred, the input data selection unit 702 selects camera images in situations where no deviation has occurred (e.g., 001, 002, 004, 007 and 008 in FIG. 44C) and outputs a corresponding external parameter (e.g., 007 in FIG. 440). Specifically, from the pairs each consisting of a camera image and an external parameter recorded in the camera image recording unit 701, the input data selection unit 702 selects a pair in the corrected state and outputs the selected pair to the deviation correction unit 608. Also in the selection of the camera to which no deviation has occurred, the input data selection unit 702 may select and output an image (e.g., 007 in FIG. 44C) in a condition close to the camera image to which deviation has occurred (e.g., #8 in FIG. 440). The image in a close condition is, for example, an image whose image capture time is close, an image in which no person exists, an image whose sunshine condition is close, an image whose luminance value is close, an image that is close in the similarity level, or the like. Specifically, the image in a close condition is an image whose difference in the image capture time is within a predetermined time, an image in which no person exists (or an image whose difference in the number of people is within a predetermined value), an image whose difference in the sunshine duration per day is within a predetermined time, an image whose difference in the luminance value is within a predetermined value, an image whose difference in the similarity level is within a predetermined value, or the like. In other words, the image in a close condition is judged based on one or more of a condition in which the difference in the image capture time (e.g., difference in the season, difference in the date (month/day/year) or difference in the time of day (hour:minute:second)) is within a predetermined range, a condition in which there exists no mobile object, a condition in which the difference in the number of people is within a predetermined value, a condition in which the difference in the sunshine duration per day is within a predetermined time, and a condition in which an index used when evaluating image similarity level including one of luminance difference, distribution and contrast is within a predetermined range, or based on a classification result obtained from a learning model for classifying images.

### (4-4) Movement Amount Estimation-Parameter Calculation Unit 607

In regard to each camera judged by the deviation detection unit 606 to have the position posture deviation, the movement amount estimation-parameter calculation unit 607 receives the camera image and the reference data (i.e., the reference image and the external parameter) provided from the input data selection unit 702 as the input and calculates the external parameter based on these input data. Except for this feature, the movement amount estimation-parameter calculation unit 607 is the same as that in the third embodiment.

### (4-5) Deviation Correction Unit 608

In regard to each camera judged by the deviation detection unit 606 to have the position posture deviation, the deviation correction unit 608 receives the camera image (i.e., the image captured by the camera in the deviated state), the reference image and the external parameter provided from the input data selection unit 702. In regard to each camera not judged by the deviation detection unit 606 to have the position posture deviation, the deviation correction unit 608 receives the camera image and the corresponding external parameter provided from the input data selection unit 702. In the third embodiment, values provided from the camera parameter input unit 601 are used as the external parameter of the camera having no position posture deviation. In contrast, in the fourth embodiment, the external parameter corresponding to the image selected by the input data selection unit 702 is used as the external parameter of the camera having no position posture deviation. However, in the fourth embodiment, the external parameter of the camera having no position posture deviation is not updated in the optimization process similarly to the third embodiment. Except for these features, the deviation correction unit 608 in the fourth embodiment is the same as that in the third embodiment.

### (4-6) Effect

As described above, with the image processing device 710, the image processing method or the image processing program according to the fourth embodiment, the deviation correction process and the movement amount estimation process are executed based on images in close conditions, and thus estimation accuracy of the movement amount or calculation accuracy of the deviation amount evaluation value can be increased. Further, robustness of the correction process can be increased and the condition in which the correction can be executed can be widened.

Except for the above-described features, the fourth embodiment is the same as the third embodiment. The deviation correction process and the movement amount estimation process described in the fourth embodiment can be applied also to other embodiments.

### (5) Fifth Embodiment

### (5-1) Image Processing Device 810

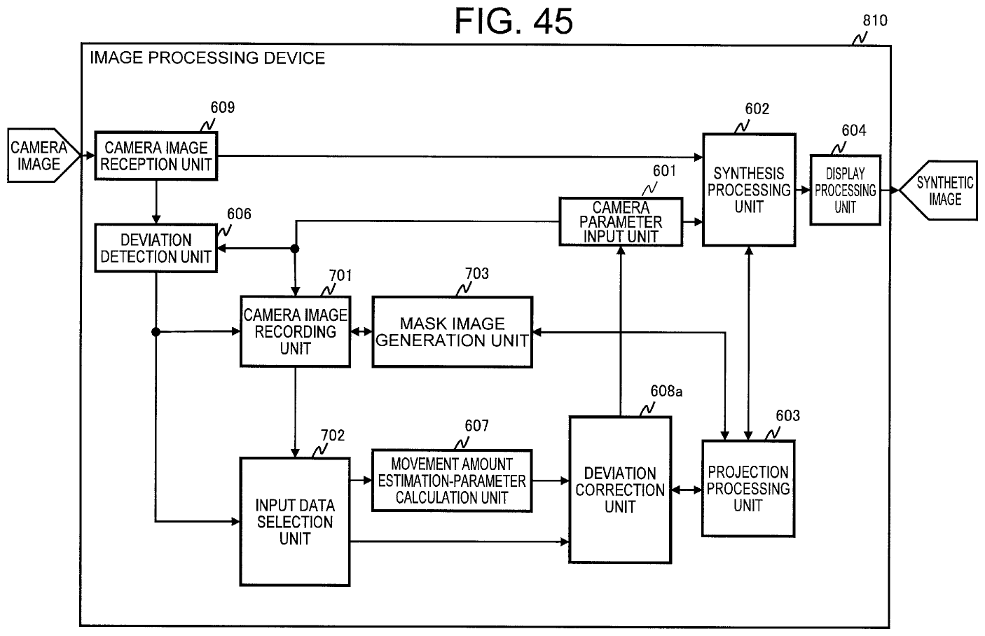

FIG. 45 is a functional block diagram schematically showing the configuration of an image processing device 810 according to a fifth embodiment. In FIG. 45, each component identical or corresponding to a component shown in FIG. 40 is assigned the same reference character as in FIG. 40. The image processing device 810 according to the fifth embodiment differs from the image processing device 710 according to the fourth embodiment in further including a mask image generation unit 703.

As shown in FIG. 45, the image processing device 810 according to the fifth embodiment includes the camera image reception unit 609, the camera parameter input unit 601, the synthesis processing unit 602, the projection processing unit 603, the display processing unit 604, the deviation detection unit 606, the movement amount estimation-parameter calculation unit 607, a deviation correction unit 608a, the camera image recording unit 701, the input data selection unit 702 and the mask image generation unit 703. The image processing device 810 according to the fifth embodiment differs from the image processing device 710 according to the fourth embodiment in the functions of the projection processing unit 603, the camera image recording unit 701, the input data selection unit 702, the movement amount estimation-parameter calculation unit 607 and the deviation correction unit 608a. The mask image generation unit 703 generates a mask image that designates a mask region not used for the estimation of the movement amounts of the plurality of cameras and the calculation of the plurality of external parameters after the correction. The movement amount estimation-parameter calculation unit 607 estimates the movement amounts of the plurality of cameras and calculates the plurality of external parameters after the correction based on regions of the plurality of reference images excluding the mask region and regions of the plurality of camera images captured by the plurality of cameras excluding the mask region.

The hardware configuration of the image processing device 810 is the same as that shown in FIG. 26. The description of the image processing device 810 according to the fifth embodiment will be given below mainly of the difference from the image processing device 710 according to the fourth embodiment.

### (5-2) Projection Processing Unit 603

When the inputted camera image includes a masked region, the projection processing unit 603 shown in FIG. 45 projects the camera image including the masked region and outputs the projection image including the mask region. Except for this feature, the projection processing unit 603 shown in FIG. 45 is the same as that shown in FIG. 40.

### (5-3) Camera Image Recording Unit 701

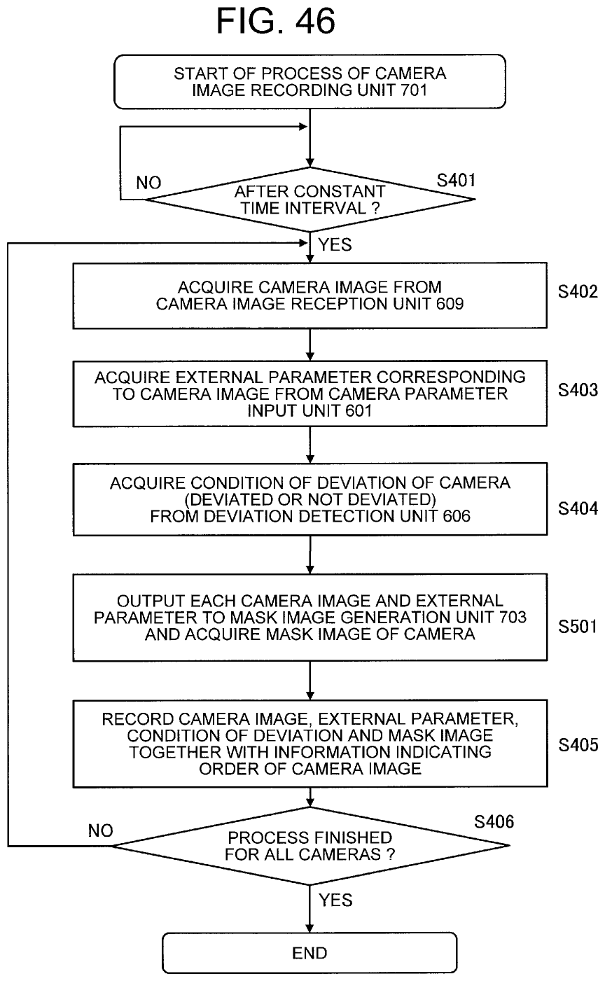

FIG. 46 is a flowchart showing a process executed by the camera image recording unit 701 shown in FIG. 45. In FIG. 46, each process step identical to a process step shown in FIG. 41 is assigned the same reference character as in FIG. 41. The camera image recording unit 701 records camera images provided from the camera image reception unit 609 at constant time intervals (step S401). The constant time interval is, for example, a time interval corresponding to some frames, an interval of some seconds, or the like. When recording a camera image, the camera image recording unit 701 also records an ordinal number, a time stamp or the like so that the chronological relationship regarding the timing of recording becomes clear. To give an explanation with reference to FIG. 26, the main processor 611 stores information recorded in the main memory 612 in the auxiliary memory 613 via the file interface 616.

When recording an image, the camera image recording unit 701 also records (i.e., stores) the already set external parameter of the camera in the camera parameter input unit 601 (steps S402, S403 and S405). Further, when recording an image, the camera image recording unit 701 also records the state of the deviation of the camera provided from the deviation detection unit 606 (steps S402, S404 and S405).

Furthermore, the camera image recording unit 701 inputs the image from each camera and the external parameters set to the camera parameter input unit 601 to the mask image generation unit 703 and acquires the mask image of each camera (step S501). When recording a camera image, the camera image recording unit 701 records the mask image provided from the mask image generation unit 703 while associating the mask image with the camera image (step S405).

Moreover, the camera image recording unit 701 outputs the data to be recorded (the camera image, the external parameter, the mask image, an ordinal number or time stamp, and so forth) to the input data selection unit 702 as a set of data. The data to be recorded are, for example, the camera image, the external parameter, the mask image, the ordinal number or time stamp, and so forth. The camera image recording unit 701 repeats the processing of the steps S402 to S404, S501 and S405 for all the cameras (step S406).

### (5-4) Mask Image Generation Unit 703

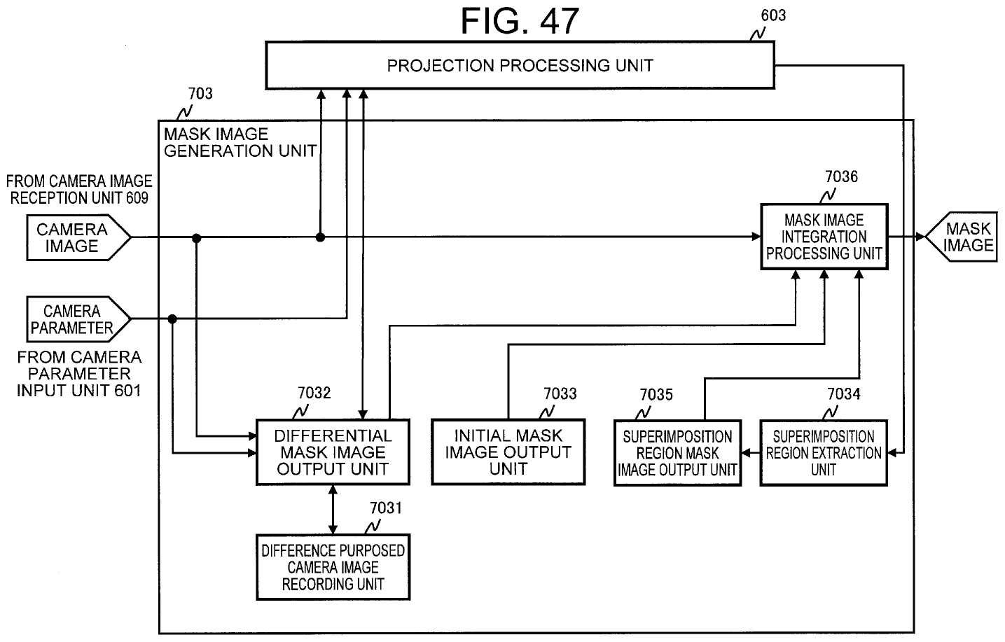

FIG. 47 is a functional block diagram schematically showing the configuration of the mask image generation unit 703 shown in FIG. 45. As shown in FIG. 47, the mask image generation unit 703 includes a difference purposed camera image recording unit 7031, a differential mask image output unit 7032, an initial mask image output unit 7033, a superimposition region extraction unit 7034, a superimposition region mask image output unit 7035 and a mask image integration processing unit 7036.

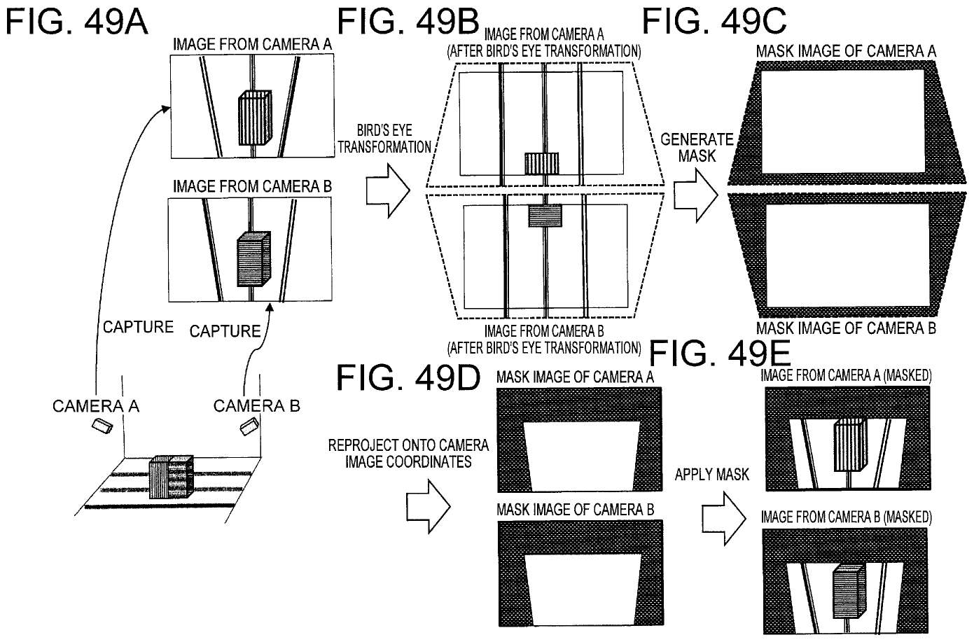

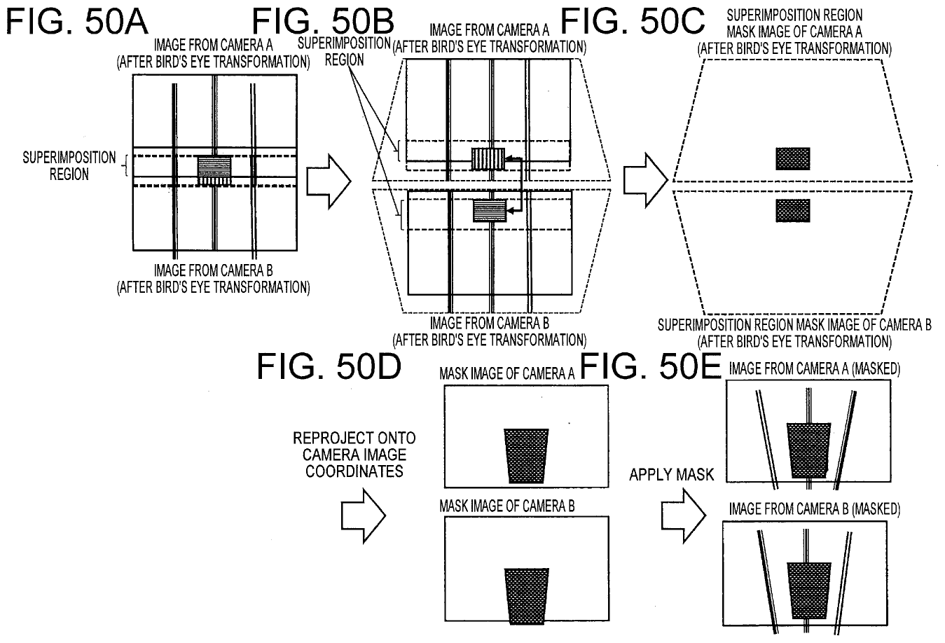

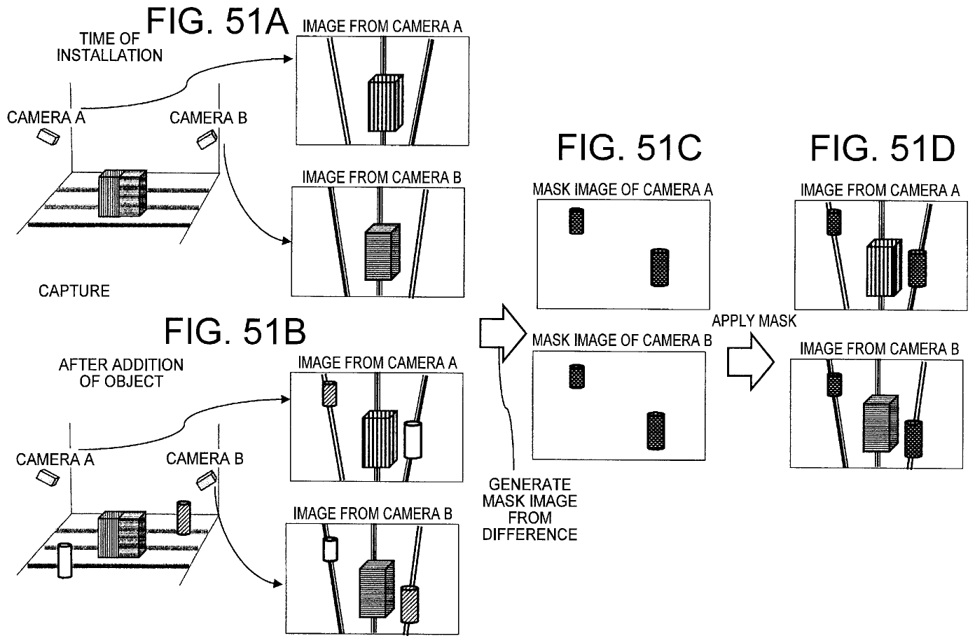

FIG. 48 is a flowchart showing a process executed by the mask image generation unit 703. FIGS. 49A to 49E, FIGS. 50A to 50E, FIGS. 51A to 51D, FIGS. 52A to 52C and FIGS. 53A to 53C are explanatory diagrams showing the process executed by the mask image generation unit 703. FIGS. 49A to 49E show a process corresponding to steps S511 and S512 in FIG. 48. FIGS. 50A to 50E show a process corresponding to steps S513 and S514 in FIG. 48. FIGS. 51A to 51D, FIGS. 52A to 52C and FIGS. 53A to 53C respectively show processes corresponding to steps S515, S516 and S517 in FIG. 48. The mask image generation unit 703 generates three types of masks which will be described below and generates masks to be used at a time of reprojection onto camera images.

### (Initial Mask Image Output Unit 7033)

The initial mask image output unit 7033 shown in FIG. 47 has stored mask image information, indicating a region previously excluded from the camera image, in the auxiliary memory 613 (FIG. 26), and provides the mask image information to the mask image integration processing unit 7036 (step S511 in FIG. 48, FIGS. 49A to 49C). The initial mask image output unit 7033 provides the mask image information in order to exclude a region that is not used in the camera images (e.g., a part other than a monitored range), an object whose position does not change such as a structure (or an object whose position does not change frequently), or the like when the images are outputted as the synthetic image, for example. The initial mask image output unit 7033 normalizes the mask image to be outputted based on the mask image when reprojected onto the camera image. The initial mask image output unit 7033 may also be configured to output a mask image that masks the image when projected. When integrating a mask with other masks, the initial mask image output unit 7033 is capable of integrating the masks into one mask image by performing the normalization in a camera image coordinate system. Thus, when a mask range is set in a projection image, for example, the initial mask image output unit 7033 transforms the mask range to a mask region in the camera image by reprojecting the mask range onto the camera image coordinate system by using the external parameter acquired from the camera image recording unit 701 (FIG. 49D). In the auxiliary memory 613 (FIG. 26), the mask image as a projection image or the mask image in the camera image is stored. When the mask range is set in a projection image, the mask image is transformed onto camera image coordinates and outputted (FIG. 49E).

### (Superimposition Region Mask Image Output Unit 7035)

The superimposition region mask image output unit 7035 shown in FIG. 47 generates and outputs a mask for a part where the pixel values are deviated when the camera image provided from the camera image recording unit 701 is projected (FIGS. 50A and 50B) and the superimposition region is extracted by the superimposition region extraction unit 7034 (steps S512 and S513 in FIG. 48, FIGS. 50B and 50C). Similarly to the initial mask, the mask image to be outputted is normalized based on the mask image when reprojected onto the camera image (FIG. 50D). The superimposition region mask image output unit 7035 reprojects the mask image onto the camera image coordinate system by using the external parameter acquired from the camera image recording unit 701 (step S514 in FIG. 48, FIG. 50E).

### (Differential Mask Image Output Unit 7032)

The differential mask image output unit 7032 shown in FIG. 47 detects whether there exists an object or not based on camera images recorded in the past (FIGS. 51A and 51B) and generates a mask for the place where the object exists (FIG. 51C). The initial mask is used for the purpose of excluding an object or the like whose position does not change frequently such as a structure, whereas a differential mask is used for the purpose of excluding an object whose position changes frequently (e.g., a parked vehicle).

The differential mask image output unit 7032 shown in FIG. 47 records camera images acquired from the camera image recording unit 701 in the difference purposed camera image recording unit 7031 (step S515 in FIG. 48). When generating a mask image, the differential mask image output unit 7032 reads in at least one camera image recorded in the difference purposed camera image recording unit 7031 (FIGS. 51A and 51B), generates a differential image, generates a mask image for masking the pertinent region (FIG. 51C), and outputs the mask image to the mask image integration processing unit 7036 (step S516 in FIG. 48).

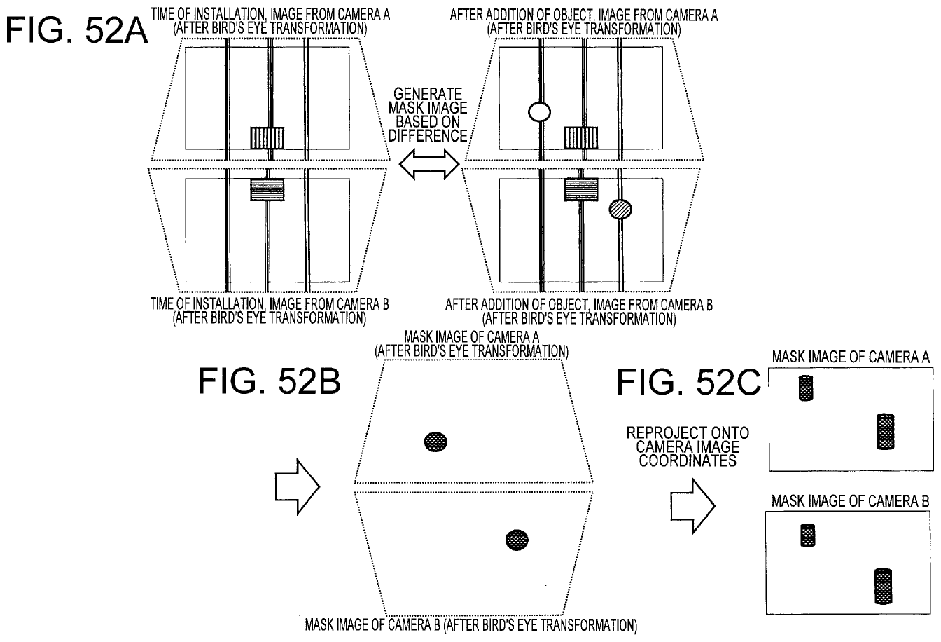

While the differential mask image output unit 7032 may calculate the difference between received camera images, it is also possible to first transform the received camera images into projection images and calculate the difference between the projection images. In this case, the differential mask image output unit 7032 makes the projection processing unit 603 transform the input images into projection images based on the inputted camera images and camera parameters, calculates the difference between the projection images (FIG. 52A), generates the mask image (FIG. 52B), and thereafter reprojects the mask image onto the camera coordinate system (FIG. 52C). Specifically, the differential mask image output unit 7032 reprojects the mask image by using the external parameter. It is also possible for the differential mask image output unit 7032 not to use the aforementioned difference but to directly extract a region where an object exists from the camera image by using an object detection algorithm and output the result of the extraction as the mask image.

### (Mask Image Integration Processing Unit 7036)

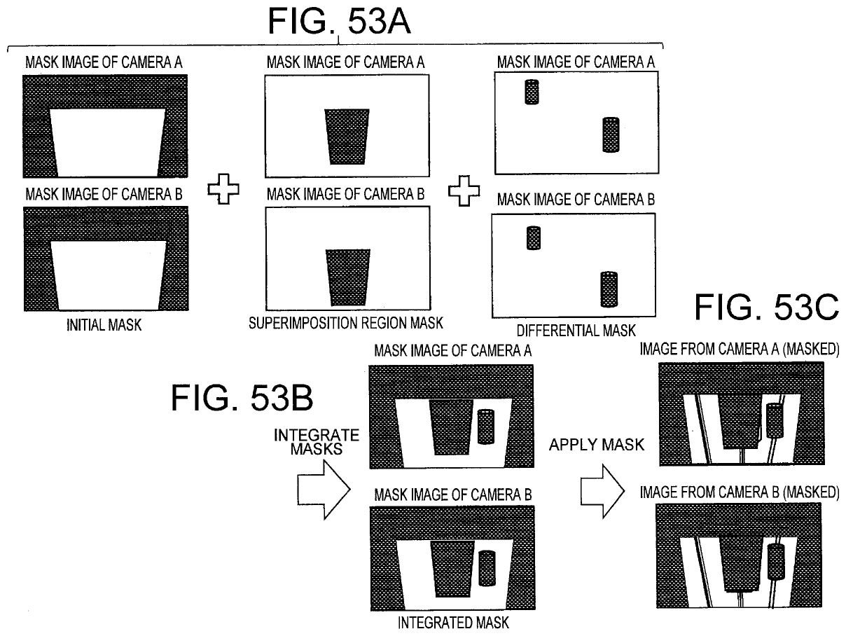

An integrated mask generated by the mask image integration processing unit 7036 shown in FIG. 47 is a mask obtained by integrating the initial mask, the superimposition region mask and the differential mask in regard to each camera into one mask. The integrated mask does not need to be a mask obtained by integrating all the masks; the integrated mask can be a mask obtained by integrating some selected masks. Further, the mask image integration processing unit 7036 may also select a process not performing the masking. The mask image integration processing unit 7036 integrates the mask images provided from the initial mask image output unit 7033, the superimposition region mask image output unit 7035 and the differential mask image output unit 7032 by means of OR (i.e., OR conditions) (FIG. 53A) and outputs the result of the integration as one mask image (step S517 in FIG. 48, FIGS. 53B and 53C).

### (5-5) Input Data Selection Unit 702

The input data selection unit 702 shown in FIG. 45 has the following functions (U1) and (U2):

(U1) When outputting the selected image (in the deviated state), the reference image and the external parameter in regard to a camera having the position posture deviation to the movement amount estimation-parameter calculation unit 607 and the deviation correction unit 608a, the input data selection unit 702 also outputs a mask image associated with the reference image and the external parameter.

(U2) When selecting images in close conditions, the input data selection unit 702 finds the images in close conditions by applying the mask image associated with the reference image and the external parameter. Namely, this process is a process of limiting an image range to be considered when obtaining the images in close conditions.

Except for these features, the input data selection unit 702 shown in FIG. 45 is the same as that in the fourth embodiment.

### (5-6) Movement Amount Estimation-Parameter Calculation Unit 607

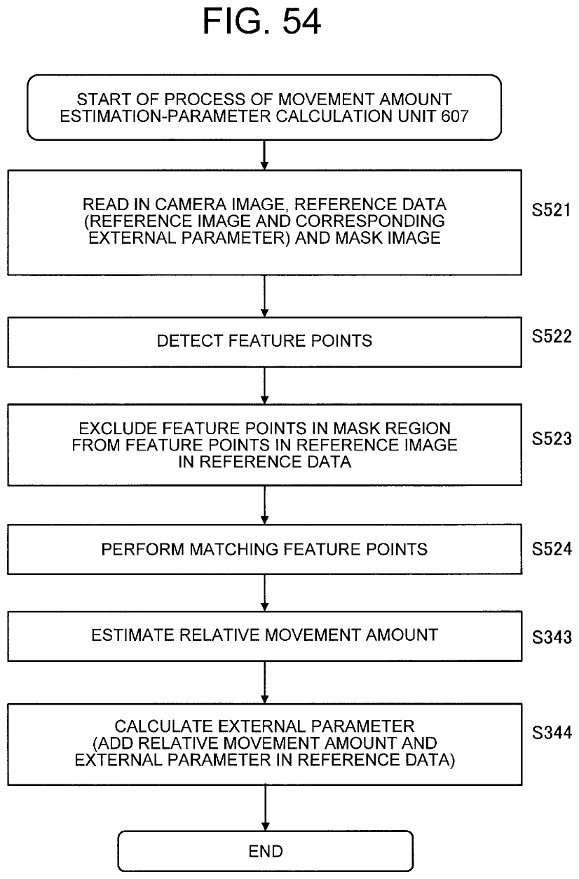

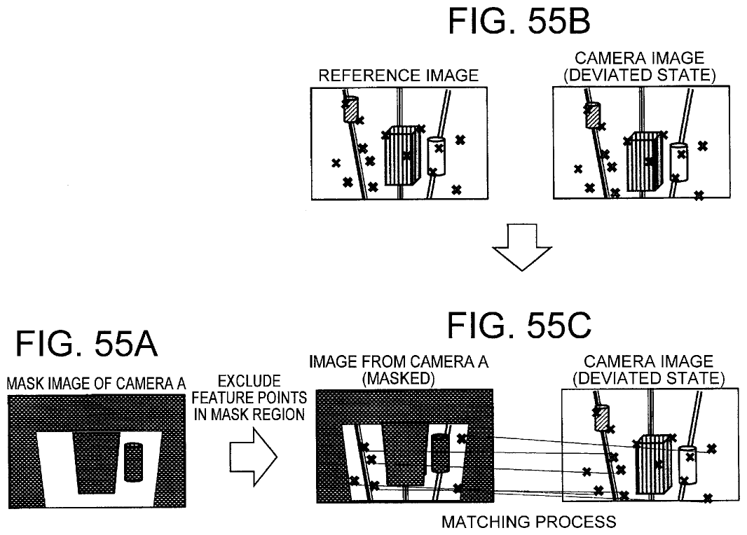

FIG. 54 is a flowchart showing a process executed by the movement amount estimation-parameter calculation unit 607 shown in FIG. 45. In FIG. 54, each process step identical to a process step shown in FIG. 38 is assigned the same reference character as in FIG. 38. FIGS. 55A to 55C are explanatory diagrams showing the process executed by the movement amount estimation-parameter calculation unit 607.

In regard to each camera judged by the deviation detection unit 606 to have the position posture deviation, the movement amount estimation-parameter calculation unit 607 receives the camera image, the reference image, the external parameter and the mask image provided from the input data selection unit 702 (step S521 in FIG. 54, FIGS. 55A and 55B). When performing the feature point matching, the movement amount estimation-parameter calculation unit 607 excludes the feature points in the part masked by the mask image from the targets of the matching (steps S522 to S524 in FIG. 54, FIG. 55C). Namely, the movement amount estimation-parameter calculation unit 607 limits the range of performing the feature point matching. Except for these features, the process of the movement amount estimation-parameter calculation unit 607 is the same as that in the fourth embodiment.

### (5-7) Deviation Correction Unit 608a

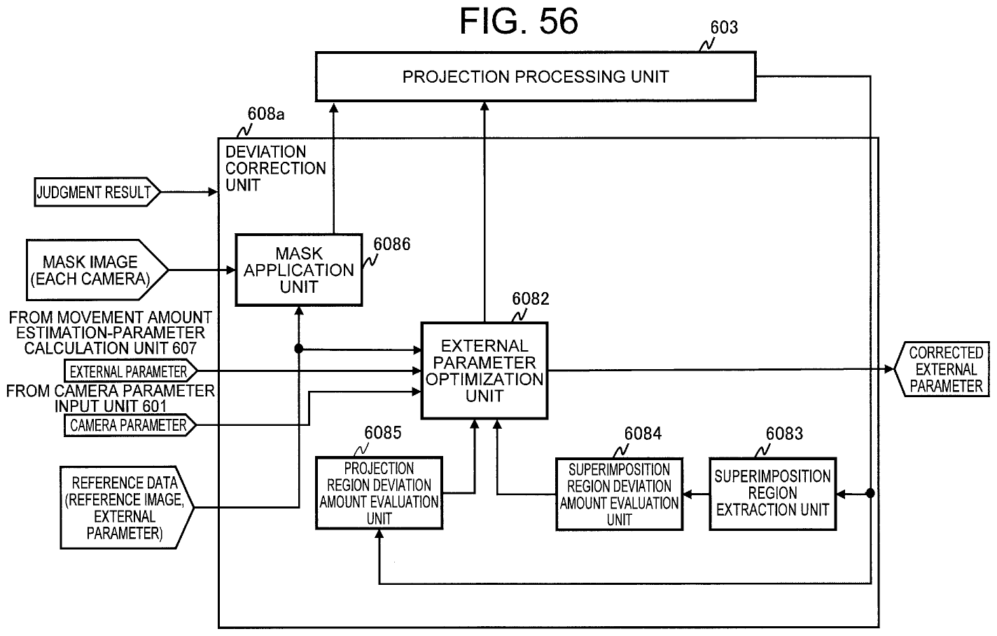

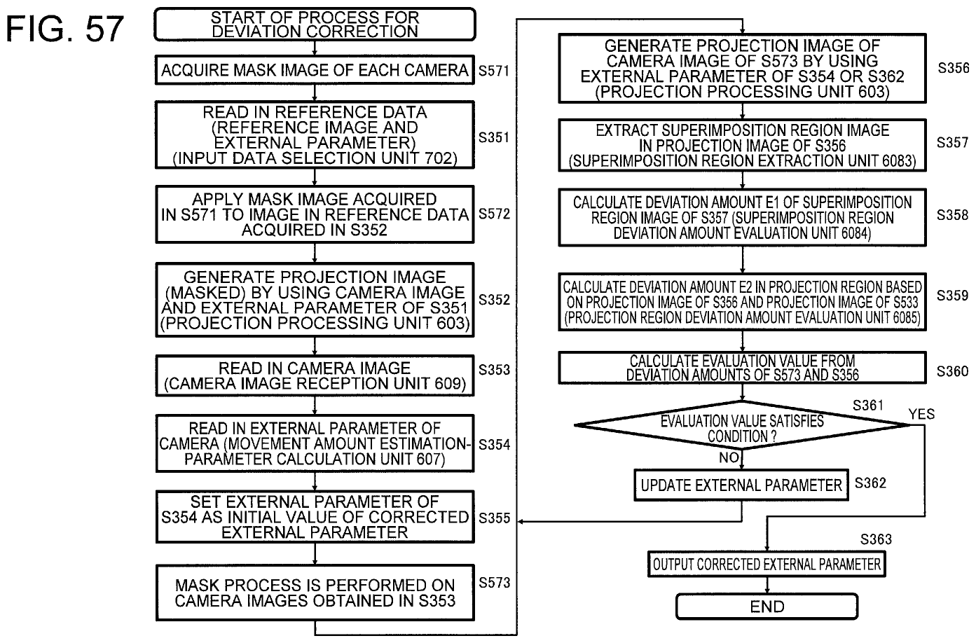

FIG. 56 is a functional block diagram schematically showing the configuration of the deviation correction unit 608a shown in FIG. 45. In FIG. 56, each component identical or corresponding to a component shown in FIG. 31 is assigned the same reference character as in FIG. 31. FIG. 57 is a flowchart showing a process for deviation correction. In FIG. 57, each process step identical or corresponding to a process step shown in FIG. 39 is assigned the same reference character as in FIG. 39.

In regard to each camera judged by the deviation detection unit 606 to have the position posture deviation, the deviation correction unit 608a shown in FIG. 45 and FIG. 56 receives the camera image (i.e., the camera image captured by the camera in the deviated state), the reference image, the external parameter and the mask image provided from the input data selection unit 702 (steps S571, S351, 5572, S352 to S355 and S573). In regard to each camera not judged by the deviation detection unit 606 to have the position posture deviation, the deviation correction unit 608a receives the camera image and the corresponding external parameter and mask image provided from the input data selection unit 702. The received data are used in the comparison of superimposition regions.

When a mask region exists in an input image (i.e., a projection image, and a superimposition region image), the projection region deviation amount evaluation unit 6085 and the superimposition region deviation amount evaluation unit 6084 exclude the part from the target of the comparison process. When a mask region exists in the projection image provided from the projection processing unit 603, the superimposition region extraction unit 6083 extracts the superimposition region while maintaining the mask region and outputs the extracted superimposition region to the superimposition region deviation amount evaluation unit 6084.

### (Mask Application Unit 6086)

A mask application unit 6086 executes the following processes (V1) and (V2):

(V1) The mask application unit 6086 receives selected reference data (i.e., the reference image and the external parameter) and the mask image corresponding to the reference data as the input, performs the mask process on the reference image, and outputs the masked reference image and the corresponding external parameter to the projection processing unit 603.

(V2) When an object exists in the mask region in the selected reference image, the mask application unit 6086 detects the object. Thereafter, if the detected object exists in the inputted camera image (camera image in the deviated state), the mask application unit 6086 outputs the image in which the object has been masked.

Except for the above-described features, the deviation correction unit 608a is the same as the deviation correction unit 608 in the fourth embodiment.

### (5-8) Effect

As described above, with the image processing device 810, the image processing method or the image processing program according to the fifth embodiment, image parts adversely affecting the estimation of the movement amount or the calculation of the deviation amount evaluation value are excluded from the images used for the deviation correction process, and thus the estimation accuracy of the movement amount or the calculation accuracy of the deviation amount evaluation value can be increased.

Except for the above-described features, the fifth embodiment is the same as the third or fourth embodiment. The processes for generating and using the mask image described in the fifth embodiment can be applied also to other embodiments.

### (6) Sixth Embodiment

### (6-1) Image Processing Device 910

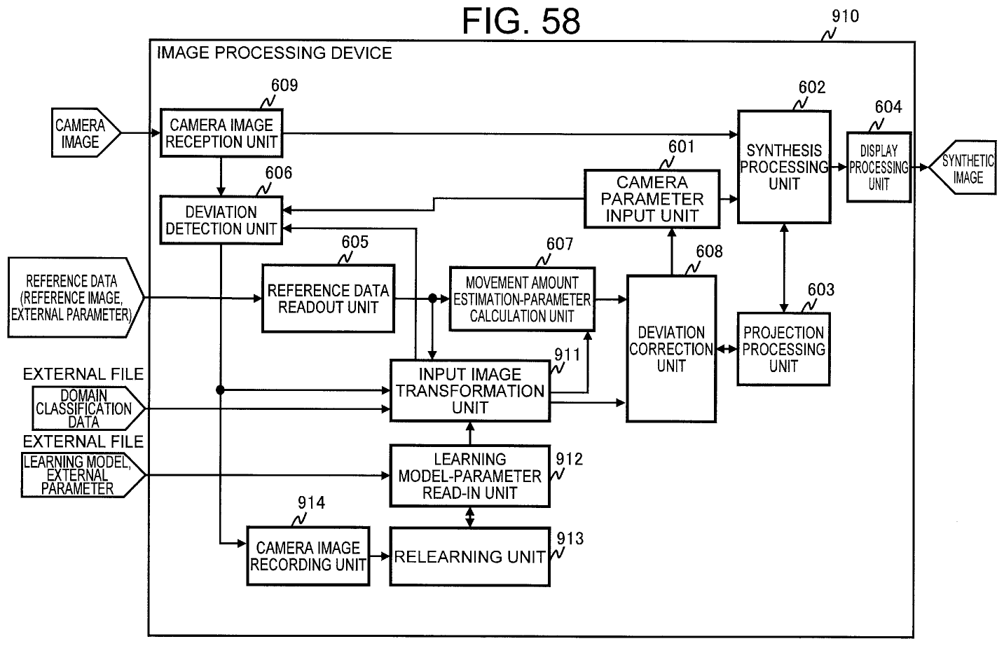

FIG. 58 is a functional block diagram schematically showing the configuration of an image processing device 910 according to a sixth embodiment. In FIG. 58, each component identical or corresponding to a component shown in FIG. 27 is assigned the same reference character as in FIG. 27. The image processing device 910 according to the sixth embodiment differs from the image processing device 610 according to the third embodiment in including an input image transformation unit 911, a learning model-parameter read-in unit 912, a relearning unit 913 and a camera image recording unit 914.

As shown in FIG. 58, the image processing device 910 according to the sixth embodiment includes the camera image reception unit 609, the camera parameter input unit 601, the synthesis processing unit 602, the projection processing unit 603, the display processing unit 604, the reference data readout unit 605, the movement amount estimation-parameter calculation unit 607, the deviation correction unit 608, the camera image recording unit 914, the input image transformation unit 911, the learning model-parameter read-in unit 912 and the relearning unit 913. The hardware configuration of the image processing device 910 is the same as that shown in FIG. 26.

The input image transformation unit 911 classifies each of a plurality of camera images into one of a plurality of domains based on the states in which the plurality of camera images were captured, classifies each of a plurality of reference images into one of the plurality of domains based on the states in which the plurality of reference images were captured, and performs a transformation process, for causing a state in which the domain of a comparison target camera image among the plurality of camera images and the domain of a comparison target reference image among the plurality of reference images are close, on at least one of the comparison target camera image and the comparison target reference image. Further, also among the plurality of camera image, the input image transformation unit 911 performs a transformation process of causing a state in which the domains of camera images are close. The movement amount estimation-parameter calculation unit 607 estimates the movement amounts of the plurality of cameras based on the comparison target camera images and the comparison target reference images outputted from the input image transformation unit 911 and calculates the plurality of external parameters after the correction corresponding to the plurality of cameras. The transformation process is a process of making the domain of the comparison target camera image and the domain of the comparison target reference image coincide with each other, or a process of reducing the distance between the domains.

The relearning unit 913 generates and updates a learning model, indicating into which of the plurality of domains each of the plurality of camera images should be classified and into which of the plurality of domains the reference image should be classified, based on the plurality of camera images. Based on the learning model, the input image transformation unit 911 executes the classification of each of the plurality of camera images, the classification of each of the plurality of reference images, and the aforementioned transformation process. The relearning unit 913 generates and updates the learning model based on the plurality of camera images recorded by the camera image recording unit 914.

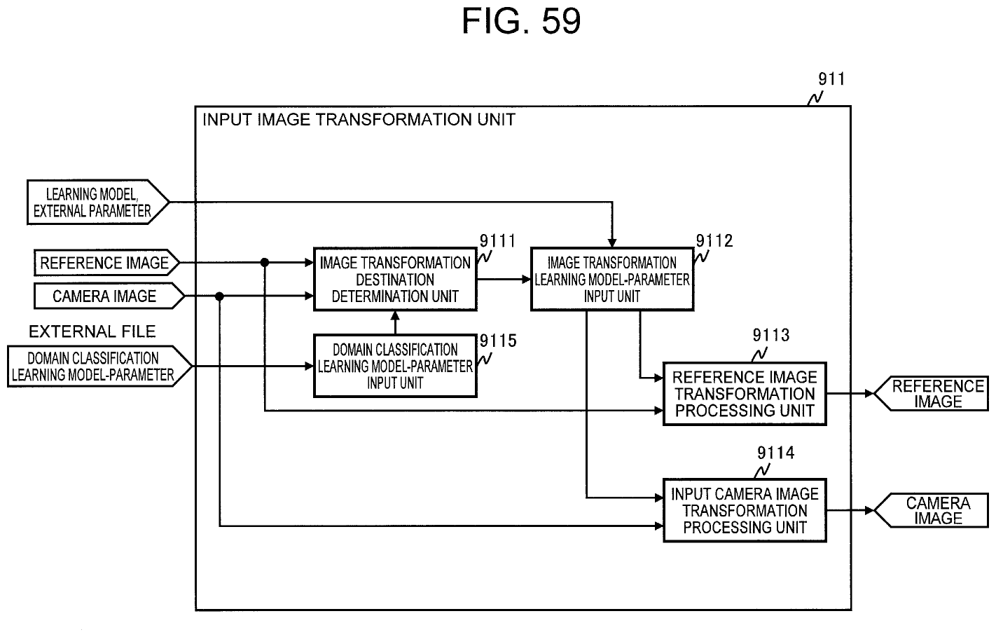

FIG. 59 is a functional block diagram schematically showing the configuration of the input image transformation unit 911 shown in FIG. 58. As shown in FIG. 59, the input image transformation unit 911 includes an image transformation destination determination unit 9111, an image transformation learning model-parameter input unit 9112, a reference image transformation processing unit 9113 and an input camera image transformation processing unit 9114.

### (6-2) Reference Data Readout Unit 605

The reference data readout unit 605 shown in FIG. 58 provides the input image transformation unit 911 with the reference image as the reference data. Further, the reference data readout unit 605 provides the movement amount estimation-parameter calculation unit 607 with the external parameter as the reference data. Except for these features, the reference data readout unit 605 shown in FIG. 58 is the same as that described in the third embodiment.

### (6-3) Deviation Detection Unit 606

The deviation detection unit 606 shown in FIG. 58 notifies the input image transformation unit 911 that the deviation has occurred. The deviation detection unit 606 shown in FIG. 58 is the same as that described in the third embodiment. Incidentally, when detecting the deviation, the deviation detection unit 606 may also execute the deviation detection not by using the camera images from the camera image reception unit but by using the comparison target camera image and the comparison target reference image outputted from the input image transformation unit 911 as the input.

### (6-4) Movement Amount Estimation-Parameter Calculation Unit 607

The movement amount estimation-parameter calculation unit 607 shown in FIG. 58 estimates the movement amount and calculates the external parameter based on the transformed (or not transformed) reference image provided from the input image transformation unit 911, the transformed (or not transformed) camera image provided from the camera image reception unit 609, and the external parameter provided from the reference data readout unit 605. Except for these features, the movement amount estimation-parameter calculation unit 607 shown in FIG. 58 is the same as that described in the third embodiment.

### (6-5) Deviation Correction Unit 608

The deviation correction unit 608 shown in FIG. 58 corrects the deviation amount based on the transformed (or not transformed) reference image in the reference data provided from the input image transformation unit. 911, the transformed (or not transformed) camera image provided from the camera image reception unit 609, and the external parameter and the relative movement amount provided from the movement amount estimation-parameter calculation unit 607.

Further, the deviation correction unit 608 performs the transformation of camera images by using the input image transformation unit 911 and calculates the deviation amount by using transformed images obtained as the result of the transformation. Similarly to the third embodiment, the deviation correction unit 608 executes the camera parameter optimization process by using the values evaluated by the projection region deviation amount evaluation unit and the superimposition region deviation amount evaluation unit (i.e., the evaluation values). The former evaluation value is represented as E1 and the latter evaluation value is represented as E2.

When calculating E1, the comparison between the reference image and the present camera image in regard to one camera is made, and thus the input image transformation unit 911 transforms the reference image into the domain to which the camera image provided from the camera image reception unit 609 belongs, or transforms the camera image provided from the camera image reception unit 609 into the domain to which the reference image belongs. The projection region deviation amount evaluation unit executes the calculation of the deviation amount by using the aforementioned images (i.e., performs bird's eye transformation on images and evaluates the deviation amount similarly to the third embodiment).

When calculating E2, the input image transformation unit 911 transforms the image from the correction target camera, the image from an adjacent corrected camera (i.e., camera in the non-deviated state), or both of the images into an appropriate domain. The superimposition region deviation amount evaluation unit executes the calculation of the deviation amount by using the aforementioned images after the transformation (i.e., performs bird's eye transformation on images, extracts the superimposition region, and calculates the deviation amount from the extracted superimposition region images similarly to the third embodiment).

Methods of determining the destination of the domain transformation between different cameras (i.e., transformation for the aforementioned evaluation value E2) are as described in the following (Y1) to (Y3):

(Y1) Previously obtain every domain-to-domain distance in regard to all the domains of the different cameras.
(Y2) Classify each of the image from the correction target camera and the image from the adjacent camera into the domain in regard to each camera and obtain the domain-to-domain distance between the domains of the different cameras.
(Y3) When there exists a domain that decreases the distance between the images based on the distances obtained in the above (Y1) and (Y2), transform the domains of the images from the correction target camera and the adjacent camera into the pertinent domain.

When there exist a plurality of adjacent cameras, domain transformation optimum for each image may be selected. Namely, different domain transformation is performed for each adjacent camera. For example, in the comparison of the domain-to-domain distance of the correction target camera and the adjacent camera (namely, the aforementioned (Y1)), the image similarly in the superimposition region is calculated by transforming the images into a domain “summer and daytime”. In the comparison of the domain-to-domain distance of the correction target camera and the adjacent camera (namely, the aforementioned (Y2)), the image similarly in the superimposition region is calculated by transforming the images into a domain “autumn and daytime”. Except for these features, the deviation correction unit 608 shown in FIG. 58 is the same as that described in the third embodiment.

### (6-6) Camera Image Recording Unit 914

The camera image recording unit 914 shown in FIG. 58 records camera images provided from the camera image reception unit 609 in the storage device (e.g., the external storage device 17 in FIG. 26) at constant time intervals. Here, the constant time interval is an interval corresponding to a predetermined number of frames (e.g., an interval corresponding to some frames), a predetermined time interval (e.g., an interval of some seconds), or the like. When recording a camera image provided from the camera image reception unit 609, the camera image recording unit 914 records information such as the ordinal number or the time stamp of the camera image while associating the information with the camera image so that the chronological relationship regarding the timing of recording the camera image becomes clear. To explain the process executed by the camera image recording unit 914 with reference to FIG. 26, the main processor 611 stores the camera image in the auxiliary memory 613 from the main memory 612 via the file interface 616.

### (6-7) Input Image Transformation Unit 911

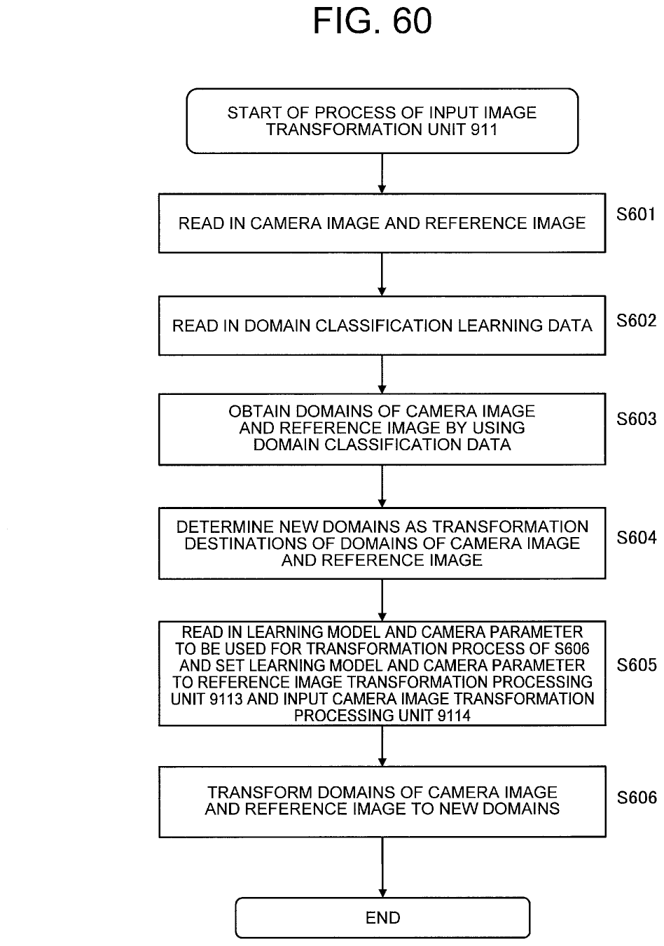

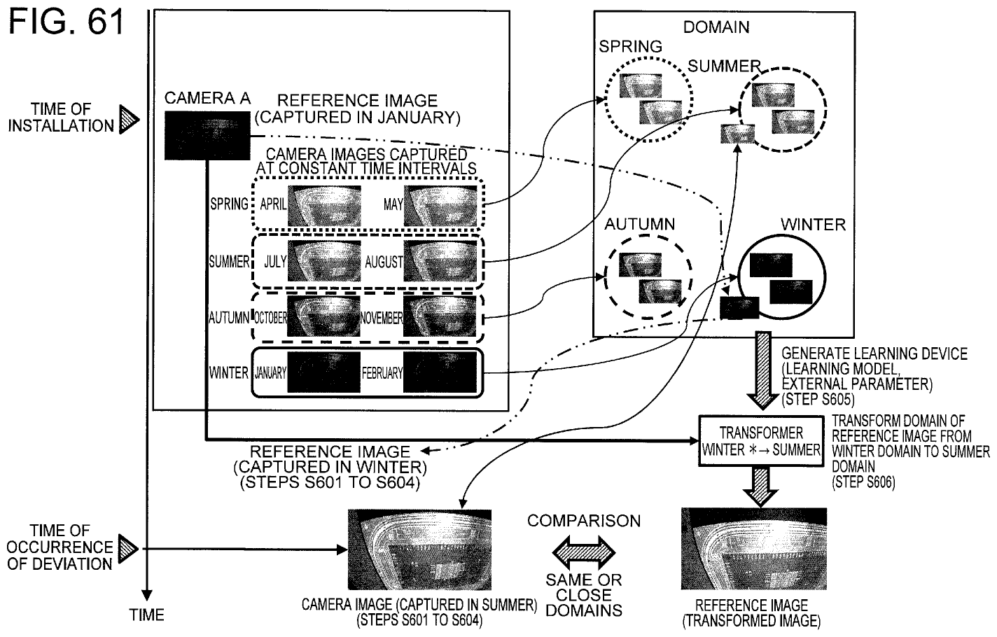

FIG. 60 is a flowchart showing a process executed by the input image transformation unit 911 shown in FIG. 58 and FIG. 59. FIG. 61 is an explanatory diagram showing the process executed by the input image transformation unit 911 shown in FIG. 58 and FIG. 59.

The input image transformation unit 911 executes a transformation process for transforming at least one of the reference image provided from the reference data readout unit 605 and the camera image provided from the camera image reception unit 609 so as to make these images be in a condition in which the images are close to each other and provides the movement amount estimation-parameter calculation unit 607 with the reference image after the transformation process and the camera image after the transformation process. The “condition in which the reference image and the camera image are close to each other” include, for example, one or more of a condition in which the sunshine situations are close to each other, a condition in which the seasons are close to each other, a condition in which situations regarding the presence/absence of a person are close to each other, etc. For example, when the reference image provided from the reference data readout unit 605 is an image of the daytime and the camera image provided from the camera image reception unit 609 is an image of the nighttime, the input image transformation unit 911 transforms the camera image provided from the camera image reception unit 609 into a camera image in a daytime condition. When the present camera image captured by the camera A is a camera image captured in summer (e.g., camera image in a summer domain in a lower left part of FIG. 61) and the reference image is a camera image captured in winter (e.g., camera image in a winter domain in an upper right part of FIG. 61), the input image transformation unit 911 transforms the reference image so that the domain of the reference image changes from winter to summer and thereby generates the transformed reference image (e.g., reference image in the summer domain in a lower right part of FIG. 61). By executing the transformation process so as to make the reference image and the camera image be in conditions close to each other and comparing the reference image and the camera image after the transformation process as above, the reference image and the camera image can be compared under conditions close to (preferably, equal to) each other.

### (Image Transformation Destination Determination Unit 9111)

The image transformation destination determination unit 9111 shown in FIG. 59 determines the method of the transformation process of each image based on the reference image provided from the reference data readout unit 605, the camera image provided from the camera image reception unit 609 and domain classification data prepared previously, and notifies the image transformation learning model-parameter input unit 9112 of the method of the transformation process (steps S601 to S603 in FIG. 60). In the transformation process of the reference image or the camera image, the image transformation destination determination unit 9111 executes the transformation of the domain to which each of the reference image and the camera image belongs, such as transforming an image of the nighttime into an image of the daytime, transforming an image of spring into an image of winter, transforming an image of a rainy day into an image of a sunny day, or the like (steps S604 to S606 in FIG. 60). The method of the transformation process is, for example, a learning model and a camera parameter used in the transformation from a domain D1 to a domain D2 or the like. Further, the transformation process executed by the image transformation destination determination unit 9111 includes a process of directly outputting at least one of the reference image and the camera image without changing the image(s). Incidentally, the domain to which the reference image or the camera image belongs after performing the transformation process on the reference image and the camera image is referred to also as a “domain after the transformation process” or a “transformation destination”.

For determining the transformation destination, it is necessary to judge to which domain each of the reference image in the reference data provided from the reference data readout unit 605 and the camera image provided from the camera image reception unit 609 belongs, and thus the image transformation destination determination unit 9111 also makes the judgment on to which domain each image belongs. The image transformation destination determination unit 9111 prepares a previously labeled image, that is, a standard image belonging to each domain, and judges the domain based on the similarity level to the standard image (i.e., distance to the image belonging to each domain). For the domain judgment, a machine learning algorithm such as t-SNE (T-distributed Stochastic Neighbor. Embedding) can be used. For example, in cases of classifying images into four domains of early morning, daytime, nightfall and nighttime, the image transformation destination determination unit 9111 previously prepares standard images respectively captured in the early morning, in the daytime, in the nightfall and in the nighttime, and judges the domain to which the reference image or the camera image belongs by obtaining the similarity level between the standard image belonging to each domain and the reference image provided from the reference data readout unit 605 or the camera image provided from the camera image reception unit 609. Incidentally, while the description has been given of an example in which the image transformation destination determination unit 9111 directly obtains the similarity level between the standard image and the reference image or the camera image as above, it is also possible to judge the domain based on the similarity level between an image obtained by convolution of each image (i.e., intermediate data) and an image obtained by convolution of the standard image (i.e., intermediate standard data).

As methods of determining the transformation destination, there are the following methods (Z1) to (Z3), for example:

(Z1) The first determination method is a method in which the reference image provided from the reference data readout unit 605 is transformed into the domain to which the camera image provided from the camera image reception unit 609 belongs. For example, when the reference image is an image of the nighttime and the camera image provided from the camera image reception unit 609 is an image of the daytime, the image transformation destination determination unit 9111 performs the transformation process on the reference image so that the domain to which the reference image belongs changes from the nighttime domain to the daytime domain.

(Z2) The second determination method is a method in which the camera image provided from the camera image reception unit 609 is transformed into the domain of the reference image provided from the reference data readout unit 605. For example, when the camera image provided from the camera image reception unit 609 is an image of the nighttime and the reference image is an image of the daytime, the image transformation destination determination unit 9111 performs the transformation process on the camera image so that the domain to which the camera image provided from the camera image reception unit 609 belongs changes from the nighttime domain to the daytime domain.

(Z3) The third determination method is a method in which the reference image provided from the reference data readout unit 605 and the camera image provided from the camera image reception unit 609 are transformed into a new domain. For example, when the camera image provided from the camera image reception unit 609 is an image of early morning and the reference image is an image of nightfall, the image transformation destination determination unit 9111 transforms the camera image provided from the camera image reception unit 609 from the image of early morning to an image of the daytime (i.e., transforms the domain from the early morning domain to the daytime domain) and transforms the reference image from the image of nightfall to an image of the daytime (i.e., transforms the domain from the nightfall domain to the daytime domain).

As a method of determining the method of the domain transformation, the method of the domain transformation is determined based on the similarity level (e.g., distance) between the reference image provided from the reference data readout unit 605 and the camera image provided from the camera image reception unit 609 and the distances to images respectively belonging to the domains.

### (Examples of Transformations of (Z1) to (Z3))

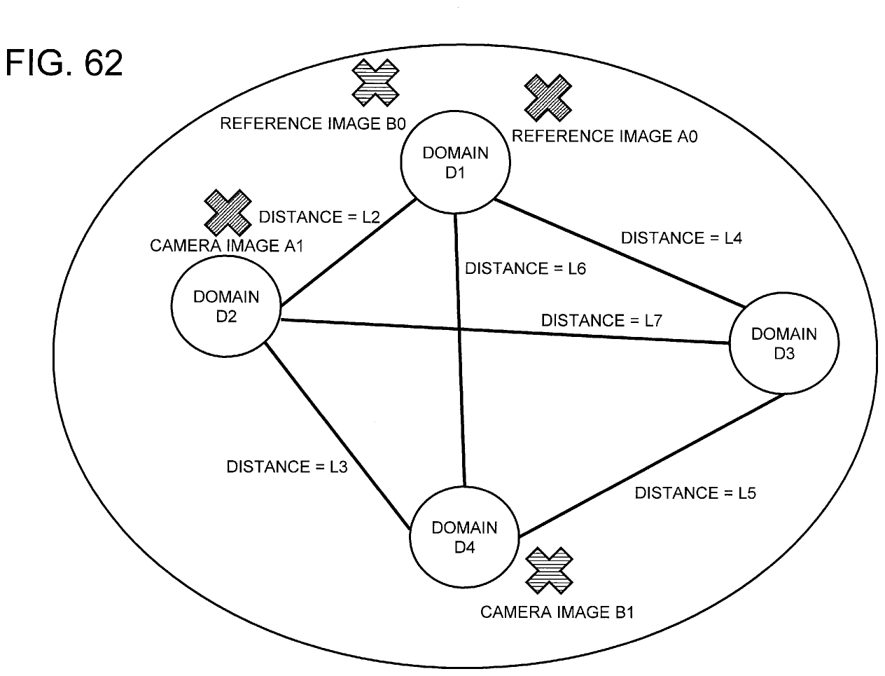

FIG. 62 is an explanatory diagram showing a process executed by the input image transformation unit 911 shown in FIG. 58 and FIG. 59. In FIG. 62, a “reference image A0” belongs to a domain D1, a “camera image A1” belongs to a domain D2, and the distance L2 between the domain D1 and the domain D2 is shorter than the other domain-to-domain distances L3 to L7. In other words, the relationship between the domain D1 and the domain D2 is closer than the relationship between other domains. In this case, the input image transformation unit 911 performs a process for transforming the domain to which the reference image A0 belongs from the domain D1 to the domain D2 on the reference image A0. Alternatively, the input image transformation unit 911 performs a process for transforming the domain to which the camera image A1 belongs from the domain D2 to the domain D1 on the camera image A1.

### (Example of Transformation of (Z3))

In FIG. 62, a “reference image B0” belongs to the domain D1, a “camera image B1” belongs to a domain D4, and the distance L6 between the domain D1 and the domain D4 is longer than the distance L2 between the domain D1 and the domain D2 and the distance L3 between the domain D4 and the domain D2. In this case, the input image transformation unit 911 performs a process for transforming the domain to which the reference—image B0 belongs from the domain D1 to the domain D2 on the reference image B0, and performs a process for transforming the domain to which the camera image B1 belongs from the domain D4 to the domain D2 on the camera image B1. By this process, excessive change in the reference image B0 and the camera image B1 can be avoided, and thus an input of erroneous information to the reference image B0 or the camera image B1 in the transformation process can be prevented.

Further, the input image transformation unit 911 may additionally employ reliability as data used for the correction of each domain in addition to the similarity level (distance) between images and determine the transformation destination based on both of the similarity level and the reliability. For example, since the accuracy of the correction increases in images of the daytime compared to images of the nighttime, the transformation destination is determined dynamically so as to increase the correction accuracy by setting the reliability of the daytime domain higher than the reliability of the nighttime domain.

Furthermore, the input image transformation unit 911 may also be configured to judge the similarity level between the reference image and the camera image based on the direct distance between the images instead of the distance between the domains to which the images belong.

### (Domain Classification Learning Model-Parameter Input Unit 9115)

A domain classification learning model-parameter input unit 9115 shown in FIG. 59 outputs a learning model and a parameter, to be used by the image transformation destination determination unit 9111 for judging to which domains the reference image provided from the reference data readout unit 605 and the camera image provided from the camera image reception unit 609 belong, to the image transformation destination determination unit 9111. Corresponding learning model and camera parameter are acquired from the learning model-parameter read-in unit 912.

### (Image Transformation Learning Model-Parameter Input Unit 9112)

Based on the method of the image transformation process provided from the image transformation destination determination unit 9111, the image transformation learning model-parameter input unit 9112 shown in FIG. 59 reads in the learning model and the camera parameter to be used when implementing the transformation. Based on the method of the transformation process of each of the reference image provided from the reference data readout unit 605 and the camera image provided from the camera image reception unit 609, the image transformation destination determination unit 9111 acquires corresponding learning model and camera parameter from the learning model-parameter read-in unit 912 and outputs the corresponding learning model and camera parameter to the reference image transformation processing unit 9113 and the input camera image transformation processing unit 9114 (step S605 in FIG. 60). When an output designating not transforming an image is issued from the image transformation destination determination unit 9111, the image transformation learning model-parameter input unit. 9112 outputs a command for not transforming the image to the reference image transformation processing unit 9113 or the input camera image transformation processing unit 9114.

### (Reference Image Transformation Processing Unit 9113)

The reference image transformation processing unit 9113 shown in FIG. 59 transforms the reference image provided from the reference data readout unit 605 based on the learning model and the camera parameter inputted from the image transformation learning model-parameter input unit 9112 and outputs the reference image after the transformation to the movement amount estimation-parameter calculation unit 607 and the deviation correction unit 608 as a new reference image. When the transformation is unnecessary, the reference image transformation processing unit 9113 outputs the reference image provided from the reference data readout unit 605 without performing the transformation.

### (Input Camera Image Transformation Processing Unit 9114)

The input camera image transformation processing unit 9114 shown in FIG. 59 transforms the camera image provided from the camera image reception unit 609 based on the learning model and the camera parameter inputted from the image transformation learning model-parameter input unit 9112 and outputs the transformed camera image to the movement amount estimation-parameter calculation unit 607 and the deviation correction unit 608 as a new camera image. When the transformation is unnecessary, the input camera image transformation processing unit 9114 outputs the camera image provided from the camera image reception unit 609 without performing the transformation.

### (6-8) Learning Model-Parameter Read-In Unit 912

The learning model-parameter read-in unit 912 shown in FIG. 58 provides the input image transformation unit 911 with the learning model and the camera parameter to be used for the image classification (i.e., domain classification) and the image transformation. To give an explanation with reference to FIG. 26, the main processor 611 loads the learning model and the camera parameter stored in the auxiliary memory 613 into the main memory 612 via the file interface 616.

### (6-9) Relearning Unit 913

The relearning unit 913 shown in FIG. 58 has the function of relearning the learning model and the camera parameter used for the image classification (i.e., domain classification) and the image transformation based on camera images recorded in the camera image recording unit 914.

### (6-10) Modification of Sixth Embodiment

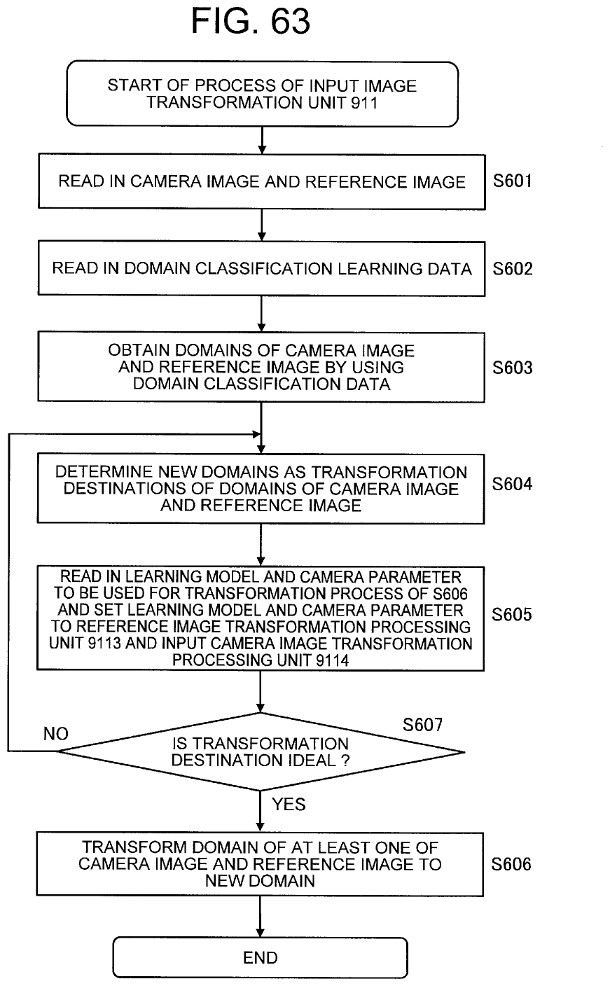

FIG. 63 is a flowchart showing a process executed by an image transformation destination determination unit 9111 of an image processing device according to a modification of the sixth embodiment. In FIG. 63, each process step identical to a process step shown in FIG. 60 is assigned the same reference character as in FIG. 60. As is clear from FIG. 63 and FIG. 60, the image transformation destination determination unit 9111 in the modification of the sixth embodiment differs from that in the image processing device 710 according to the sixth embodiment in repeating the process of determining the transformation destination of the domain of each of the camera image and the reference image until a suitable transformation destination (transformed image) is selected in the movement amount estimation and deviation correction process of the camera (i.e., step S607).

The image transformation destination determination unit 9111 can make the judgment on whether the selected transformation destination is a suitable transformation destination or not based on the movement amount between the transformed camera image and the transformed reference image, the similarity level between the transformed camera image and the transformed reference image, or both of the movement amount and the similarity level. The estimation of the movement amount is performed by the same process as the process executed by the movement amount estimation-parameter calculation unit 607. For example, the image transformation destination determination unit 9111 can judge that the transformation destination is not suitable when the movement amount between the transformed camera image and the transformed reference image is an outlier. Alternatively, the image transformation destination determination unit 9111 can judge that the transformation destination is not suitable when the similarity level between the transformed camera image and the transformed reference image is lower than a predetermined threshold value.

### (6-11) Effect

As described above, with the image processing device 910, the image processing method or the image processing program according to the sixth embodiment, the movement amount estimation-parameter calculation unit 607 estimates the movement amount or calculates the deviation amount evaluation value by using images in conditions close to each other, and thus the estimation accuracy of the movement amount or the calculation accuracy of the deviation amount evaluation value can be increased and optimization accuracy of the camera parameter can be increased.

Further, with the image processing device 910, the image processing method or the image processing program according to the sixth embodiment, even in a period in which images in conditions close to each other have not been recorded (e.g., period within one year from the installation of the cameras in which images of all the seasons of the year have not been acquired), the images in conditions close to each other can be newly generated. Accordingly, the estimation accuracy of the movement amount or the calculation accuracy of the deviation amount evaluation value can be increased.

Except for the above-described features, the sixth embodiment is the same as one of the third to fifth embodiments. The function of transforming the domain to which the camera image belongs described in the sixth embodiment can be applied also to other embodiments.

### (7) Modification

It is possible to appropriately combine the configurations of the image processing devices according to the first to sixth embodiments described above. For example, the configuration of the image processing device according to the first or second embodiment can be combined with the configuration of the image processing device according to one of the third to sixth embodiments.

### DESCRIPTION OF REFERENCE CHARACTERS

1a-1d: camera, 10: image processing device, 11: processor, 12: memory, 13: storage device, 14: image input interface, 15: display device interface, 17: external storage device, 18: display device, 100: deviation correction unit, 101a-101d: captured image, 102: image recording unit, 103: timing determination unit, 104: movement amount estimation unit, 105: feature point extraction unit, 106: parameter optimization unit, 107: correction timing determination unit, 108: synthesis table generation unit, 109: synthesis processing unit, 110: deviation amount evaluation unit, 111: overlap region extraction unit, 112: display image output unit, 113: outlier exclusion unit, 114: storage unit, 115: external storage unit, 202a-202d, 206a-206d: captured image, 204a-204d, 207a-207d, 500a-500d: synthesis table, 205, 208: synthetic image, 600_1-600_n: camera, 601: camera parameter input unit, 602: synthesis processing unit, 603: projection processing unit, 604: display processing unit, 605: reference data readout unit, 606: deviation detection unit, 607: movement amount estimation-parameter calculation unit, 608, 608a: deviation correction unit, 609: camera image reception unit, 610, 710, 810, 910: image processing device, 611: main processor, 612: main memory, 613: auxiliary memory, 614: image processing processor, 615: image processing memory, 616: file interface, 617: input interface, 6061: similarity level evaluation unit, 6062: relative movement amount estimation unit, 6063: superimposition region extraction unit, 6064: superimposition region deviation amount evaluation unit, 6065: projection region deviation amount evaluation unit, 6066: deviation judgment unit, 6082: parameter optimization unit, 6083: superimposition region extraction unit, 6084: superimposition region deviation amount evaluation unit, 6085: projection region deviation amount evaluation unit, 701: camera image recording unit, 702: input data selection unit, 703: mask image generation unit, 7031: difference purposed camera image recording unit, 7032: differential mask image output unit, 7033: initial mask image output unit, 7034: superimposition region extraction unit, 7035: superimposition region mask image output unit, 7036: mask image integration processing unit, 911: input image transformation unit, 912: learning model-parameter read-in unit, 913: relearning unit, 914: camera image recording unit, 9111: image transformation destination determination unit, 9112: image transformation learning model-parameter input unit, 9113: reference image transformation processing unit, 9114: input camera image transformation processing unit, 9115: domain classification learning model-parameter input unit.

What is claimed is:

1. An image processing device for executing a process of combining a plurality of captured images captured by a plurality of image capturing devices, the image processing device comprising:
processing circuitry
to record each of the plurality of captured images in a storage device while associating the captured image with identification information on the image capturing device that captured the captured image and time information indicating an image capture time;
to calculate an estimated movement amount of each of the plurality of image capturing devices based on the plurality of captured images recorded in the storage device; and
repeatedly to execute a deviation correction process including a process of obtaining an evaluation value of a deviation amount in each overlap region of the plurality of captured images constituting a synthetic image generated by combining the plurality of captured images whose image capture times are the same, a process of updating an external parameter of each of the plurality of image capturing devices based on the estimated movement amount and the evaluation value of the deviation amount, and a process of combining the plurality of captured images whose image capture times are the same by using the updated external parameters,
wherein in regard to each of the plurality of image capturing devices, the processing circuitry acquires the captured images in a designated period from the storage device, obtains movement amounts in adjacent image periods based on a plurality of captured images arranged in chronological order, and obtains the estimated movement amount by calculation using the movement amounts in the adjacent image periods.

2. The image processing device according to claim 1, wherein the processing circuitry repeatedly executes the deviation correction process until the evaluation value of the deviation amount satisfies a predetermined condition.

3. The image processing device according to claim 1, wherein the estimated movement amount is a sum total of the movement amounts in the adjacent image periods existing in the designated period.

4. The image processing device according to claim 2, wherein the processing circuitry
judges whether or not each of the movement amounts in the adjacent image periods satisfies a predetermined outlier condition, and
does not use the movement amounts in the adjacent image periods satisfying the outlier condition for the calculation for obtaining the estimated movement amount.

5. The image processing device according to claim 1, wherein the processing circuitry generates timing for the execution of the deviation correction process.

6. The image processing device according to claim 1, wherein when the plurality of image capturing devices are targets of the deviation correction process, the processing circuitry uses a sum total obtained by totalizing a plurality of deviation amounts in the synthetic image as the evaluation value of the deviation amount used in the deviation correction process.

7. An image processing method of executing a process of combining a plurality of captured images captured by a plurality of image capturing devices, the image processing method comprising:
recording each of the plurality of captured images in a storage device while associating the captured image with identification information on the image capturing device that captured the captured image and time information indicating an image capture time;
when calculating an estimated movement amount of each of the plurality of image capturing devices based on the plurality of captured images recorded in the storage device, in regard to each of the plurality of image capturing devices, acquiring the captured images in a designated period from the storage device, obtaining movement amounts in adjacent image periods based on a plurality of captured images arranged in chronological order, and obtaining the estimated movement amount by calculation using the movement amounts in the adjacent image periods; and
repeatedly executing a deviation correction process including a process of obtaining an evaluation value of a deviation amount in each overlap region of the plurality of captured images constituting a synthetic image generated by combining the plurality of captured images whose image capture times are the same, a process of updating an external parameter of each of the plurality of image capturing devices based on the estimated movement amount and the evaluation value of the deviation amount, and a process of combining the plurality of captured images whose image capture times are the same by using the updated external parameters.

8. A non-transitory computer-readable storage medium storing an image processing program that causes a computer to execute a process of combining a plurality of captured images captured by a plurality of image capturing devices, the image processing program causing the computer to execute:
recording each of the plurality of captured images in a storage device while associating the captured image with identification information on the image capturing device that captured the captured image and time information indicating an image capture time;
when calculating an estimated movement amount of each of the plurality of image capturing devices based on the plurality of captured images recorded in the storage device, in regard to each of the plurality of image capturing devices, acquiring the captured images in a designated period from the storage device, obtaining movement amounts in adjacent image periods based on a plurality of captured images arranged in chronological order, and obtaining the estimated movement amount by calculation using the movement amounts in the adjacent image periods; and
repeatedly executing a deviation correction process including a process of obtaining an evaluation value of a deviation amount in each overlap region of the plurality of captured images constituting a synthetic image generated by combining the plurality of captured images whose image capture times are the same, a process of updating an external parameter of each of the plurality of image capturing devices based on the estimated movement amount and the evaluation value of the deviation amount, and a process of combining the plurality of captured images whose image capture times are the same by using the updated external parameters.

9. An image processing device for executing a process of generating a synthetic image by combining a plurality of camera images captured by a plurality of cameras, the image processing device comprising:
processing circuitry
to provide a plurality of external parameters as camera parameters of the plurality of cameras;
to generate synthesis tables, as mapping tables used at a time of combining projection images, based on the plurality of external parameters and to generate a plurality of projection images corresponding to the plurality of camera images by projecting the plurality of camera images onto the same projection surface by using the synthesis tables;
to generate the synthetic image from the plurality of projection images;
to calculate a plurality of external parameters after correction as camera parameters of the plurality of cameras by estimating movement amounts of the plurality of cameras based on reference data, including a plurality of reference images as camera images used as reference corresponding to the plurality of cameras and a plurality of external parameters corresponding to the plurality of reference images, and the plurality of camera images captured by the plurality of cameras; and
to update the plurality of external parameters to the plurality of external parameters after the correction by using a result of the calculating of the plurality of external parameters after the correction.

10. The image processing device according to claim 9, wherein the processing circuitry reads the reference data from a storage device that previously stores the reference data.

11. The image processing device according to claim 9, further comprising the storage device that previously stores the reference data.

12. The image processing device according to claim 9, wherein the processing circuitry selects the reference data from the plurality of camera images captured by the plurality of cameras.

13. The image processing device according to claim 12, wherein the processing circuitry
records the plurality of camera images captured by the plurality of cameras in the storage device, and
selects the reference data from the plurality of camera images recorded in the storage device.

14. The image processing device according to claim 9, wherein the processing circuitry
generates a mask image that designates a mask region not used for the estimation of the movement amounts of the plurality of cameras and the calculation of the plurality of external parameters after the correction, and
estimates the movement amounts of the plurality of cameras and calculates the plurality of external parameters after the correction based on regions of the plurality of reference images excluding the mask region and regions of the plurality of reference images captured by the plurality of cameras excluding the mask region.

15. The image processing device according to claim 9, wherein the processing circuitry
classifies each of the plurality of camera images into one of a plurality of domains based on states in which the plurality of camera images were captured, classifies each of the plurality of reference images into one of the plurality of domains based on states in which the plurality of reference images were captured, and performs a transformation process, for causing a state in which the domain of a comparison target camera image among the plurality of camera images and the domain of a comparison target reference image among the plurality of reference images are close, on at least one of the comparison target camera image and the comparison target reference image, and
estimates the movement amounts of the plurality of cameras and calculates the plurality of external parameters after the correction corresponding to the plurality of cameras based on the comparison target camera image and the comparison target reference image.

16. The image processing device according to claim 15, wherein the state in which the domains are close
means one or more conditions of a condition in which difference in an image capture time is within a predetermined range, a condition in which there exists no mobile object, a condition in which difference in a number of people is within a predetermined value, a condition in which difference in sunshine duration is within a predetermined time, and a condition in which an index used when evaluating an image similarity level including one of luminance difference, luminance distribution and contrast is within a predetermined range, or
is a condition that is judged based on a classification result obtained from a learning model for classifying images.

17. The image processing device according to claim 15, wherein the transformation process is a process of making the domain of the comparison target camera image and the domain of the comparison target reference image coincide with each other or a process of reducing a distance between the images.

18. The image processing device according to claim 15, wherein the processing circuitry
generates and updates a learning model indicating into which of the plurality of domains each of the plurality of camera images should be classified and a learning model indicating into which of the plurality of domains the reference image should be classified based on the plurality of camera images, and
executes the classification of each of the plurality of camera images, the classification of each of the plurality of reference images and the transformation process based on the learning models.

19. The image processing device according to claim 15, wherein the transformation process is a process of causing a state in which the domain of a correction target camera image and the domain of a camera image adjoining the correction target camera image are close.

20. The image processing device according to claim 18, wherein the processing circuitry
records the plurality of camera images captured by the plurality of cameras in a storage device, and
generates and updates the learning models based on the plurality of camera images recorded in the storage device.

21. The image processing device according to claim 9, wherein the processing circuitry
records each of the plurality of camera images in a storage device while associating each of the plurality of camera images with identification information on the camera that captured the camera image and time information indicating an image capture time,
calculates an estimated movement amount of each of the plurality of cameras based on the plurality of camera images recorded in the storage device, and
repeatedly executes a deviation correction process including a process of obtaining an evaluation value of a deviation amount in each overlap region of the plurality of camera images constituting the synthetic image generated by combining the plurality of camera images whose image capture times are the same, a process of updating the external parameter of each of the plurality of cameras based on the estimated movement amount and the evaluation value of the deviation amount, and a process of combining the plurality of camera images whose image capture times are the same by using the updated external parameters.

22. An image processing method executed by an image processing device for executing a process of generating a synthetic image by combining a plurality of camera images captured by a plurality of cameras, the image processing method comprising:
providing a plurality of external parameters as camera parameters of the plurality of cameras;
generating synthesis tables, as mapping tables used at a time of combining projection images, based on the plurality of external parameters and generating a plurality of projection images corresponding to the plurality of camera images by projecting the plurality of camera images onto the same projection surface by using the synthesis tables;
generating the synthetic image from the plurality of projection images;
calculating a plurality of external parameters after correction as camera parameters of the plurality of cameras by estimating movement amounts of the plurality of cameras based on reference data, including a plurality of reference images as camera images used as reference corresponding to the plurality of cameras and a plurality of external parameters corresponding to the plurality of reference images, and the plurality of camera images captured by the plurality of cameras; and
updating the plurality of external parameters to the plurality of external parameters after the correction by using a result of the calculating of the plurality of external parameters after the correction.

23. A non-transitory computer-readable storage medium storing an image processing program that causes a computer to execute a process of generating a synthetic image by combining a plurality of camera images captured by a plurality of cameras, the image processing program causing the computer to execute:
providing a plurality of external parameters as camera parameters of the plurality of cameras;
generating synthesis tables, as mapping tables used at a time of combining projection images, based on the plurality of external parameters and generating a plurality of projection images corresponding to the plurality of camera images by projecting the plurality of camera images onto the same projection surface by using the synthesis tables;
generating the synthetic image from the plurality of projection images;
calculating a plurality of external parameters after correction as camera parameters of the plurality of cameras by estimating movement amounts of the plurality of cameras based on reference data, including a plurality of reference images as camera images used as reference corresponding to the plurality of cameras and a plurality of external parameters corresponding to the plurality of reference images, and the plurality of camera images captured by the plurality of cameras; and
updating the plurality of external parameters to the plurality of external parameters after the correction by using a result of the calculating of the plurality of external parameters after the correction.
